(19) United States
(12) Patent Application Publication
(10) Pub. No.: US 2021/0257932 A1
(43) Pub. Date: Aug. 19, 2021

(54) SELF-POWERED TRIBOELECTRIC BASED DEVICES

(71) Applicant: NATIONAL UNIVERSITY OF SINGAPORE, Singapore (SG)

(72) Inventors: Chengkuo LEE, Singapore (SG); Qiongfeng SHI, Singapore (SG)

(73) Assignee: NATIONAL UNIVERSITY OF SINGAPORE, Singapore (SG)

(21) Appl. No.: 17/259,302

(22) PCT Filed: Jul. 11, 2019
(86) PCT No.: PCT/SG2019/050339

§ 371 Date: Jan. 11, 2021

(30) Foreign Application Priority Data
Jul. 11, 2018 (SG) 10201805968U

(51) Int. Cl. H02N 1/04; G06F 3/0346; G01C 19/5783

(52) U.S. Cl. CPC H02N 1/04; G01C 19/5783; G06F 3/0346

(57) ABSTRACT

A self-powered triboelectric based device, a self-powered triboelectric based device, a user interface, a method of providing user input, an energy harvesting device, a method of harvesting energy, a submersion-detecting device, and a method of submersion-detecting.

### FIELD OF INVENTION

The invention generally relates broadly to self-powered triboelectric based devices, specifically to a triboelectric based self-powered 3D sensor for diversified applications such as augmented reality control, game control and smart control, and to a triboelectric ball for diversified energy harvesting and self-powered motion monitoring including multi-axis acceleration and rotation.

### BACKGROUND

Any mention and/or discussion of prior art throughout the specification should not be considered, in any way, as an admission that this prior art is well known or forms part of common general knowledge in the field.

Sensors for collecting force and displacement information have been developed extensively across the world in recent years. Specifically, tactile sensors or touch sensors have stimulated huge research interest in recent years [A1, A2] These sensors are embedded into conceptual Internet of Things (IoT) applications such as medical devices, industrial controls, health and safety devices, augment reality interaction between human and computers, supply chain tools, etc. According to the prediction by Cisco [A3] there will be trillions of sensors distributed around the earth by 2020. It is reasonable to expect that the tactile sensors will share quite a huge proportion in the trillions of sensors. As current sensors are powered by batteries with limited lifetime, such huge quantity of exhausted batteries distributed around the world will cause serious environmental issues. Therefore, self-powered sensors have been developed rapidly as a solution. Specifically, self-powered tactile sensors attract increasing attention due to their self-generated working mechanism and energy saving capability for IoT applications.

By transforming mechanical energy to electrical energy, self-powered triboelectric nanogenerator (TENG) based touch sensors which can generate voltage, current or charge to indicate the property of applied force, have attracted enormous research efforts recently [1-12].

It is a promising technology for solving the issues in economic development, energy saving and environment protection. Many high-performance tactile or pressure sensors based on TENG have been prototyped and investigated. For example, Wang's group has reported a tactile sensor with high sensitivity of 44 mV-Pa in low pressure range (<0.15 kPa) [6]. Shi et al. proposed a liquid triboelectric based microfluidic sensor for pressure sensing and finger motion monitoring [11]. Meng et al. developed a micro-patterned PDMS touch sensor with high output performance [12]. However, general forces are composed of normal and shear components. Although the normal force components were characterized by touch sensors with high sensitivity and robust performance based on TENG in recent researches [13-17], the shear force components with direction information are rarely studied by TENG based sensors.

Moreover, the reported TENG based sensors are normally 2D or even 1D sensors. They are not able to perform 3D force sensing, which greatly limits their applications in 3D control such as augmented reality, game control, etc.

Previously, many of TENG models are explained by circuit modes. Under the circuit explanations, the TENGs are more likely working in vertical contact-separation mode or in-plane sliding mode. Working under these two modes, large displacement needs to be applied between layers of TENGs to achieve high output. It results in the consequence that TENGs need to occupy large space which makes it difficult for shrink-down applications. More recently, Dharmasena et al. built up a distance-dependent electric field model for TENG based on Maxwell equations [18]. Wang et al. also proposed explanations for triboelectric and piezoelectric nanogenerators based on Maxwell displacement current [19]. The electric field and displacement current theories can be adopted as guidance for designing TENG sensors that are not working in the two circuit modes with robustness, stable output and small structure deformations [20].

The working modes of TENG based sensors are rather diverse and could also be applied to harvest most of conventional mechanical/kinetic motions in our daily life [B44-B51]. For example, Zhu et al. reported a triboelectric tactile sensor that can achieve high sensitivity of 44 mV-Pa in low pressure range (<0.15 kPa) [B52]. Yi et al. presented a self-powered, single-electrode-based triboelectric sensor (TES) to accurately detect the movement of a moving object/body in two dimensions [B53]. Shi et al. proposed a flexible liquid-solid interface triboelectric based microfluidic sensor for pressure/force sensing and finger bending monitoring [B54]. Meng et al. demonstrated a self-powered touch sensor with micro-patterned PDMS to achieve high output performance [B55]. Along the years of research, normal force components were characterized by TENG based touch/tactile sensors with high sensitivity and robust performance [B56-B58]. However, general applied forces on the sensors are composed of normal and shear components. The shear force components with direction information are barely studied by TENG based sensors in the 2D applications as mentioned above.

Furthermore, limitation of structure design of the previous TENG based sensors inhibits their applications for 3D parameter detection. Specifically, to date, no relevant research has been conducted using the TENG as a self-powered 3D-controlsensor in AR interactive system.

Also, healthcare monitoring systems are playing a more and more important role in our daily life to provide useful health information for disease prevention and treatment. A wide variety of sensors have been demonstrated to monitor physiological signs and biomechanical parameters for healthcare monitoring, such as tactile sensor, respiration rate sensor, heart rate sensor, blood pressure sensor, eyeball motion sensor, brain activity sensor and various implantable biomedical sensors, etc. Among the versatile aspects of the healthcare monitoring, motion information of body segments, i.e. biomechanical parameter monitoring, is one indispensable aspect as useful and opportune knowledge of physical and mental status can be obtained for rehabilitation or diagnostics purpose. For example, it can be benefited for the detection of human activity pattern (sitting, walking or resting), the monitoring and prevention of elderly people fall, the training of hemiparetic patients for limb rehabilitation, etc. Nowadays the motion monitoring systems are commonly based on inertial sensor modules including multi-axis accelerometer and gyroscope. Commercially available microelectromechanical systems (MEMS) inertial sensor modules have been widely used for acceleration and rotation sensing in healthcare and amusement applications [C1-C6]. Although MEMS inertial sensors have been commercialized and used in diversified applications, self-powered accelerometers using piezoelectric mechanism and triboelectric mechanism have been investigated and considered as novel self-sustained sensors for battery-less applications in internet-of-things (IoT), healthcare and harsh environment monitoring [C7-C11].

Among these reported self-powered accelerometers, devices based on flexible polymer with simple fabrication process and cost effectiveness have been widely investigated. A piezoelectric polyvinylidene fluoride (PVDF) polymer based cantilever-type accelerometer was proposed for one-axis low frequency acceleration detection [C7]. A triboelectric and electromagnetic hybrid energy harvester with magnet as movable mass was demonstrated for z-axis acceleration measurement [C8]. A popular device configuration for acceleration sensing is a symmetric structure, for example, a spherical shaped triboelectric nanogenerator (TENG) was presented for acceleration sensing as well as vibration and water wave energy harvesting [C9, C10]. The symmetric spherical structure has great potential to enable multi-axis acceleration sensing, however, only one-axis acceleration measurement was demonstrated. In order to realize the detection of multi-axis acceleration, a 3-dimension (3D) acceleration sensor was developed with the structure of three tube shaped TENGs integrated together along x, y and z direction [C11]. However, the detection of 3-axis acceleration is actually achieved by three individual devices rather than one single device, which greatly increases the device size and complexity. Moreover, a self-power gyroscope has not been reported yet.

Nowadays, the energy source of our daily life is heavily depended on fossil fuels. But with the fossil fuels running out and the consequent environmental issues (pollution, global warming, climate change, etc.) along with it, the search for new green energy source is becoming more and more impending. When more than 70% of the earth surface is covered by water, water wave energy is an enormous green energy source existing all around the world. However, most of the water wave energy remains unexplored due to the harsh water environment and the lack of efficient energy harvesting technologies. Although electromagnetic generators have been developed to convert water wave energy into electricity, there are still no commercial power farms demonstrated successfully based on water wave energy harvesting. The main challenges are low energy conversion efficiency of the turbine based electromagnetic generators, heavy instruments, water corrosion and high maintenance cost. In search for a reliable and efficient approach to harvest energy from the huge water wave energy source is highly desirable and necessary.

In general, self-powered sensing design or dual-purpose design with energy harvesting and sensing capability is a promising research field to enable long-term and smart motion monitoring system.

Therefore, research for a more reliable and efficient approach to harvest the huge water wave energy is highly desirable and necessary. Triboelectric nanogenerator (TENG) based on the triboelectrification (or contact electrification) and electrostatic induction has emerged as a promising energy harvesting technology since 2012 [D8]. After that, diverse TENGs have been extensively investigated and demonstrated as an effective approach for harvesting mechanical energy including vibration, human motions, airflow and water wave [D9-D20]. In comparison to the traditional electromagnetic generators, the emerging TENG technology shows greater advantages benefited from the simple device configuration, light weight, wide material choice, cost effectiveness and easy scalability. Furthermore, large-scale TENG array forming network structure on water surface has been reported to effectively scavenge the wide-area water wave energy and produce significant output power [D21-D24]. Due to the aforementioned merits, TENG provides a more efficient way to harvest the random and large-scale water wave energy.

When trying to harvest the water wave energy, three-dimension (3D) structure is more advanced and can function better in the complicated water wave environment [D25-D31].

Previously developed 3D TENGs for water wave energy harvesting are normally based on the design of an encapsulated structure with solid movable mass to create impact on TENGs on the inner surface. For example, a sealed cubic structure with four TENGs on the inner sidewalls and a movable ball mass is proposed to convert the slow and random water wave energy into electricity [D25]. An encapsulated box structure with four wavy-structured TENGs as sidewalls and a free-moving metal ball as movable mass is reported to harvest water wave energy [D26]. An enclosed polyhedron structure with 12 sets of multilayer wavy-structured TENGs and a hard ball for water wave energy harvesting has been demonstrated [D27]. A fully enclosed TENG with a rolling dielectric sphere inside the spherical shell is proposed for low frequency water wave energy harvesting [D28]. However, there are three major drawbacks of these reported TENGs as water wave energy harvesters. First of all, water wave with low frequency and random direction/amplitude may not cause sizable acceleration on the movable mass, resulting in low impact force on the TENGs and thereby low output performance. Next, the outer surface of these developed devices is normally wasted due to the fact that conventional TENGs cannot work in the water environment, which greatly hinders the energy conversion efficiency. Last but not least, the performance of the developed TENGs for water wave energy harvesting is highly susceptible to water leakage. Even small amount of water leakage can cause device failure due to the conventional solid-solid interface TENG design. Water leakage may be fatal for the conventional TENGs, but on the other hand, water itself can function as triboelectric material for power generation in liquid-solid interface TENGs. Recently, liquid-solid interface triboelectrification between polymer and water or liquid metal has been investigated for energy harvesting and self-powered sensing applications [D32-D43]. TENGs using this phenomenon have received increasing research effort and developed rapidly. But current designs mainly focus on energy harvesting from vibration/water drop and self-powered sensing of ion concentration, pressure, flow rate, etc. Only very limited water based TENGs have been demonstrated for water wave energy harvesting [D44-D46]. A liquid-solid electrification based thin film TENG with electrode array covered by fluorinated ethylene propylene (FEP) is reported for harvesting energy from ambient water motions [D44]. A flexible and area-scalable TENG based on triboelectrification between solid and liquid interface is developed for scavenging kinetic water wave energy [D45]. A hybrid TENG by integrating interfacial electrification and impact electrification is proposed for harvesting the electrostatic energy and impact energy from water wave [D46]. However, these developed liquid-based TENGs are based on 2D structure designs that are less adaptable in the complicated water environment compared to 3D structure. For example, variation from water wave direction can cause significant output degradation for 2D structure design. On the other hand, liquid-based 3D symmetric structure is expected to be more desirable and effective in the complicated water wave environment and less susceptible to water leakage.

Embodiments of the present invention provide seek to address at least one of the above problems.

### SUMMARY

In accordance with a first aspect of the present invention there is provided a self-powered triboelectric based device comprising

a base member comprising a first material,
an actuator member comprising a second material having a work function that differs from the first material disposed on a first surface of the base member, and
a plurality of electrodes electrically coupled to the base member;
wherein the plurality of electrodes are disposed in a manner such that a direction of a shear force component applied to the actuator member can be analysed based on electrical outputs measured via respective ones of the electrodes.

In accordance with a second aspect of the present invention there is provided a self-powered triboelectric based device comprising

a hollow base member comprising a first material,
one or more actuator members comprising a second material having a work function that differs from the first material disposed inside the hollow base member in a cavity defined by an internal surface of the base member, and
a plurality of electrodes disposed below the internal surface of the base member;
wherein the plurality of inner electrodes are disposed in a manner such that movement of the one or more actuator members can be analysed based on electrical outputs measured via respective ones of the inner electrodes.

In accordance with a third aspect of the present invention there is provided a user interface comprising the device of the first or second aspects.

In accordance with a fourth aspect of the present invention there is provided a method of providing user input using the device of the first or second aspects.

In accordance with a fifth aspect of the present invention there is provided a energy harvesting device comprising the device of the second aspect.

In accordance with a sixth aspect of the present invention there is provided a method of harvesting energy using the device of the second aspect.

In accordance with a seventh aspect of the present invention there is provided a submersion-detecting device comprising the device of the second aspect.

In accordance with an eighth aspect of the present invention there is provided a method of submersion-detecting using the device of the second aspect.

### DETAILED DESCRIPTION

Some embodiments of the present invention provide a 2D sensor with detail analysis on working mechanism according to the electric field theory and characterization of the device for normal force and shear force detecting. The self-powered 2D sensor according to example embodiments has the capability of detecting not only the normal force but also the shear force directions. For normal force sensing, it has a linear range of 0-25 N according to an example embodiment. The open circuit voltage, output charge and short circuit current sensitivity is 0.131 V N⁻¹, 0.048 nC N⁻¹ and 0.175 nA N⁻¹, respectively, according to an example embodiment. Some embodiments of the present invention provide a 3D sensor for collecting force and displacement information. The 3D sensor according to example embodiments can significantly extend the usage scenarios and applications, such as augmented reality force sensor and motion controller of object movements in 3D free space, game control and smart control, etc.

Because the theoretical model is limited in 1D or 2D in previous works [A13,A16-A19], the shear force part is not able to be revealed by TENG. In example embodiments described herein, from the electric field perspective, the 3D force information is able to be characterized by the electric field variations due to force applied on the device. Besides, the flexibility of liquid metal and 3D printing structure preferably ensure that the device has a robust force detecting capability. In the aspect of shear force detection, embodiments of the present invention can resolve the shear force direction with step resolution of at least 15°. Additionally, the self-powered cursor according to an example embodiment is also able to detect the rotation motions applied on the touch point. This self-powered cursor shows significant potential in the batteryless and energy saving IoT sensor applications.

Generally, some embodiments of the present invention provide a self-powered 2D and a 3D sensor based on triboelectric nanogenerator (TENG) for collecting force and displacement information. Based on the theoretical modeling, simulation and experimental characterization of the 2D sensor, a more novel 3D sensor is then proposed for 3D control.

The self-powered 2D sensor according to an example embodiment is made of liquid-metal mixed with PDMS which deforms under applying force and contacts with PTFE generating the triboelectric signal to denote the force amplitude. The self-powered 2D sensor according to an example embodiment has the capability of simultaneously detecting normal force in the range of 0-25 N and shear force direction (0°-360°) for the first time. The normal force sensing is characterized by open-circuit voltage, charge and current with the sensitivity of 0.131 V N⁻¹, 0.048 nC N⁻¹ and 0.175 nA N⁻¹, respectively, according to an example embodiment. The shear force direction detecting can achieve a resolution of 15°. Because of the positive output voltage and low internal impedance, the self-powered sensor according to an example embodiment is readily compatible with commercial portable circuits without the requirement of specified bulky high-impedance instruments to detect the output voltage. Demonstration of the self-powered sensor as triggering signal to drive a small vehicle is successfully realized by directly detecting the output voltage without any periphery signal processing circuits. The 2D sensor according to an example embodiment can be used to control the in-plane movement of an object.

In an example embodiment, a 3D sensor is provided that can be used to control the movement of an object in free space, not limited to only in-plane space. This 3D sensor according to an example embodiment significantly widens the application to ever large area, such as augmented reality control, game control, smart control, etc.

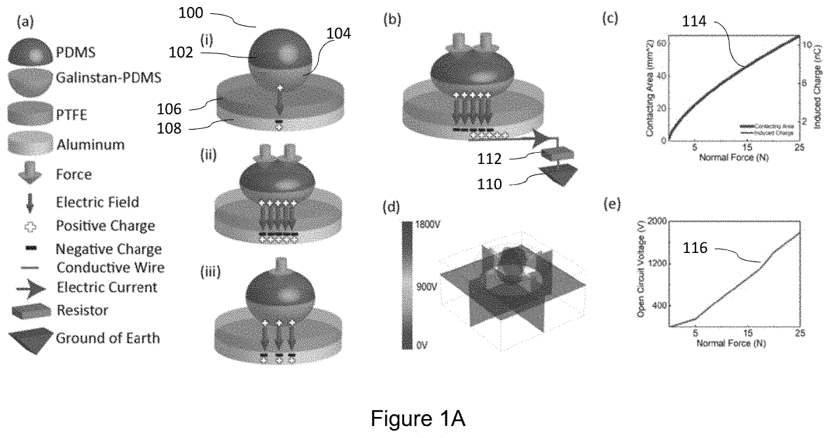

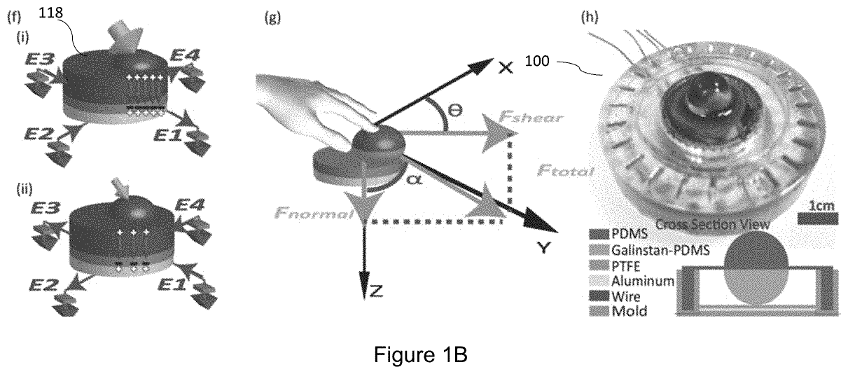

FIG. 1A shows: a) Working mechanism of the self-powered 2D sensor according to an example embodiment under normal force based on the electric field change with the applied force. b) Net induced charge. c) The relationship of contacting area and induced charge with the applied force. d) Multi-slice electrical potential distribution. e) The relationship of open-circuit voltage with the applied force. FIG. 1B shows: f) The structure with multiple electrodes and working mechanism for shear force detecting. g) Force component analysis acting on the self-powered 2D sensor. h) Photo of the Self-powered 2D sensor and its cross section view.

Based on the electrical field theory of TENG, the working mechanism of the self-powered cursor according to an example embodiment under normal force is explained in FIG. 1A a.

As shown in the sketch, the self-powered cursor 100 consists of top semisphere touch point 102, bottom functional semisphere 104, polytetrafluoroethylene (PTFE) thin film 106, aluminum electrode 108, and supporting structure (not shown). The bottom semisphere 104 is made by mixing galinstan (eutectic alloy of 68.5% gallium, 21.5% indium, and 10% tin by weight) with PDMS in one non-limiting example embodiment. The galinstan-PDMS mixture functions as one triboelectric layer and conductive material during the pressing period as Fassler and Majidi uncovered [A25]. Because of the work function difference between galinstan and PTFE [A26,A27], negative charges will transfer from galinstan surface to PTFE when they contact with each other. Then, galinstan holds net positive charge and PTFE surface carries net negative charge, as illustrated in FIG. 1A a(i). Due to Coulomb's law, the total charge induced in the aluminum electrode 108 is contributed by the negative charge on PTFE surface and the positive charge on galinstan surface. However, the negative charge on PTFE surface almost has no change after several periods of fully contacting due to the saturation of charge density on PTFE surface. When no force is applied, positive charge is widely separated in the semisphere of galinstan-PDMS mixture to maintain the electrostatic equilibrium. After force is applied, the positive charge on mixture is attracted significantly by the negative charge on PTFE in the contacting area, as illustrated in FIG. 1A a(ii). The charge density of the galinstan surface in the contacting area changes dramatically. The electric field generated by the positive charge is also enhanced under the contacting area. Corresponding charge pair would be induced in the aluminum electrode. The charge pair is approximately the same amount of positive charge accumulated in the contacting area of galinstan. After force is released and the deformed structure recovers to initial shape, the electric field is weakened and the charge pairs are also reduced, as illustrated in FIG. 1A a(iii). When the electrode 108 is connected to ground 110 with a resistor 112 as shown in FIG. 1b, the induced positive charge in the electrode 108 would flow to the ground to keep electrostatic equilibrium. This is the basic qualitative working mechanism of the self-powered cursor under normal force, according to example embodiments. Based on Gauss's law, the electric field at fixed positions is proportional to the source charge amount Q. The charges aggregated on galinstan of contacting area are derived as

$$Q = π {eD}_{s} ( {W}_{m} - {W}_{p} ) \cdot {[ \frac{3 F ( \frac{1 - {v}_{3}^{2}}{{E}_{1}} + \frac{1 + {v}_{2}^{2}}{{E}_{2}} )}{4 \frac{1}{R}} ]}^{\frac{2}{3}} \qquad ( 1 )$$

where e is the charge of an electron, Dₛ is the number of surface states per unit area and unit energy, Wₘ and Wₚ are the work functions for the metal gallium and PTFE, E₁ and E₂ are the modulus of elasticity for galinstan-PDMS mixture and PTFE film, ν₁ and ν₂ are the Poisson's ratios, respectively, F is the applied force on the top dome, and R is the radius of sphere. Here, gallium's work function has been used to represent the work function of galinstan, because gallium has consisted the main part of the eutectic alloy according to an example embodiment as shown by an energy-dispersive X-ray spectroscopy image. The specific values of parameters were derived from the energy-dispersive X-ray spectroscopy data. As the maximum distance change between vertex and nadir of sphere is 10 mm which is the diameter in a non-limiting example embodiment, the theoretical maximum applied force is calculated as 25 N. Relationships of the contact area A, induced charge Q, and applied force F is shown in FIG. 1c for an example embodiment, in which the contact area curve and induced charge curve are overlapping with each other as indicated generally at numeral 114. The relationship of contacting area with applied force is almost linear in the range of 0-25 N. Meanwhile, the induced charge Q also has a linear relationship with applied force in the range of 0-25 N. In sensor applications, voltage has huge significance in characterizing the sensor performance for its convenience to be read by circuits.

A self-powered cursor preferably has a voltage output around 0-5 V which can be directly read by commercial portable circuits without any periphery processing circuit. Therefore, the voltage output of the bottom aluminum electrode 108 relative to the earth ground should be derived to characterize the intended sensor performance according to an example embodiment.

In the metal and insulator contacting model, the charge distribution in metal is mathematically difficult to be calculated. That means that the electric field and electric potential are not able to be resolved through manual calculation. However, finite element modelling offers an effective method to simulate the voltage potential of the bottom electrode 108 when the sphere deforms.

A finite element simulation is built up to solidify the qualitative analysis and quantitative derivations. The multislice electrical potential distribution and open-circuit voltage of the bottom aluminum electrode 108 are shown in FIG. 1d,e, respectively. It can be observed that the open-circuit voltage has an approximately linear relationship with the applied force (see curve 116) which is in accordance with the theoretical derivations. Although the maximum output voltage is around 1800 V which is quite high, this simulation is built up in the vacuum circumstance. Additionally, recent research of TENG in vacuum environment also solidified that the output voltage level is reasonable [A28].

In the above description, the force is the normal force. In natural environments, forces are more likely to be random containing both the normal force component and the shear force component. The normal force is measured through the above mentioned mechanism. The shear force can be simultaneously measured by the same mechanism with multiple electrodes. The device according to an example embodiment with multiple electrodes and working mechanism is shown in FIG. 1A f. There are in total four electrodes E1 to E4 under the PTFE sheet to perceive the charge distribution changes on galinstan surface as the applied force changes. The PDMS film 118, circling around the sphere 102/104, confines the sphere 102/104 position in the center. To demonstrate the working mechanism, the shear force is applied toward electrode E1 and electrode E4, as shown in FIG. 1B f(i). The electric field on E1 and E4 generated by galinstan in the contacting area is enhanced compared with the initial electric field. On the contrary, the electric field on electrode E2 and electrode E3 generated by galinstan in the contacting area is weakened compared with the initial state. Therefore, the current flows from E1 and E4 to the ground and flows from the ground to E2 and E3. When the force is released, as shown in FIG. 1f(ii), the electric fields are back to the initial state and current flows in the opposite direction. Since charge output, open-circuit voltage, and short-circuit current of each electrode have proportional relationship with force components shared on the corresponding electrodes, force magnitude and direction can be determined by outputs of the different electrodes E1-E4. Although force consisted of the normal force component Fₙₒᵣₘₐₗ and the shear force component F_{sgear}, as shown in FIG. 1B g, the shear force component Fₛₕₑₐᵣ dominates the total force Fₜₒₜₐₗ in the applications of touching a cursor to realize controlling different direction, namely, the vertical angle α, between total force Fₜₒₜₐₗ and normal force Fₙₒᵣₘₐₗ, is greater than 60°. When force is acting on the top dome 102, the shear force Fₛₕₑₐᵣ is resolved into the compressing and elongation of PDMS film which encloses the sphere 102/104 and confines the sphere positions 102/104 (compare FIG. 1B f). The normal force component Fₙₒᵣₘₐₗ contributes to form the contacting area which induces outputs of the four electrodes. When the force is released, the PDMS film will push the sphere back to the initial position. The direction of shear force can be analyzed by the outputs of four electrodes. In FIG. 1B g, the x-axis coincides with the angle bisector of electrode E1 and the y-axis coincides with the angle bisector of electrode E4. For the cursor application, assuming the angle α has negligible change in each force applying cycle, therefore, the shear force Fₛₕₑₐᵣ has a proportional relationship with the normal force Fₙₒᵣₘₐₗ. In this way, it is reasonable to represent the actual shear force output voltage amplitude by

Vₛₕₑₐᵣ=\sqrt{V_{E1}²+V_{E4}²} (2)

The horizontal angle θ, between the x-axis positive direction and the shear force, is derived by

$$θ = {tan}^{- 1} \frac{{V}_{E 4}}{{V}_{E 1}} \qquad ( 3 )$$

If the amplitude of shear force and angle α are constant during the tests, the theoretical output voltage of electrode E1 is

$${V}_{E 1} = \frac{{V}_{shear}}{\sqrt{1 + tan {θ}^{2}}} \qquad ( 4 )$$

Based on Equation (4), through the theoretical derivation and force detecting mechanisms, a self-powered cursor 118 according to an example embodiment is fabricated with 3D printing technology to characterize the applied force information, as shown in FIG. 1B h.

Fabrication of the Self-Powered Cursor According to Example Embodiments

Based on the theoretical derivation and force detecting mechanisms, a self-powered cursor 118 according to an example embodiment was fabricated with 3D printing technology to characterize the applied force information, as shown in FIG. 1h. The scales or bars e.g. 120 were used to denote the direction of applied force. The angle of the center point to adjacent two bars was 15°. The PDMS (Sylgard 184 Dow Corning, USA) was mixed with cross-linker by the weight ratio of 10:1. The solution was then mixed with galinstan (Changsha Santech Materials, China) by the weight ratio of 1:6.44. After that, the galinstan-PDMS mixture was poured into a 3D printing mold to form the bottom semisphere. Then, pure PDMS was kept on pouring into the mold to form the supporting structure. Next, the structure was degassed and cured in the oven for 30 min under 80° C. The structure was then demolded and packaged into another 3D printing structure with PTFE sheet and aluminum electrode on bottom. Single electrode design on the bottom of PTFE was ready for normal testing. Separated four electrode design could be used for shear force testing. Last, PDMS touch point was bonded on top by PDMS-PDMS bonding method [A30]. To compare the output performance, two other devices according to example embodiments with the same single aluminum electrode and but different material-configurations for the triboelectric effect were also characterized.

### Characterization of the Self-Powered Cursor According to Example Embodiments

Open-circuit voltage, charge output measurements of the devices according to example embodiments were conducted with electrometer (Keithley 6514). Short-circuit current was measured by Stanford SR570. The normal force applied on these devices was generated by force gauge (Mecmesin 2.5-I, Germany). The output voltage of four-electrode galinstan-PTFE device according to an example embodiment was measured by Agilent DSO-X 3034A oscilloscope. The Arduino Uno (Arduino, Italy) and small vehicle (DG012-ATV, USA) were used in the small vehicle control demonstration.

Characterization of Normal Force Detection According to Example Embodiments

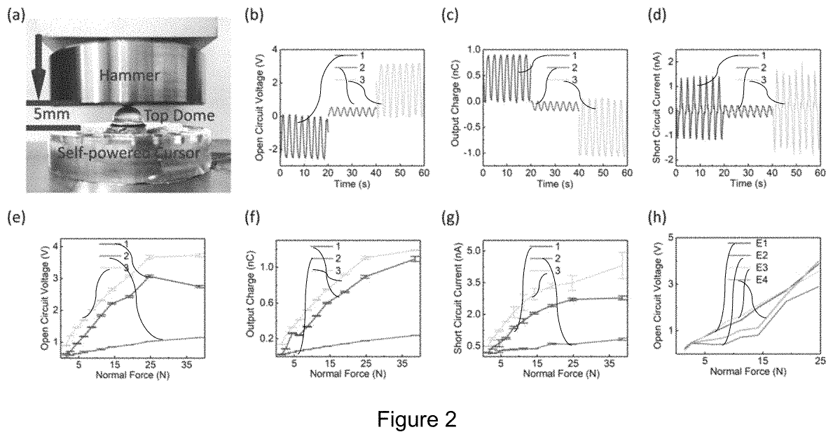

FIG. 2 shows: a) Testing setup of normal force detection. b) The open circuit voltage of three different devices under 24.7 N normal force (1—PDMS-Aluminum device according to an example embodiment; 2—Gold-PTFE device according to an example embodiment; 3—Galinstan-PTFE device according to an example embodiment; Each device is tested for continuous 20s, here their results are combined to be shown compactly in graphs b-d). c) The output charge of these three devices. d) The short circuit current of these three devices. e) The open circuit voltage versus applied normal force. f) The output charge versus applied normal force. g) The short circuit current versus applied normal force. h) The open-circuit voltage outputs of four-electrode configuration.

First, with reference to FIG. 2a, the hammer of the force gauge is set to be in exact contact with the vertex of the top dome of the sphere without yielding any deformation. Initially, there is no net charge generated between the two contacting surfaces of the self-powered cursor according to example embodiments. Because the sphere radius is 5 mm, the force gauge is set to run up and down 100 cycles with a displacement of 5 mm to make sure that the bottom PTFE layer is sufficiently charged. In FIG. 2b-g, 1 represents PDMS-aluminum device according to an example embodiment, 2 represents gold-PTFE device according to an example embodiment, and 3 represents galinstan-PTFE device according to an example embodiment.

FIG. 2b-d show the output waveforms of open-circuit voltage, charge output, and short-circuit current, respectively, under the same normal force 24.7 N.

In FIG. 2b, the open-circuit voltage between the bottom aluminum electrode and the ground is zero when no normal force is applied. Because the surfaces of galinstan and gold generate positive charge and PDMS surface generates negative charge, the galinstan-PTFE device (curve 3) and the gold-PTFE device (curve 2) have positive open-circuit voltage and the PDMS-aluminum device (curve 3) has negative open-circuit voltage. This matches well with the proposed theoretical model.

FIG. 2c shows the output charge of induced electrons flowing from the aluminum electrode to the ground. The initial output charge is zero when no normal force is applied. Because the bottom electrodes of galinstan-PTFE device and gold-PTFE device attract electrons and the bottom electrode of PDMS-aluminum device repels electrons, the galinstan-PTFE device (curve 3) and the gold-PTFE device (curve 2) have negative output charge and the PDMS-aluminum device (curve 1) has positive output charge when the normal force is applied. The results further consolidate the working mechanism model.

FIG. 2d shows the short-circuit current flowing from the aluminum electrode to the ground. The initial short-circuit current is zero when the applied normal force is static. As the bottom electrodes of galinstan-PTFE device and gold-PTFE device repels positive charge and the bottom electrode of PDMS-aluminum device attracts positive charge, the galinstan-PTFE device (curve 3) and the gold-PTFE device (curve 1) have positive short-circuit current peak and the PDMS-aluminum device (curve 1) has negative short-circuit current peak during dynamic period of normal force enhancing. In the dynamic period of normal force releasing, the galinstan-PTFE device (curve 3) and the gold-PTFE device (curve 2) have negative short-circuit current peak and the PDMS-aluminum device (curve 1) has positive short-circuit current peak. The result also supports the working mechanism model.

By comparing the output curves in FIG. 2b-d, it can be found that the galinstan-PTFE configuration (curves 3) has the best output performance in open-circuit voltage (maximum 3.23 V), charge output (maximum 1.19 nC) and short-circuit current (peak-peak maximum 4.31 nA). The maximum voltage output of gold-PTFE device (curve 2) and PDMS-aluminum device (curve 1) are only 0.53 V and 2.57, respectively. Based on the measured charge output amount, the surface charge density generated by galinstan-PTFE contacting is calculated to be 20.2 μC m⁻². Although the experimental values have some deviation from the theoretical value 168 μC m⁻², they are relatively comparable and reasonable because the testing environment weakens the output by many factors such as humidity, temperature, surface abrasion, fabrication defects, and so on. The surface charge density generated by gold-PTFE device is 4.04 μC m⁻², which is much smaller than galinstan-PTFE device. The theoretical charge density value is 72.9 μC m⁻². This theoretical value is smaller than galinstan-PTFE device which corresponds to the measured charge density comparison of the two devices. Concluded by Schein, when gold contacts with PTFE, it may even gain the negative charges [A29]. Besides, its fragile property also weakens the output charge. During the experiment, fragments of gold were found attached onto the PTFE surface while galinstan has no residue on PTFE surface. Therefore, this suggests that the liquid phase galinstan has superiority over other solid metals coated on the PDMS surface to contact with PTFE.

FIG. 2e-g show the relationship of output performance and the applied force. These outputs show good linear range from 0 to 25 N, which is consistent with the theoretical and simulation results. The open-circuit voltage, output charge, and short-circuit current sensitivity are 0.131 V N⁻¹, 0.048 nC N⁻¹, and 0.175 nA N⁻¹, respectively. This linear property is quite useful in the self-powered cursor application for normal force measuring. In the 25-40 N range, the output gradually saturates and the displacement of force gauge hammer (compare FIG. 2a) finally reaches the maximum 5 mm. Because the hammer is very close to the bottom semisphere in the last step and the hammer is connected to the ground which is default set by the machine, the charge on the bottom semisphere is partially coupled by the hammer. Therefore, the outputs have a saturation trend in the range of 25-40 N which is corresponding to the displacement 4.5-5 mm of the hammer.

For the PDMS-aluminum device, the open-circuit voltage (curve 1 in FIG. 2e) becomes smaller as the applied normal force increases, while charge output and short-circuit current keep increasing to saturation in the last step. Here, bottom PDMS semisphere is the only dielectric material and has no capability of shielding electric field. Therefore, the induced positive charge on the bottom aluminum electrode is weakened by the ground-connected hammer. In the charge output and short-circuit current tests, the measurement circuit is connected directly to the ground. There is no impedance and the induced charge flows freely to the ground during the dynamic period of force applying. Therefore, the hammer has less influence on weakening induced charge of bottom electrode in contrast to open-circuit voltage tests. Additionally, the PDMS-aluminum device's output voltage is negative (curve 1 in FIG. 2b) during the period of force applying because the bottom PDMS semisphere surface is negatively charged. The negative output property is not compatible for the majority of commercial circuits. Considering the output stability with metal shielding capability, high output performance, and positive output voltage of the galinstan-PTFE device, this configuration is chosen for the self-powered cursor application in a non-limiting example embodiment which can be directly connected with the commercial portable circuits.

After measuring the single electrode configuration for the above three devices, the galinstan-PTFE structure is chosen to be further investigated as an example embodiment, integrated with four separated electrodes. The open-circuit voltage outputs of four electrodes in the 0-24.7 N linear range are shown in FIG. 2h. The four curves show similar linear property and comparable output amplitude compared with the single electrode device. The voltage output difference of the four electrodes is due to the fabrication and assembling deviations. In force measurements, these discrepancies can preferably be eliminated by normalizations which will be discussed in the next section.

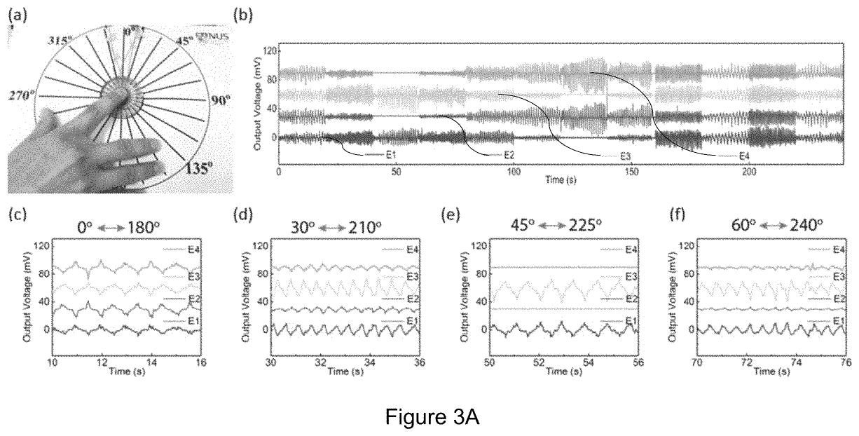

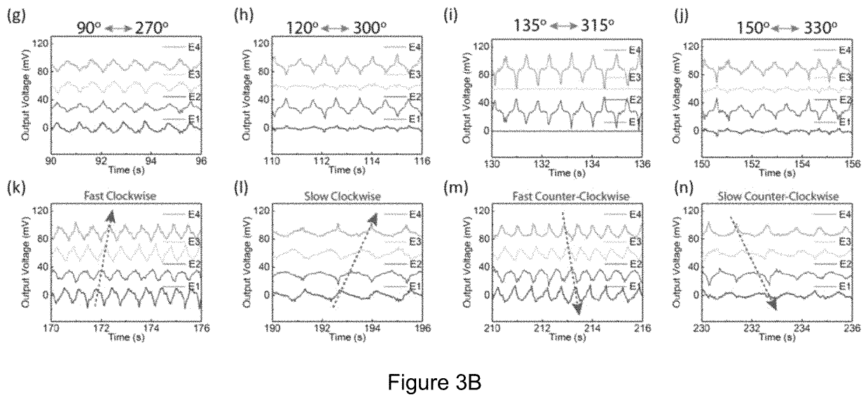

Characterization of Shear Force Detection according to example embodiments FIG. 3A shows: a) The illustration of shear force testing. b) Output voltage waveform of the four electrodes of a sensor according to an example embodiment by reciprocation and rotation motions in different directions. c)-f) Zoom-in voltage waveforms of the reciprocation motions.

FIG. 3B shows: g)-j) Zoom-in voltage waveforms of the reciprocation motions. k)-n) Zoom-in voltage waveforms of the rotation motions.

In the characterization experiments, to make the testing results reliable, the force is applied at the limitation of finger capability on the top dome of the cursor keeping the same amplitude around 10 N and same vertical angle α nearly 80° in different horizontal directions. The illustration of force applied is shown in FIG. 3A a. The horizontal direction change of force is realized by following along direction scales on the sensor. The interval between two scales is 15°. Due to the low input impedance 1 MΩ of the Agilent DSO-X 3034A oscilloscope used comparing to 200 TΩ of Keithley 6514 electrometer used, the output voltages are only a small portion of the open-circuit voltages and have peak-peak characteristics. However, they can be used to resolve the horizontal direction of the shear force since output voltages are still proportional to the force amplitude. Additionally, the reciprocation motion of finger is repeated for more than 15 cycles to calculate the mean values of output voltage peak-peak values to elevate the accuracy and reliability of measurements.

FIG. 3A b includes 8 reciprocation motions and 4 rotation finger motions. Each motion contains 20 s and more than 15 voltage peaks. E1, E2, E3, and E4 are used to represent the voltage from electrode 1, electrode 2, electrode 3, and electrode 4 of the sensor according to example embodiments. To differentiate the output voltage waveforms of each electrode, E2, E3, and E4 have the positive voltage offsets of 30, 60, and 90 mV, respectively. FIG. 3A c-f and FIG. 3B g-j show the zoom-in figures of each motion. Direction of 0°-180° as the reference direction (RD) represents the reciprocation motion in line with the “0°” and the “180°” scales on the sensor. The other 7 reciprocation motions have the directions in line with the “30°” and the “210°” scales, in line with the “40°” and the “225°” scales, in line with the “60°” and the “240°” scales, in line with the “90°” and the “210°” scales, in line with the “120°” and the “300°” scales, in line with the “135°” and the “315°” scales, and in line with the “150°” and the “330°” scales, respectively (compare FIG. 3A a).

In FIG. 3A c, the amplitudes of E1, E2, E3, and E4 are almost the same due to the same contacting area on each electrode during the operation period. There are small differences in the magnitudes due to the fabrication deviations. In addition, E1 and E4 are in the same phase and both are in opposite phase against E2 and E3. The phase of E1 in RD is set as the reference phase. The opposite phase of the reference phase is denoted with a negative symbol “−” before the output value. In FIG. 3A d, the phases of E1, E2, E3, and E4 keep the same phase as in RD. E2 and E4 are attenuated and E1 and E3 are improved because the contacting area becomes smaller for E2 and E4 but becomes larger for E1 and E3. In FIG. 3A e, E2 and E4 decrease to the lowest nearly zero, while E1 and E3 increase to the largest values because the contacting area are all on E1 and E3. In FIG. 3A f, E1 and E3 have slight attenuations and phases keep the same as in RD. E2 and E4 increase a little and phases are opposite from that in RD. In FIG. 3B g, E1 and E3 keep on decreasing with phases the same as in RD. E2 and E4 keep on increasing with phases opposite from RD. The amplitudes of E1, E2, E3, and E4 are almost the same as FIG. 3A c due to the same contacting area. In FIG. 3B h, E1 and E3 decrease and phases are opposite from that in RD. E2 and E4 increase with opposite phases from RD. In FIG. 3B i, E1 and E3 decrease to almost zero. E2 and E4 increase to the maximum. In FIG. 3B j, E1 and E3 increase a little, while E2 and E4 have slight attenuations. In summary, the shear force direction can be detected by the self-powered cursor through differentiating the amplitudes and phases of the four outputs.

FIG. 3B k-n show the zoom-in figures output results for the rotation motions of finger around the center of the sensor according the example embodiment. In FIG. 3k, E1, E2, E3, and E4 have a time delay in turn, as indicated by the arrow. This delay shows the motion is a clockwise rotation for FIGS. 3B k and l. The rotation period is 0.64 ms in FIG. 3B k. In FIG. 3B 1, E1, E2, E3, and E4 also have a time delay in turn with larger period of 1.40 ms, as indicated by the arrow. It is a slower clockwise rotation compared to FIG. 3B k. In FIG. 3B m, E1, E2, E3, and E4 have a time advance in turn, as indicated by the arrow. This time advance shows the rotation is a counterclockwise rotation. The rotation period is 0.60 ms. In FIG. 3B n, E1, E2, E3, and E4 also have a time advance in turn with larger period of 1.43 ms, as indicated by the arrow. It is a slower counterclockwise rotation comparing with FIG. 3m. Therefore, except for shear force direction detection (compare FIG. 3A c-f and FIG. 3B g-j), the self-powered cursor according to example embodiments is also able to detect the rotation direction and period of the finger motion. This greatly broadens the self-powered cursor according to example embodiments for more advanced control applications.

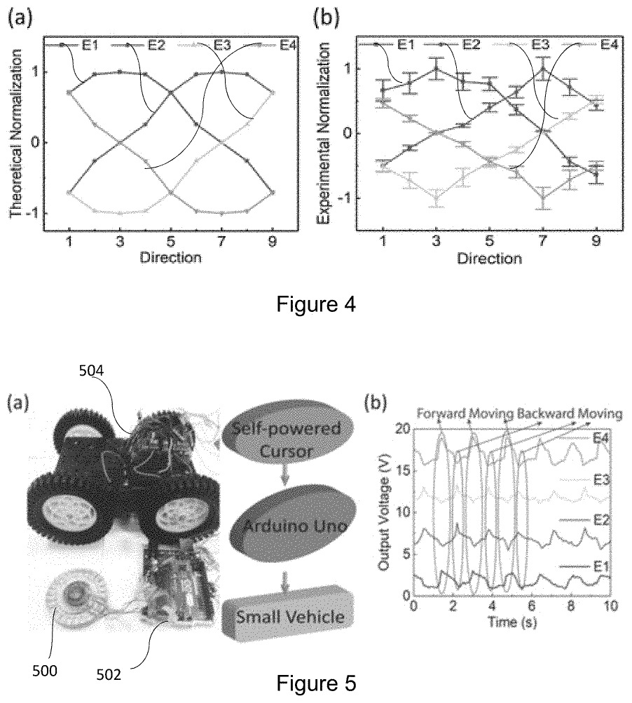

In the above presented testing results, the output trends of each electrode for different force directions have been illustrated in detail. To minimize the fabrication deviations, the output from each electrode can be normalized by the corresponding maximum value and will be discussed with reference to FIG. 4.

FIG. 4 shows: a) The normalization of theoretical output voltage with different shear force directions for a sensor according to an example embodiment. The direction number 1, 2, 3, 4, 5, 6, 7, 8 and 9 represents the directions of FIGS. 3c-j, respectively. b) The normalization of the experimental output voltage found in the experiments with different shear force directions for the sensor according to the example embodiment.

The normalizations of the theoretical and experimental output voltage values are compared and shown in FIG. 4. The curves from experimental results according to the example embodiment match quite well with the theoretical values from Equation (4). When force is applied in any horizontal direction, any two adjacent electrodes would have the positive output voltage and the other two have negative voltage, namely opposite phase. Through comparing voltage amplitude ratio and phase of the four electrode outputs, the horizontal direction of the force can be resolved accurately. With a more reliable testing platform, the shear force can also be calibrated under the same vertical angle α.

To further broaden the application of the self-powered cursor according to example embodiments without the limitation of constant vertical angle α, each of the multiple (e.g. E1 to E4) electrodes can be deposited as the bottom electrode in radial sections. The shear force amplitude can be measured by the outmost radial electrode section which lies in the boundary of contacting area and the shear force direction could be calculated in the same way as for the self-powered cursor according to an example embodiment as described above. The normal force could be derived as the whole output of the electrode sections in the contacting area. In this way, the force in any direction of half 3D space can be resolved thoroughly.

Self-Powered Cursor Demonstration according to example embodiments FIG. 5 shows: a) The photograph of a small vehicle and a self-powered 2D cursor with processing unit according to an example embodiment (left side) and a schematic circuit block diagram of the control mechanism according to the example embodiment (right side). b) The voltage output waveform read by Arduino Uno for E1 to E4 of the self-powered cursor according to the example embodiment.

To examine whether the cursor's output voltage is compatible with present commercial portable circuits, the self-powered cursor 500 according to an example embodiment is directly connected with an Arduino Uno board 502 to control a small vehicle 504, as shown in FIG. 5a. The Arduino Uno board 502 is programmed to read the output voltage of the cursor 500 and output corresponding signals to control the small vehicle 504 to move forward and backward. FIG. 5b depicts the readout values when force is applied in 0° and 180° directions. To differentiate each electrode output in the figure, E2, E3, and E4 have a 5, 10, and 15 V positive offset against E1, respectively. The output voltage of each electrode has a voltage amplitude in the range of 0-5 V. For the force applied forward and backward cyclically, E1 and E4 are in the same phase and opposite phase against E2 and E3. The results match well with the theoretical and experimental output in the reciprocation motion described above with reference to FIG. 4.

Accordingly, a self-powered cursor according to an example embodiment is provided and investigated with complete theoretical model, experimental characterization, and application demonstration. The self-powered cursor according to the example embodiment can detect both the normal force and shear force. In the non-limiting example embodiment, in detecting the normal force, it shows a linear range from 0 to 25 N. The open-circuit voltage, output charge, and short-circuit current sensitivity is 0.131 V N⁻¹, 0.048 nC N⁻¹, and 0.175 nA N⁻¹, respectively. In the aspect of shear force detection, the self-powered cursor according to the non-limiting example embodiment has the capability of differentiating the horizontal direction with resolution of at least 15°. A theoretical analysis of thoroughly resolving force in any direction of half three-direction space is proposed. Additionally, the self-powered cursor according to the example embodiment is also able to detect the rotation motions circling around its touch point. Moreover, the self-powered cursor according to an example embodiment is successfully demonstrated as the interaction interface for small vehicle controlling. The self-powered cursor according to the example embodiment shows great potential for sensing and controlling in batteryless and energy saving applications.

Self-powered virtual reality 3D-control sensor according to an example embodiment Next, a self-powered virtual reality 3D-control sensor (hereinafter also abbreviated as VR-3D-CS) according to an example embodiment based on triboelectric mechanism for controlling the attitude (both the position and rotation) of an object in 3D virtual space will be described. This cost-effective, simple-designed sensor has a symmetric 3D structure with eight separated sensing electrodes and two touching spheres as the interactive interface with human fingers for 3D force information sensing and virtual reality (VR) controlling. Based on the coupling effect of triboelectrification and electrostatic induction, the VR-3D-CS according to an example embodiment generates different electric output signals in response to different operation manner that can be used to control the attitude of objects in 3D virtual space. The symmetrical 3D configuration design of the sensor enables the detection of 3D force from both the normal direction and shear direction. By employing vector properties of force and signal analysis from the eight sensing electrodes, detection of six-axis directions in 3D space is achieved by triboelectric mechanism for the first time. The VR-3D-CS according to an example embodiment has been demonstrated to be able to detect normal force in the range of 0-18 N. It can resolve the shear force direction with step resolution of at least 15°. In addition, due to the positive output voltage and low internal impedance, the VR-3D-CS according to an example embodiment is readily compatible with commercial portable signal processing systems for signal analysis and controlling. Demonstration of the VR-3D-CS according to an example embodiment as interactive interface for Augmented Reality (AR) control was successfully realized. The robust structure, stable output performance and self-powered sensing property enable the VR-3D-CS according to example embodiments as an ideal human machine interface towards AR interface, batteryless and energy saving applications.

Specifically, a self-powered, triboelectric based virtual reality 3D-control sensor (VR-3D-CS) according to an example embodiment is provided by the coupling of contact electrification and electrostatic induction. The VR-3D-CS has a novel structure design of two opposite touch spheres and separated sensing electrodes for 3D force information sensing and controlling. By moving two spheres toward same directions or opposite directions, 3D space coordinates (X, Y, Z and Ox, Ay, Oz) can be detected and controlled. Six-axis directions in 3D space are detected by triboelectric mechanism for the first time. When the sphere under external force approaches or leaves the triboelectric layer, it will change the distribution of the local electric field, which would lead to a flow of electrons moving back and forth between the electrodes and ground.

The working mechanism of the VR-3D-CS according to example embodiments is analysed according to the electric field theory and characterization of the VR-3D-CS for normal force and shear force detection. Using the vector properties of forces, the attitude-control function in 3D space was realized. The VR-3D-CS generates electric output signals in response to different operation manner for attitude-control of objects in 3D virtual space.

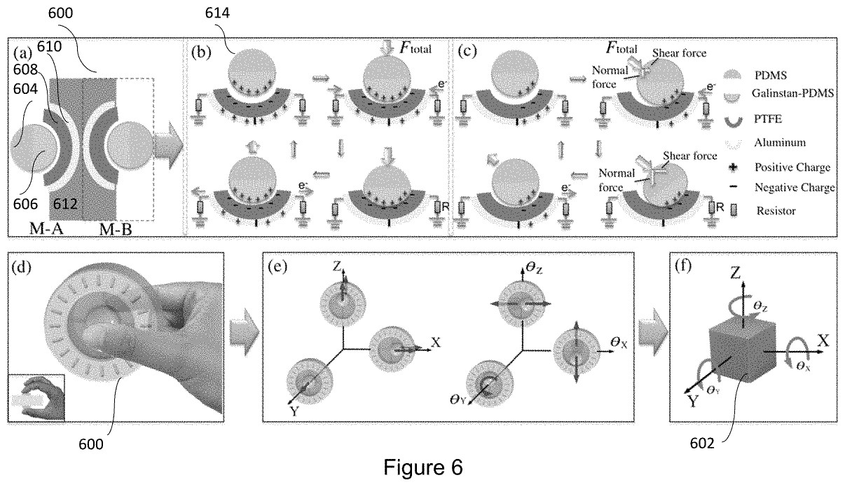

FIG. 6 Shows: (a) The symmetrical structure of the VR-3D-CS 600 according to an example embodiment, including two touch-sphere-based modules M-A and M-B. (b) Working mechanism of the touch-sphere-based components M-A, M-B of the VR-3D-Cs 600 under normal force based on the electric field change with the applied force. (c) Working mechanism of the touch-sphere-based components M-A, M-B of the VR-3D-Cs 600 under tilted force. (d) Illustration of operation chart of the VR-3D-Cs 600. (e) The relationship between the detection principle of the VR-3D-Cs 600 and (f) the motion of an object 602 in 3D virtual space.

The symmetric VR-3D-CS 600 according to an example embodiment is composed of two identical non-planar TENG sensing modules, named M-A and M-B as shown in FIG. 6(a). Each single module M-A, M-B consists of top semi-sphere touch point 604, bottom functional semi-sphere 606, polytetrafluoroethylene (PTFE) thin film 608, aluminium (A1) electrode 610 and supporting structure (indicated at numeral 612 in FIG. 6(a). In a non-limiting example embodiment, the bottom semi-sphere 606 is made by mixing galinstan (eutectic alloy of 68.5% gallium, 21.5% indium and 10% tin by weight) with polydimethylsiloxane (PDMS). The galinstan-PDMS mixture functions as one triboelectric layer and conductive material [C59].

The working mechanism of each module M-A, M-B under normal force and titled force are shown in FIGS. 6(b) and (c), respectively. Under the tilted force, the each module M-A, M-B can detect both the normal and shear force components simultaneously as shown in FIG. 6(c). The attitude-control principle of the VR-3D-CS 600 is shown in FIG. 6(d-f). By the vector decomposition of the forces acting on the spheres e.g. 614, the normal and shear forces on the two modules M-A, M-B are depicted by FIG. 6(e). Through the combinational detection signals of the normal and shear forces, the 3D attitude-control of the object 602 in the space (FIG. 6(f)) can be realized along six axes (X, Y, Z and θ_{X}, θ_{Y}, θ_{Z}) in the rectangular coordinate system (FIG. 6(e)).

The basic qualitative working mechanism of the VR-3D-CS 600 according to an example embodiment under normal force is shown in FIG. 6(b) for each module M-A, M-B. Because of the work function difference between galinstan and PTFE [B60,B61], a physical contact between the two dielectric films, i.e. between the bottom semi-sphere 606 and the PTFE thin film 608, with distinct electron affinity creates oppositely charged surfaces. Negative charges will transfer from galinstan surface of the bottom semi-sphere 606 to the PTFE thin film 608, which causes the PTFE surface to carry net negative charge. Due to Coulomb's law, the total charge induced in the A1 electrode 610 is contributed by the negative charge on the PTFE surface. When the force Fₜₒₜₐₗ is applied, the positive charge on the galinstan surface is attracted significantly by the negative charge on the PTFE surface in the contacting area. The electric field generated by the positive charge is also enhanced under the contacting area.

Corresponding charge pair would be induced in the A1 electrode 610, with the resulting current flow to ground (via a resistor e.g. 616) from the A1 electrode 610. After force is released and the deformed structure recovers to initial shape, the electric field is weakened and the charge pairs in the A1 electrode 610 are also reduced, i.e. the induced positive charge in the A1 electrode 610 would flow to the ground, with a resulting current flow from ground (via resistor to the A1 electrode 610 to keep electrostatic equilibrium.

Optimizing the contact area and structure of the TENG in each module M-A, M-B can effectively increase the overall triboelectric charge density. Thus, the structure of the PTFE film 606 is designed in this example embodiment to be hemispherical, as shown in FIG. 6(a-c).

The contact area A of the galinstan-PDMS semi-sphere 606 and the PTFE film 608 is an approximate circle in the model used to analyse the example embodiment, as will now be described.

Based on the contact area between two different materials given by Hertz hypothesis, the area can be calculated as:

$${S}_{A} = {π [ \frac{3}{4} \frac{{R}_{1} {R}_{2}}{{R}_{2} - {R}_{1}} ( \frac{1 - {v}_{1}^{2}}{{E}_{1}} + \frac{1 + {v}_{3}^{3}}{{E}_{2}} ) F ]}^{\frac{2}{3}} \qquad ( A1 )$$

where S_{A} is the contact area of galinstan-PDMS semi-sphere 606 and PTFE film 608 under the force, E₁ and E₂ are the modulus of elasticity for galinstan-PDMS mixture and PTFE film 608, respectively, υ₁ and υ₂ are the Poisson's ratios, respectively. F is the applied force on the top semi-sphere 604 and R₁ and R₂ is the radius of the galinstan-PDMS semi-sphere 606 and PTFE layer 608, respectively. Because the galinstan is still liquid phase in the galinstan-PDMS mixture, the modulus of elasticity is referred to the value of PDMS.

The surface charge density, a of galinstan-PDMS and PTFE contacting area is given by [B61]:

σ=eDₛ(Wₘ−Wₚ) (A2)

where e is the charge of an electron, Dₛ is the number of surface states per unit area and unit energy. Wₘ and Wₚ are the work functions of the metal gallium and PTFE. Gallium's work function has been used to represent the work function of galinstan, for gallium is the main part of the eutectic alloy. The charge amount Q generated on galinstan surface of the contacting area is then derived as:

Q=σ·A (A3)

Combing Equations (A1) to (A3), the generated charge can be calculated. The material parameters in the equation can be obtained in Table 1 from the literature [B61-B67].

TABLE 1
Material parameters

| Parameter Name | Symbol | Value |
|---|---|---|
| Sphere diameter | R | 5 × 10⁻³ m |
| PTFE sheet thickness | d | 1 × 10⁻⁴ m |
| galinstan-PDMS mixture | E₁ | 0.75 MPa |
| elastic modulus | | |
| PTFE sheet elastic modulus | E₂ | 1.5 GPa |
| galinstan-PDMS mixture | υ₁ | 0.5 |
| Poisson's ratio | | |
| PTFE sheet Poisson's ratio | υ₂ | 0.41 |
| Charge of electron | σ | −1.602 × 10⁻¹⁹ C. |
| Vacuum permittivity | ϵ₀ | 8.854 × 10⁻¹² F. m⁻¹ |
| Relative permittivity of PTFE | ϵ₁ | 2.1 |
| Number of surface states | Dₛ | 7 × 10¹⁰ eV⁻¹ cm⁻² |
| Work function of PTFE | Wₚ | 5.75 eV |
| Work function of Gallium | Wₐₛ | 4.25 eV |
| Work function of Aluminum | W_{A1} | 4.08 eV |
| Work function of Gold | W_{A2} | 5.1 eV |

It is assumed that the galinstan-PDMS semi-sphere 606 can achieve a spherical contact area of chord length of 10 mm under normal force according to a non-limiting example embodiment.

The theoretical maximum normal force is calculated as 18 N through Equation (A1). The relationship of contacting area and induced charge Q against with applied force is almost linear in the range of 0-18 N. Therefore, the normal force can be measured through above-mentioned mechanism.

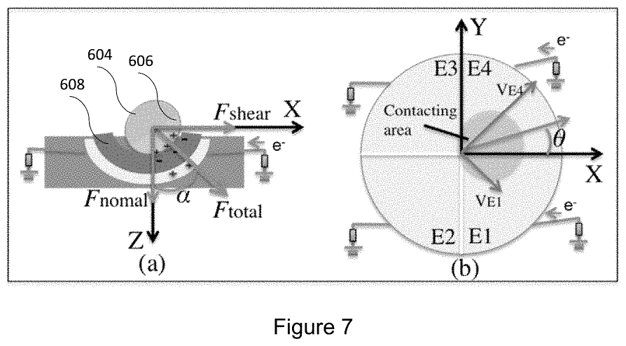

The value and direction of shear force component can be simultaneously measured by the design of four quadrant electrodes as shown in FIG. 6(c) and FIG. 7.

FIG. 7 shows: (a) Force component analysis acting on self-powered sensor according to an example embodiment. (b) The structure form with four electrodes and working mechanism for shear force detecting.

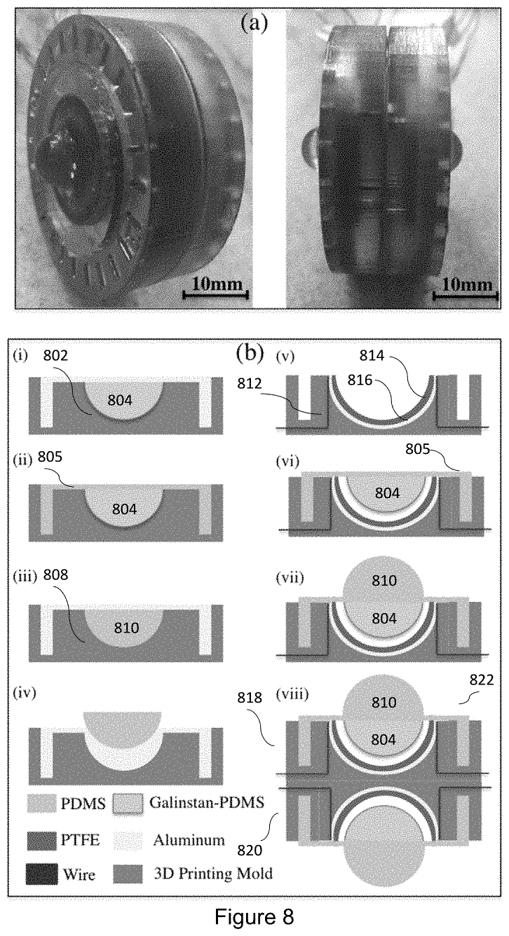

As the applied force changes, the four electrodes E1 to E4 under the PTFE sheet 608 perceive the change distribution. A PDMS film (not shown in FIG. 7, compare 805 support structure in FIG. 8 described below) supports the top and bottom semi-sphere structures, circling around the sphere 604/606, confines the sphere 604/606 position in the center. The force Fₜₒₜₐₗ applied on the top PDMS semi-sphere 604 of the sensor can be resolved into two parts, as shown in FIG. 7(a). The force contributes to form the contacting area between the galinstan-PDMS semi-sphere 606 and PTFE 608, which induces outputs of corresponding electrodes. When the force is released, the PDMS film 608 will push the sphere 604/606 back to the initial position.

To demonstrate the working mechanism, a total force Fₜₒₜₐₗ is applied so that Fₛₕₑₐᵣ is at an angle θ to the x axis, compare FIG. 7(b). The electric field on E1 and E4 generated by galinstan in the contacting area is enhanced comparing with the initial electric field. Therefore, the current flows from E1 and E4 to the ground. When the force is released, the electric fields are back to the initial state and current flows in the opposite direction. Since charge output, open circuit voltage and short circuit current of each electrode have proportional relationship with force components shared on the corresponding electrodes, force magnitude and direction can be determined by outputs of the different electrodes. FIG. 7(b) is a projection of the spherical surface of the PTFE layer 608 at the bottom. The X and Y axes coincide with the two lines of the E4 electrode sector, respectively.

For the sensor application according to example embodiments, the amplitude of the output voltage of shear force is represented by

Vₛₕₑₐᵣ=\sqrt{V_{E1}²+V_{E4}²} (A4)

As shown in FIG. 7(b), the horizontal angle θ, between the x-axis positive direction and the shear force component, is derived by

$$θ = 4 {5}^{∘} - {tan}^{- 1} \frac{{V}_{E 1}}{{V}_{E 4}} \qquad ( A5 )$$

Fabrication Process of the Self-Powered Sensor According to Example Embodiments

Photos of a sensor according to an example embodiment are shown in FIG. 8(a). The detailed fabrication process according to an example embodiment is shown in FIG. 8(b). (i) The PDMS (Sylgard 184 Dow Corning, USA) is mixed with cross-linker by the weight ratio of 10:1. The solution is then mixed with galinstan (Changsha Santech Materials, China) by the weight ratio of 1:6.44 in the crucible, and then the mixture is fully stirred and grinded until the galinstan is completely mixed with the liquid PDMS. Then the mixture is poured into a 3D printing mold 802. (ii) Pure PDMS is then poured into the partially filled mold 802 for the supporting structure 805. The filled mold 802 is cured in an oven immediately for 60 minutes under 70° C. to solidify the PDMS to form the bottom semi-sphere 804 and supporting structure 805. (iii) Next, pure PDMS is poured into another mold 808 (corresponding to mold 802) to form the top sphere 810. (iv) After the structure is degassed and cured in the oven for 60 minutes under 70° C., the top semi-sphere 810 is taken out of the mold 808 to spare. (v) The frame 812 of the sensor is fabricated with 3D printing technology. The PTFE sheet 814 and A1 electrode 816 are placed on bottom. (vi) The structure 804/805 fabricated by step (ii) is then demolded and packaged into frame 812. (vii) The PDMS top semi-sphere 810 is then bonded on the bottom semi-sphere 804 by PDMS-PDMS bonding method on the supporting structure 805. (viii) Two modules 818, 820 are attached back to back together to form a complete sensor 822.

Characterization of Normal Force Detection According to Example Embodiments

From the above analysis, the force acting on the sensor according to example embodiments contains normal force and shear force components. The shear force component has a proportional relationship with the normal force component. Therefore, the detection of normal force is performed next. Because of the symmetrical structure design of the VR-3D-CS according to an example embodiment, the normal force was detected for each module individually. First, the hammer of the force gauge is set to be exact contact with the vertex of the top semi-sphere without yielding any deformation. Because the semi-sphere radius is 5 mm in a non-limiting example embodiment, the force gauge is set to run up and down 50 cycles with a displacement of 6 mm to make sure the bottom PTFE layer is sufficiently charged.

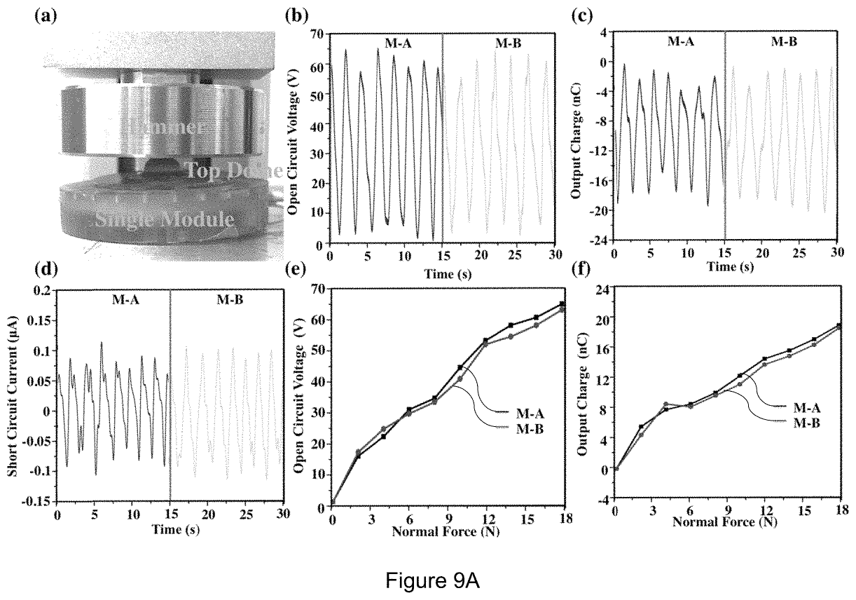

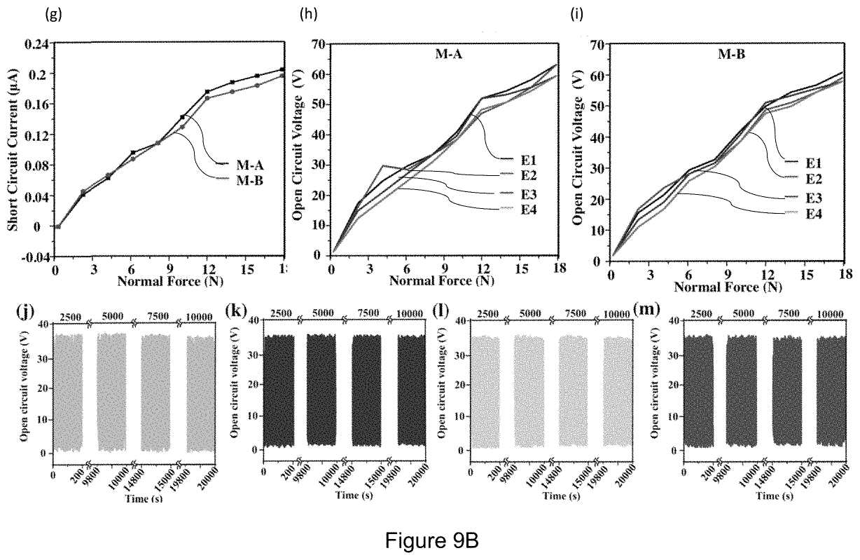

FIG. 9A shows: (a) Testing setup of normal force detection for each module of a VR-3D-CS according to an example embodiment. (b) The open circuit voltage under 18 N normal force. (c) The output charge. (d) The short circuit current. (e) The open circuit voltage versus applied normal force. (f) The output charge versus applied normal force. FIG. 9B shows: (g) The short circuit current versus applied normal force. (h) The open-circuit voltage outputs of four-electrode configuration (M-A). (i) The open-circuit voltage outputs of four-electrode configuration (M-B). (j) The reliability test of E1 under pressure of ION. The voltage change curves were recorded after each 2500 cycles and 100 cycles of data were presented in each recording. (k)-(m) The reliability test of E2-E4.

Specifically, the testing setup is shown in FIG. 9A (a). FIG. 9A (b-d) shows the E1 and E1′ outputs performance of modules M-A and M-B, respectively.

It can be readily found out that the modules according to an example embodiments have the output performance in open-circuit voltage (maximum 65 V), charge output (maximum 19.3 nC) and short circuit current (peak-peak maximum 0.2 μA). Open circuit voltage, charge output measurements of the devices were conducted with Electrometer (Keithley 6514). Short circuit current is measured by Stanford SR570. The normal force applying on the devices is generated by the force gauge (Mecmesin 2.5-I, Germany).

FIG. 9A (e-f) and FIG. 9B (g) shows the relationship of output performance against the applied force. These outputs show good linear range from 0 to 18 N, which is consistent with the theoretical and simulation results. The open circuit voltage, output charge and short circuit current sensitivity are 3.6 V N⁻¹, 1.1 nC N⁻¹ and 11.1 nA N⁻¹, respectively. This linear property is quite useful in the self-powered sensor application for normal force measurement. The open circuit voltage outputs of the four electrodes in 0-18 N linear range are shown in FIG. 9B (h)-(i). The four curves show similar linear property and comparable output amplitude comparing with the single (E1) electrode. The cycling stability of a VR-3D-CS according to an example embodiment under normal force of 10 N is tested as shown in FIG. 9B (j)-(m) by measuring the open circuit voltages of the electrodes E1-E4, respectively. The consistent voltage can be maintained after 10,000 loading-unloading cycles, implying long working life and reliability of VR-3D-CS according to example embodiments.

Characterization of Shear Force Detection According to Example Embodiments

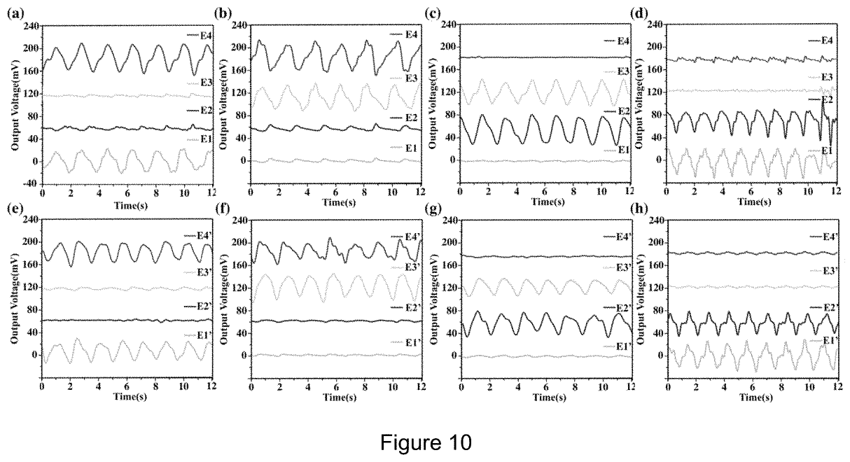

To make the testing results reliable, the force is applied at the limitation of finger capability on the top semi-sphere (or dome) of the sensor according to example embodiments in a configuration as shown in FIG. 6(d). Thumb and index fingers keep the same amplitude around 10 N and same vertical angle in different horizontal directions. First, the shear forces along the direction of X and Y axes (0°, 90°, 180°, 270°) are detected, as shown in FIG. 10.

FIG. 10 shows: (a-d) Output voltage waveform of module M-A by repetitive motions in 0°, 90°, 180°, 270° directions. (e-h) Output voltage waveform of module M-B by repetitive motions in 0°, 90°, 180°, 270° directions.

Due to the low input impedance (1 MΩ) of the oscilloscope (Agilent DSO-X 3034A) used for the measurements comparing to 200 TΩ of Keithley 6514 electrometer, the output voltages are only a small portion of the open-circuit. It can be used to resolve the horizontal direction of the shear force since output voltages are still proportional to the force amplitude. The repetitive motion of finger is repeated for more than 5 cycles and the peak-peak output voltages are calculated to elevate the accuracy and reliability of measurements.

To differentiate the output voltage waveforms of each electrode, E2(E2′), E3(E3′) and E4(E4′) have the positive voltage offsets of 60 mV, 120 mV and 180 mV, respectively. In FIGS. 10(a) and (e), the amplitudes of E2(E2′) and E3(E3′) are nearly zero, while the value of E1(E1′) and E4(E4′) are larger values because the contacting area are all on E1(E1′) and E4(E4′). E1(E1′) and E4(E4′) are almost the same due to the same contacting area on each electrode during the operation period. There are small differences in the magnitudes due to the fabrication deviations. In the same way, the 90° direction is characterized by the same value of E3(E3′) and E4(E4′) and the minimum value of E1(E1′) and E2(E2′). The 180° and 270° directions are analogous in turn as shown in FIG. 10(c), (g) and FIG. 10(d), (h).

From Equation (A5), it can be seen that the angle θ is calculated by the voltage amplitudes of two adjacent electrodes. In order to detect the resolution of the angle θ, the repetitive motion of finger is moving in different directions, respectively, increasing in units of 5.

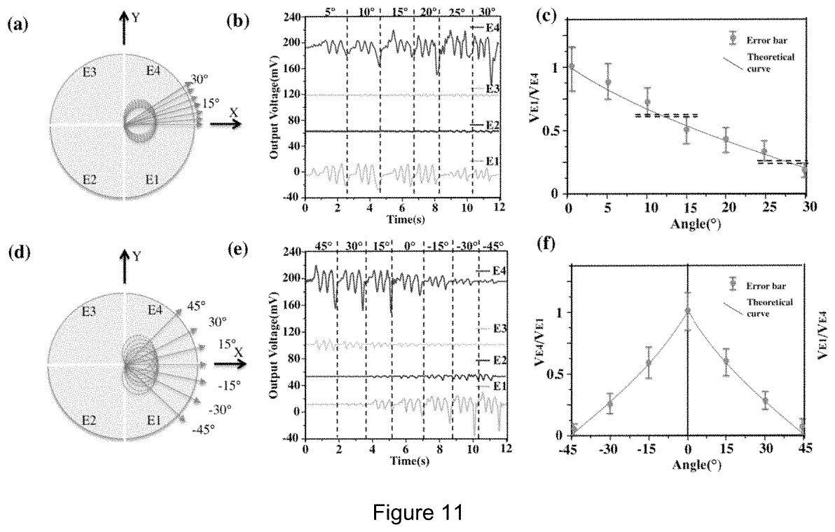

FIG. 11 shows: (a) Repetitive motion of finger in different directions from 5° to 30°, increasing in units of 5°. (b) The voltage value of four electrodes corresponding to the operation of (a). (c) Relationship between the measurement curve with error bars of V_{E1}/V_{E4} and the theoretical curve. (d) Repetitive motion of finger in different directions from −45° to 45°, increasing in units of 15°. (e) The voltage value of four electrodes corresponding to the operation of (d). (f) Relationship between the measurement curve with error bars of V_{E1}/V_{E4} (0-45°), V_{E4}/V_{E1} (−45°-0), and the theoretical curve.

Taking M-A as an example as shown in FIGS. 11(a) and (b), the voltage value of E1 gradually decreases as the angle changes, and the voltage value of E4 increases because the contacting area is increased. In order to calculate and plot the average voltage ratio of V_{E1}/V_{E4} with error bar according to example embodiments, the output voltage of each electrode was tested and the ratio for 15 times at every 50 was calculated. As shown in FIG. 11(c), it can be seen that at every 15°, the ratio value can be clearly distinguished without overlap area, as indicated by the broken horizontal lines. Therefore, it was defined that the shear force resolution detection according to example embodiments has achieved a resolution of 15°.

To further verify the accuracy of the resolution, FIG. 11(d), (e),(f) show other 7 repetitive motions with the directions of −45°, −30°, −15°, 0°, 15°, 30° and 45°, respectively. FIG. 11(f) shows the ratio value with error bar as the angle changes from −45° to 45°, increasing in units of 15°. The error bars of the 7 motions have no overlap area in the projection of ordinate. The sensor according to example embodiments can accurately identify the direction of the shear force with a resolution of 15°. In FIG. 7(b), the angle θ was defined as the acute angle between the x-axis positive direction and the shear force. So the ratio in equation (A5) is changed to V_{E4}/V_{E1} when one needs to analyse negative degrees (0 to −45°). Therefore, the result shown in FIG. 11(f) is bilateral symmetry from 0 degree and the ordinates are V_{E1}/V_{E4} and V_{E4}/V_{E1}, respectively. When the angle exceeds −45° or 45°, the calculation will change to the next pair of electrodes correspondingly.

In summary, the shear force direction can be detected by the self-powered sensor according to example embodiments through differentiating the amplitudes and phases of the four outputs.

In order to increase the angle resolution and extend the sensor applications in example embodiments, the A1 electrodes structure can be optimized to change the voltage ratio V_{E1}/V_{E4} for increasing the resolution, for example by increasing the number of electrodes, such as 8 sector electrodes, 16 sector electrodes . . . etc.

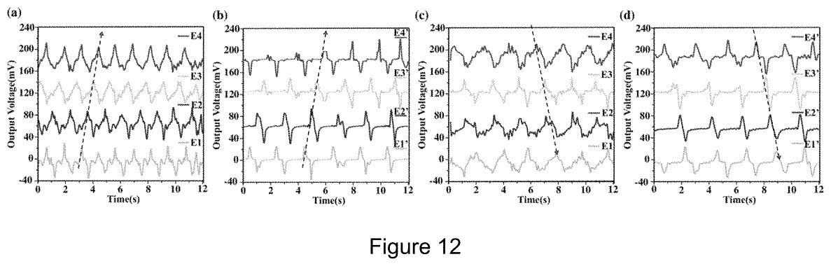

FIG. 12 shows: Voltage waveforms of the rotation motions of each module M-A, M-B according to example embodiments. (a) The motion of a clockwise rotation of M-A at a high frequency. (b) The motion of a clockwise rotation of M-B at a low frequency. (c) The motion of a counter-clockwise rotation of M-A. (d) The motion of a counter-clockwise rotation of M-B.

Specifically, FIG. 12 shows the output results for the rotation motions of the finger around the central axis of the single module. In FIG. 12(a), E1, E2, E3 and E4 have a time delay in turn, indicated by the dotted arrow. This delay shows the motion is a clockwise rotation. The rotation period is about Is. In FIG. 12(b), E1′, E2′, E3′ and E4′ also have a time delay in turn with a low frequency, indicated by the less steep dotted arrow. In FIGS. 12(c) and 12(d), E1(E1′), E2(E2′), E3(E3′) and E4(E4′) have a time advance in turn as indicated by the dotted arrows with different slopes. This time advance shows the rotation is a counter-clockwise rotation.

Therefore, in addition shear force direction detecting, the VR-3D-CS according to example embodiments is also able to detect the rotation direction and period of the finger motion. This greatly broadens the VR-3D-CS according to example embodiments for more advanced control applications. In the next section, the role of rotation direction according to example embodiments will be introduced.

Strategy and Characterization of 3D Attitude-Control According to Example Embodiments

At first, the kinematic analysis of an object in the rectangular coordinate system is studied. In 3D space, the transformation between different coordinate systems is the transformation of the different original points and coordinate axes. The rotation of the two coordinate systems can be regarded as a coordinate system that rotates three times to another coordinate system, and the three rotation angles are Euler angles in Equation (A6). Because the translation and scale transformation are simple, the rotation transformation in the rectangular coordinate system is considered for the convenience of attitude-control. And later an experiment is carried out in the rectangular coordinate system. The attitudes of an object in 3D space can be characterized by the 3D parameters (X, Y, Z and θ_{X}, θ_{Y}, θ_{Z}) in the rectangular coordinate system.

$$Euler ( {θ}_{x} , {θ}_{y} , {θ}_{z} ) Rot ( x , {θ}_{x} ) Rot ( y , {θ}_{y} ) Rot ( z , {θ}_{z} ) = [ \begin{matrix}1 & 0 & 0 \\ 0 & cos {θ}_{x} & sin {θ}_{x} \\ 0 & - sin {θ}_{x} & cos {θ}_{x}\end{matrix} ] [ \begin{matrix}cos {θ}_{y} & 0 & 0 - sin {θ}_{y} \\ 0 & 1 & 0 \\ sin {θ}_{y} & 0 & cos {θ}_{y}\end{matrix} ] [ \begin{matrix}cos {θ}_{z} & sin {θ}_{z} & 0 \\ - sin {θ}_{z} & cos {θ}_{z} & 0 \\ 0 & 0 & 1\end{matrix} ] \qquad ( A6 )$$

As described above, the normal force and shear force of each module according to example embodiments were tested respectively. In order to realize 3D attitude-control and operation for AR application, a strategy combining the component vectors is proposed. According to the attitude in 3D space, the normal forces and shear forces detected by the 8 electrodes (modules M-A and M-B combined) simulate the space vector (X, Y, Z and θ_{X}, θ_{Y}, θ_{Z}). Through the combination of these six parameters, the transformation of any attitude in 3D space can be realized. Table 2 shows the relationship between the 8 electrodes output instructions and six-axis attitude-control according to an example embodiment. In order to achieve accurate attitude operation in example embodiments, a threshold is set for the voltage output under conventional force operation. The voltage greater than the threshold is set to be “1”.

When (E1, E4) and (E1′, E4′) increase to the larger value than the threshold because the contacting areas of two spheres are all on E1, E4 and E1′, E4′ respectively, it indicates the direction of X+. And there is no signal output at the other electrodes. Similarly, the larger values than the threshold of (E2, E3) and (E2′, E3′) indicate direction X−. Similarly, the larger values than the threshold of (E3, E4) and (E3′, E4′) indicates direction Z+. The larger values of (E1, E2) and (E1′, E2′) indicate direction Z−. On the other hand, the representation of the Y direction is different from X (and Z) direction. The two symmetric modules determine the Y+ and Y-directions separately, according to an example embodiment. Specifically, When the 4 electrodes (E1, E2, E3, E4) have the same value at the same time and the 4 electrodes (E1′, E2′, E3′, E4′) have no signals, it means the direction of Y−. Oppositely, when the 4 electrodes (E1′, E2′, E3′, E4′) have the same value at the same time, it means the direction of Y+.

The larger values than the threshold of (E1, E2) and (E3′, E4′) indicates the counter clockwise rotation attitude θ_{X+}, and there is no signal output at the other electrodes. The larger values than the threshold of (E3, E4) and (E1′, E2′) indicate the clockwise rotation direction θ_{X-} Similarly, the larger values than the threshold of (E1, E4) and (E2′, E3′) indicates the counter clockwise rotation attitude θ_{Z+}, and there is no signal output at the other electrodes. The larger values than the threshold of (E2, E3) and (E1′, E4′) indicate the clockwise rotation direction θ_{Z-}.

On the other hand, to indicate the θ_{Y}, the two fingers pinch the balls at the same time, then spin clockwise (or counter clockwise) around the Y axis. In Table 2, (E4, E3, E2, E1) and (E4′, E3′, E2′, E1′) have a time delay in turn as indicated using the arrow for a counter clockwise rotation θ_{Y+} and for clockwise rotation, respectively θ_{Y-}.

Demonstration of VR-3D-CS for VR Control According to Example Embodiments

To demonstrate the practical applicability of the VR-3D-CS according to example embodiments, it was directly connected with A/D converter to control a virtual dice in virtual space

The sampling frequency of the A/D converter was 10 kHz and the precision of acquisition voltage was up to 0.01 mV. The A/D converter can collect 8 channels at the same time. The converter was connected to the USB port of a computer. In order to avoid the crosstalk between the 8 signals, mainly two measures were taken: Firstly, the A/D circuit in the convertor card used differential input to suppress common mode interference. Then, in the experiment, a relatively high threshold trigger of the sensor in the software was set to distinguish the instructions and interference. The update rate of the protocol data used in this demonstration was less than 10 Hz, thus the response time was more than 0.1 s. In the software, the communication interval is set as 0.3 s for this demonstration.

TABLE 2
Output of the electrodes corresponding to
the different operation instructions

| Direction | | | | | | | | |
|---|---|---|---|---|---|---|---|---|
| and | | | | | | | | |
| attitude | E1 | E2 | E3 | E4 | E′1 | E′2 | E′3 | E′4 |
| X | 1 | | | 1 | 1 | | | 1 |
| X− | | 1 | 1 | | | 1 | 1 | |
| Y | | | | | 1 | 1 | 1 | 1 |
| Y− | 1 | 1 | 1 | 1 | | | | |
| Z | | | 1 | 1 | | | 1 | 1 |
| Z− | 1 | 1 | | | 1 | 1 | | |
| θ_{X} | 1 | 1 | | | | | 1 | 1 |
| θ_{X}− | | | 1 | 1 | 1 | 1 | | |
| θ_{Y} θ_{Y}− | 1 1 | 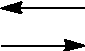 | | 1 1 | 1 1 | 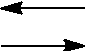 | | 1 1 |
| θ_{Z} | 1 | | | 1 | | 1 | 1 | |
| θ_{Z}− | | 1 | 1 | | 1 | | | 1 |

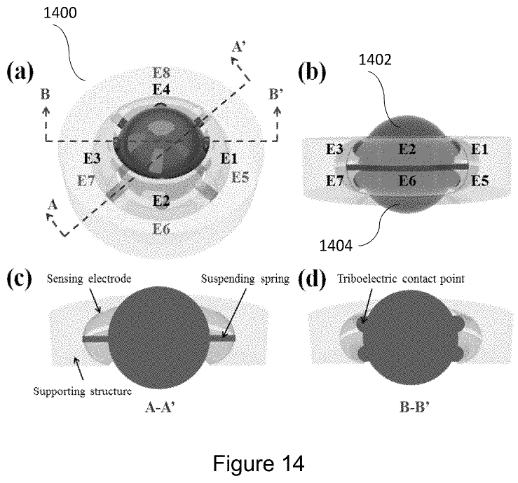

From Table 2, it can be seen that the eight electrodes do not appear to be “1” at the same time. In order to improve the interactive effect of controlling an object in AR interface, this aspect can be used to provide further control inputs, namely realize the picking and releasing movements of a virtual object according to example embodiments. When two fingers press the two spheres into the middle at the same time, eight electrodes are “1” at the same time. This process is defined as single click according to example embodiments, which means the picking movement of the virtual object. And the action of double clicks is set as the releasing movements as shown in FIG. 14(a)-(d).

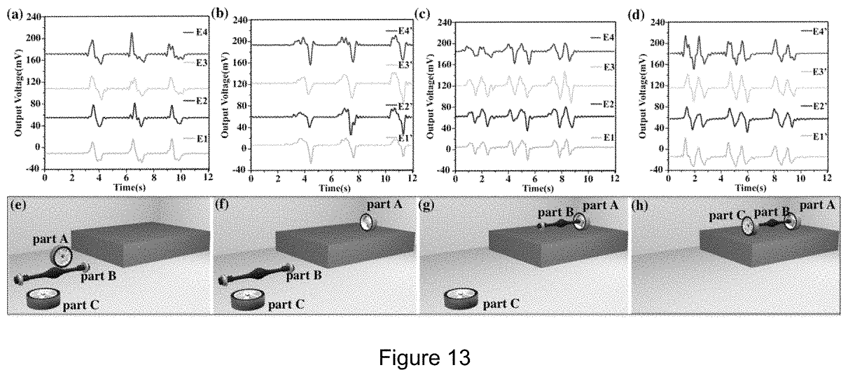

FIG. 13 shows the voltage curves of (a) M-A and (b) M-B with single click, respectively. The voltage curves of (c) M-A and (d) M-B with double clicks, respectively.

In the above description, the VR-3D-CS according to example embodiments realizes the attitude control of a single object in virtual space. In the example embodiments, the VR is realized through the “Unity3D” development engine developed by Unity Technologies, combined with the C++ programming language. The program of Unity3D can run in the Windows environment. And it can also be exported to different display platforms and combined with VR devices such as VR glass, in which the virtual 3D effect can be achieved. Currently, Unity3D is the mainstream program to realize VR and AR [B68, B69].

To highlight the control characteristics of the sensor according to example embodiments and facilitate demonstration, the Windows environment in computer terminal is used to demonstrate the VR effect. To highlight the ability of the VR-3D-CS according to example embodiments and expand its applications, the virtual assemble for an AR interface is shown in FIG. 13(e)-(h). There are three parts “A”, “B”, “C” to be assembled according to an example embodiment. The assembly process is divided into the following three steps. First step is that the part “A” is placed on the assembly platform. Then, part “B” is packed into the assemble hole of part “A”. At last, part “C” and part “B” are assembled according to the requirements. In the process of operation, the control instructions of parts correspond to the unit distance and unit angle on the six axes. With the pick and release instructions, three parts are operated in sequence, and the whole assembly process is completed. Hence, the experiments show that the VR-3D-CS according to example embodiments can not only realize the attitude-control of a single object, but also realize the assembly of a number of objects. For the future application, the device can be improved in power and portability in different embodiments, and by optimizing structure in different embodiments, e.g. the electrode structures, enabling the controlling with higher resolution.

In summary, a VR-3D-CS is provided according to example embodiments and investigated with complete theoretical model and experimental characterization. The sensor according to example embodiments can detect both the normal force and shear force, which can be used as AR interactive interface to realize 3D attitude-control operation of the objects. For detecting the normal force, it shows a linear range from 0 to 18 N in a non-limiting example embodiment. The open circuit voltage, output charge and short circuit current sensitivity are 3.6 VN⁻¹, 1.1 nCN⁻¹ and 11.1 nAN⁻¹, respectively, in a non-limiting example embodiment. In the aspect of shear force detection, a non-limiting example embodiment can resolve the shear force direction with step of at least 15°. The symmetric sensor modules according to example embodiments are designed with 2 touch points and 8 sensing electrodes. The capability of detecting the normal force and the shear force is calibrated according to example embodiments by judging voltage values of the 8 electrodes. The combination of the 8 electrode components simulates the space vector (X, Y, Z and Ox, Ay, Oz). Thus, the sensor according to example embodiments realized the 3D attitude-control operation of object in virtual space. Finally, demonstration of VR-3D-CS according to example embodiments as interactive tool is successfully realized in the virtual assembly for AR application. Considering the advantages of self-powered mechanism, cost effectiveness, and easy implementation, the VR-3D-CS according to example embodiments shows great potential for batteryless AR interface, robotics, and energy saving applications.

FIG. 14 shows a device structure of 3D sensor 1400 according to another example embodiment, which is based on an integral design providing 2 touch points 1402, 1404 and 8 sensing electrodes E1-E8. Specifically, FIG. 14 shows: a) Tilted view and b) side view of the 3D sensor. Cross-sectional view of the device structure along c) A-A′ and d) B-B′. For the contact electrification (triboelectrification) for signal generation, there can be two types of scenarios: 1) mixture of liquid metal or more positively charged particles with elastomer (PDMS or Ecoflex, etc), contacting with the surface of more negatively charged polymer layer (PTFE, FEP or PDMS, etc) with electrodes; 2) Elastomer (PDMS or Ecoflex, etc) contacting directly with the surface of electrodes. The electrodes can be fabricated by A1, Cu or Au, etc.

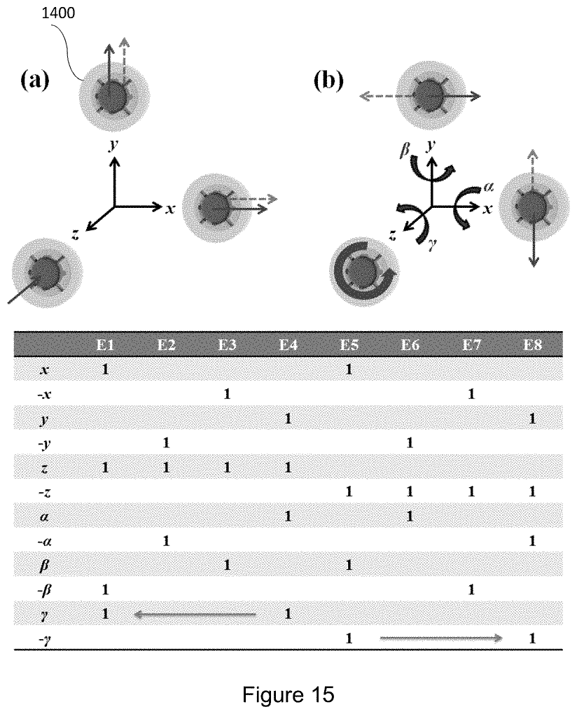

FIG. 15 shows the working mechanism of the proposed 3D sensor 1400 of FIG. 14. In the insert table, “1” means there is signal output in the corresponding electrode above a threshold, “→” or “←” means that there is a sequential output in the corresponding electrodes. As will be appreciated by a person skilled in the art, the operation principles are similar those described above with reference to the VR-3D-CS with the symmetric sensor modules M-A, M-B according to example embodiments.

The possible industrial applications of self-powered 2D and 3D sensor according to the embodiments of the present invention described above include augmented reality, human machine interface, virtual reality, IoT, smart control, and game control, etc.

In another aspect, embodiments of the present invention provide a 3-dimension (3D) symmetric triboelectric ball (hereinafter also referred to as T-Ball) with dual capability of energy harvesting and self-powered motion sensing including multi-axis acceleration and rotation. The T-Ball according to example embodiments can harvest energy under versatile scenarios, such as multi-direction vibration, spinning, rotation, rolling, human tapping/touching, water wave, etc. As a self-powered 3D accelerometer, the T-Ball according to example embodiments shows direct x, y, z axis sensitivity of 7.8 Vg⁻¹, 7.4 Vg⁻¹, 6.1 Vg⁻¹ without signal processing, respectively. Furthermore, the T-Ball according to example embodiments can serve as a self-powered gyroscope for rotation sensing with sensitivity of 4.6 mVs^{o-1}. Embodiments of the present invention show good performance in hand motion recognition with great potential for amusement, virtual reality and game control applications. Additionally, the T-Ball as a real-time activity state monitor according to example embodiments can provide useful information to healthcare monitoring system. The proposed T-Ball as a self-powered gyroscope for advanced motion sensing according to example embodiments can pay the way to a self-powered, more accurate and complete motion monitoring system.

Accordingly, in example embodiments, a triboelectric ball (T-Ball) with 3D symmetricity is provided for self-powered advanced motion sensing and multi-mode energy harvesting including water wave energy, 3D vibration, spinning, rotation and various human motion, etc.

Embodiments of the present invention provide a self-powered gyroscope based on a triboelectric mechanism. The proposed T-Ball as a self-powered gyroscope for advanced motion sensing according to example embodiments can pay the way to a self-powered, more accurate and more complete motion monitoring system. For water wave energy harvesting, the T-Ball according to example embodiments can provide a more efficient and environmental-friendly approach to harvest the large area green water wave energy.

Specifically, a triboelectric nanogenerator based gyroscope ball (T-ball) according to example embodiments with 3D symmetricity is provided for self-powered advanced motion sensing and multimode energy harvesting. The T-ball according to example embodiments is able to harvest energy from diversified scenarios, such as multiple and random directional vibration, spinning, rotation, rolling, finger tapping/touching, etc. Furthermore, it can function as a self-powered 3D accelerometer and gyroscope for advanced motion sensing including three-axis acceleration and rotation. It exhibits good performance in hand motion recognition, showing great potential in amusement, virtual reality, and game control applications. With the excellent sensing capability, the T-ball according to example embodiments is demonstrated as a self-powered exercise sensor for human activity monitoring, which can provide useful and real-time information to healthcare motion monitoring system.

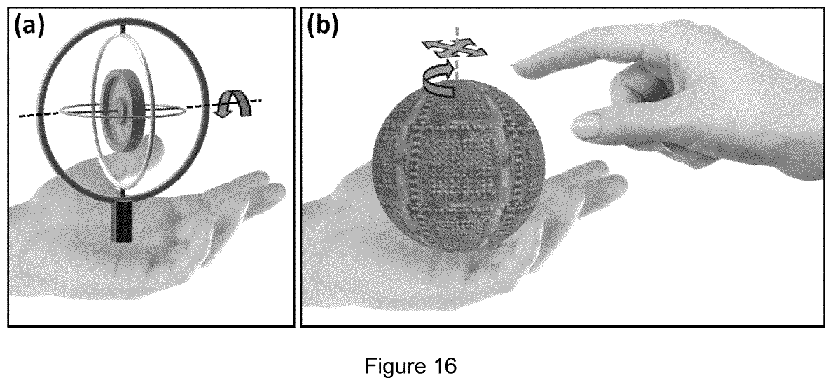

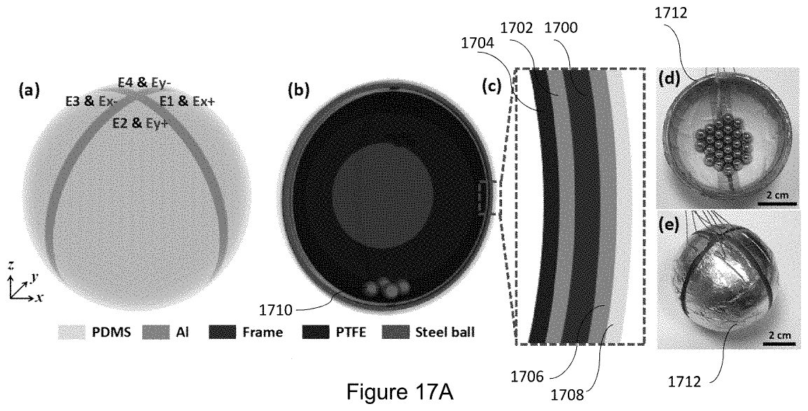

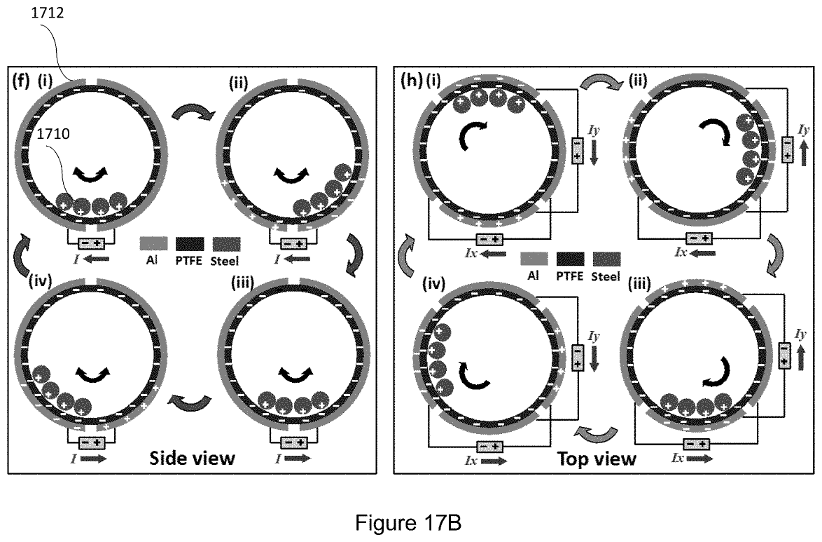

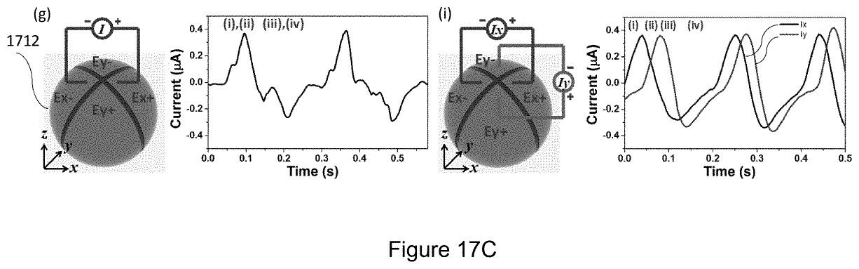

FIG. 16 shows the device configuration and photograph of the T-Ball according to an example embodiment. Specifically FIG. 16 shows: a) Schematic diagram showing the 3D structure of a traditional gyroscope. b) Conceptual illustration of the T-Ball integrated with IC circuit for energy harvesting and self-powered motion sensing according to an example embodiment. FIG. 17A shows: a) Schematic diagram showing the T-Ball device structure. Ex+, Ey+, Ex−, Ey− are inner electrodes on the inner surface and E1, E2, E3, E4 are outer electrodes on the outer surface. b) Cross sectional view of the T-Ball. c) Enlarged view of the device structure layer. d) Photograph of the T-Ball before assembling. e) Photograph of the T-Ball after assembling.

As mentioned above, a gyroscope is a sensor that can detect the rotation rate or angular velocity of an object. A traditional gyroscope with 3D symmetric structure consists of a suspending massive rotor inside three gimbals. MEMS gyroscopes with vibratory mechanical elements to sense the angular velocity have also been proposed and investigated for rotation measurement [E18-E21]. The basic device configuration of these MEMS gyroscopes includes a suspended proof mass, spring beams, driving electrodes, and sensing electrodes. The operation mechanism is that when the proof mass is driven to vibrate at resonance by electrostatic or electromagnetic force from the driving electrodes, an angular rotation will induce Coriolis force at the driving frequency which can be detected by the sensing electrodes. These MEMS gyroscopes require a vibrating proof mass and actuators to drive it in the resonant state, which causes significant power consumption from external power supply. Toward self-powered sensing ability, piezoelectric and triboelectric mechanisms provide a promising solution [E22-E30].

Furthermore, triboelectric mechanism exhibits great merits of high output performance, cost effectiveness, simple device configuration, easy scalability, and a wide range of material selection [E31,E32]. TENG based on triboelectrification and electrostatic induction between two different materials was first proposed in 2012, and since then has received tremendous research effort in diversified energy harvesting and self-powered sensing applications [E33-E41]. Therefore, by leveraging the advantages of symmetric structure and the merits of triboelectric mechanism, a 3D symmetric T-ball for multimode energy harvesting and self-powered advanced motion sensing according to example embodiments is provided.

The detailed device configuration of the T-ball according to an example embodiment with tilted view and cross-sectional view is shown in FIG. 17A (a,b). The enlarged view of the layer-by-layer structure is illustrated in FIG. 17A (c). The T-ball according to example embodiments is constituted of a 3D printing ball-shaped frame 1700, four inner A1 electrodes e.g. 1702 covered by polytetrafluoroethylene (PTFE) thin film 1704, four outer A1 electrodes e.g. 1706 covered by polydimethylsiloxane (PDMS) 1708, and multiple steel balls e.g. 1710 encapsulated inside. The outer electrodes are fabricated on the outer surface of T-ball to further enhance the energy harvesting capability. As will be described below in more detail. The dimension of the T-ball according to a non-limiting example embodiment is 65 mm in diameter.

The multiple small steel balls 1710 with diameter of 6.3 mm according to a non-limiting example embodiment serve as movable mass and triboelectric layer.

The four inner electrodes e.g. 1702 are denoted as Ex+, Ey+, Ex−, and Ey−, while the four outer electrodes e.g. 1706 are denoted as E1, E2, E3, and E4 (see FIG. 17A (a). Then the face-to-face Ex+ and Ex− are connected as the positive and negative input of Ex, while Ey+ and Ey− are connected as the positive and negative input of Ey for energy harvesting and motion sensing, as will be described in more detail below. On the other hand, the four outer electrodes E1, E2, E3, and E4 are working under single electrode mode for energy harvesting, as will also be described in more detail below. FIG. 17A (d,e) show photographs of the T-ball 1712 according to an example embodiment before and after the assembling, respectively.

Due to the 3D symmetric ball-shaped design, the T-ball 1712 according to example embodiments has the ability to harvest energy from diversified sources and the potential for complex and advanced motion sensing. Although complex motion may exhibit random-direction movement and rotation, it can always be considered as the integration of linear movement in x, y, and z-axis and rotation. Accordingly, the movement of steel balls e.g. 1710 inside the T-ball 1712 according to an example embodiment can be divided into three major categories—i) moving along one direction with an in-plane (x-y plane) vibration, ii) moving along the z-axis with an out-of-plane (vertical) vibration, and iii) spinning around the inner surface of the T-ball 1712.

The operation mechanism of the T-ball 1712 activated by in-plane vibration is depicted in FIG. 17B (f) in side view, i.e. the x-y plane is perpendicular to the plane of the page. After contacting with each other, the steel balls e.g. 1710 become positively charged and the PTFE 1704 becomes negatively charged because of the difference in electron affiliation/work function. It is noted that the terms electron affiliation and work function are used herein as synonymous. When the steel balls e.g. 1710 move to the right side (compare FIG. 17B (f)(i)-(ii), T-Ball 1712 moving to the left), electric potential difference appears on the two opposite electrodes Ex+, Ex− and then drives electrons flow from the right electrode Ex+ to the left electrode Ex− until a new balance is achieved. Then, when the steel balls e.g. 1710 move from the right side to the middle part and further to the left side (compare FIG. 17B (f)(ii)-(iii), T-Ball 1712 moving to the right), electrons are forced to flow in the opposite direction. FIG. 17C (g) presents the schematic illustration of the wire connection and current waveform from Ex when the T-ball 1712 according to example embodiments is vibrating in x direction. Only the inner electrodes and the PTFE thin film are shown in the schematic diagram to clearly indicate the wire connection. When the T-ball 1712 is solely vibrating along x or y direction, there will be only one output in the corresponding direction since there is no electric potential difference in the other direction. However, when the T-ball 1712 is vibrating with a certain angle θ with respect to x-axis (0°<0<90°), there will be two outputs from both Ex and Ey. Thus, the T-ball 1712 has the capability to harvest energy from in-plane vibration source in random and multiple directions.

The electric potential difference on all the four inner electrodes is the same in vertical vibration, since the steel balls typically do not “cross” from one to the other inner electrodes, thus in this case the four inner electrodes are connected in single electrode mode. It should be noted that the inner electrodes are connected in single electrode mode only in vertical vibration motion, otherwise they are connected as Ex and Ey. Specifically, when the T-ball 1712 vibrates downward, the steel balls e.g. 1710 depart from the bottom surface of the T-ball 1712, driving electrons flow from the inner (single connected) A1 electrode to ground to balance the electric potential difference. Then when the T-ball 1712 vibrates upward, the steel balls e.g. 1710 contact with the bottom surface of the T-ball 1712 again and electrons are driven to flow back.

The operation mechanism of the T-ball 1712 when it is activated by moving in a circle motion is depicted in FIG. 17B (h) in top view. When the T-ball 1712 is moved clockwise in x-y plane around a circle with its own orientation maintaining the same, the steel balls e.g. 1710 then undergo circular movement around the inner surface. Thus, electric potential difference is induced on all the four inner electrons (Ex+, Ey+, Ex−, and Ey−) in a consecutive way. The generated electric potential difference then drives electrons to flow between the corresponding inner electrodes and thereby current is generated. The clockwise circular movement of the steel balls e.g. 1710 results in Ex current waveform with one quarter phase shift in front of Ey current waveform, since the steel balls e.g. 1710 move in the direction of Ex+, Ey+, Ex−, and Ey−.

FIG. 17C (i) shows the wire connection and current waveform from Ex and Ey (i.e. separately connected, not single electrode mode) when the T-ball 1712 is spinning clockwise. If the T-ball 1712 is spinning in an anticlockwise direction, the current waveform of Ey will then be one quarter faster in phase.

The T-ball 1712 according to example embodiments can not only harvest energy from versatile vibration and rotational movement sources, it can also harvest the human tapping and touching energy. With reference again to FIG. 17A (a)-(c), the four outer electrodes E1 to E4 are connected in single electrode mode to harvest the energy more effectively. When an active object such as human finger contacts with the PDMS 1708 surface, triboelectrification arises between the human skin and the PDMS 1708 surface. Most common active objects like human skin, metal surface, and fabric materials are more positive in the triboelectric series compared to PDMS 1708, thus the PDMS 1708 surface becomes negatively charged and the human finger becomes positively charged. After the triboelectrification, when the human finger is approaching the PDMS 1708 surface, electric potential difference drives electrons to flow from ground to the outer A1 electrode 1708 (E1 to E4 in single electrode mode). Then, when the human finger is moving away from the PDMS 1708 surface, electrons are driven to flow back to ground.

Characterization and Optimization of the T-Ball According to Example Embodiments

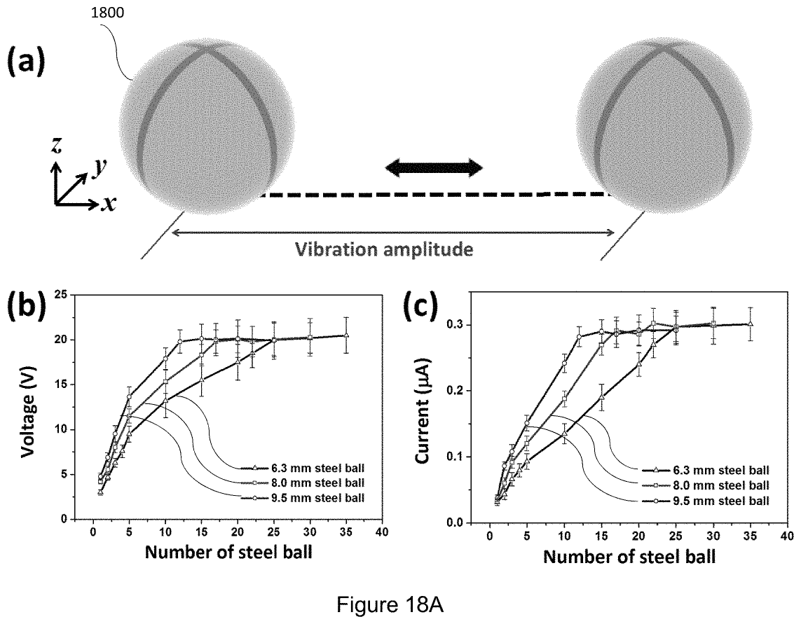

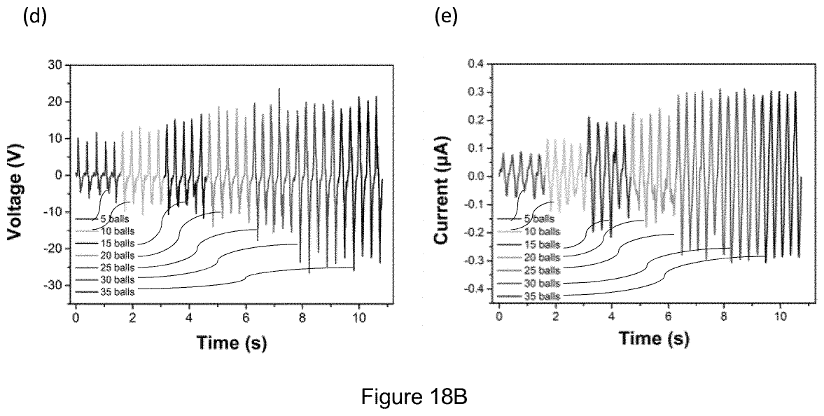

After the fabrication of electrodes and dielectric layers, multiple steel balls as movable mass and triboelectric layer are put inside the T-ball according to example embodiments. The size and the number of the steel balls to be included is a key parameter which has significant impact on the output performance. Thus, the T-ball according to example embodiments is first characterized and optimized in terms of the size and the number of steel balls. The T-ball 1800 is tested under the setup shown in FIG. 18A (a), where it is periodically vibrated along the x-axis with frequency of 3.2 Hz and displacement amplitude of 3 cm. The amplitudes of output voltage and current from Ex are measured and plotted in FIG. 18A(b,c), respectively, when the number of different diameter steel balls (6.3, 8.0, and 9.5 mm) increases. FIG. 18B (d,e) shows the output voltage and current waveform, respectively, with different number of 6.3 mm steel balls plotted consecutively over a time axis for comparison.

It can be seen that the output voltage and current amplitudes first increase with the number of steel balls and then saturates at a certain level for all three types of steel balls. The larger diameter steel balls show faster output increment rate due to the faster increment of effective contact area. The output voltage and current amplitudes for the three different diameter steel balls saturates at the same level but with different number of steel ball—12 (9.5 mm), 17 (8.0 mm), and 25 (6.3 mm). Due to the ball-shaped curve surface of the T-ball according to example embodiments, extra steel balls beyond the saturation level only stack on the previous steel balls during vibration, without actually contributing to the effective contact area. Thus, the output voltage and current amplitudes saturate at the number of 12, 17, and 25 for steel balls of 9.5, 8.0, and 6.3 mm, respectively, according to non-limiting example embodiments. From the analytical model results, it can be observed that the effective contact area is dominated by the shadow area of the steel balls. For the T-ball according to one non-limiting example embodiment, 6.3 mm steel balls with number of 25 are adopted as the optimized condition for energy harvesting and sensing measurements discussed below, unless otherwise specified.

Multimode Energy Harvesting Capability According to Example Embodiments

Due to the high symmetricity, the T-ball according to example embodiments can harvest energy under a wide variety of circumstances. As discussed before, the steel balls' movements inside the T-ball can be divided into in-plane vibration, out-of-plane vibration, and circular motion. In reality, various ambient motions acting on the T-ball according to example embodiments can cause these movements of the steel balls. Ambient vibrations are common energy sources that can be found from machine movement, vehicle engine, water wave, various human motion, etc. Normally, these vibrations exhibit multiple and random directions.

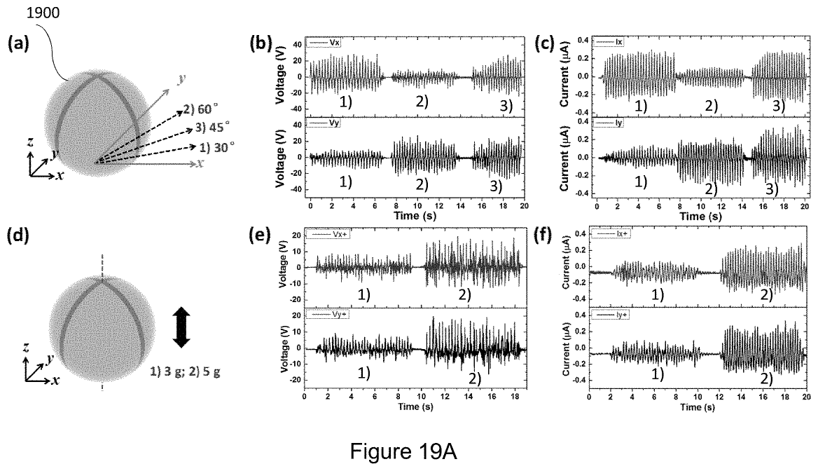

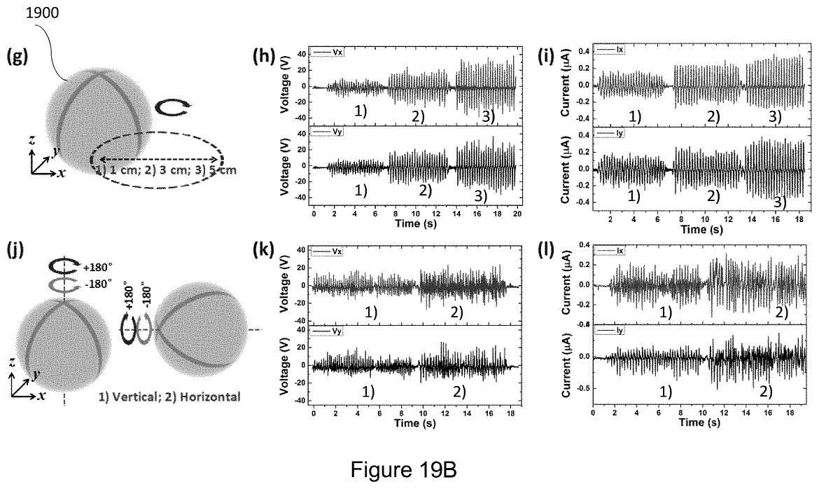

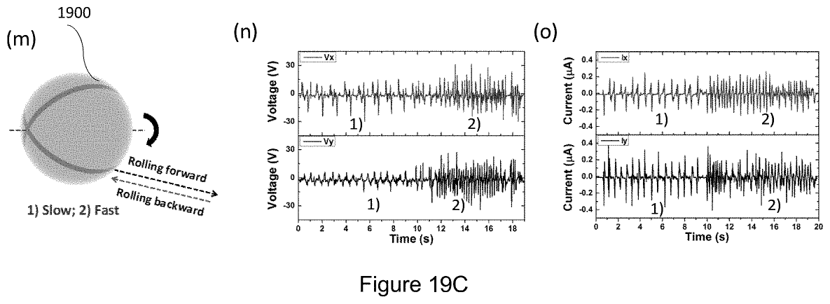

In order to demonstrate its capability of multimode energy harvesting, the T-ball 1900 according to example embodiments is tested under different circumstances as illustrated in FIG. 19. Both the output voltage and current performance from Ex and Ey are measured for all the circumstances. As shown in FIG. 19A (a-c), the T-ball 1900 according to example embodiments is first tested under in-plane vibration along 30°, 60°, and 45° with respect to x-axis. When the T-ball 1900 is vibrating with angle of 30°, output from Ex is larger than that from Ey since the vibration component in x direction is larger than in y direction. Similarly for vibration angle of 60°, output from Ey is larger than that from Ex. With vibration angle of 45°, output from Ex and Ey shows the same level. In addition to in-plane vibration, the T-ball 1900 is then tested under out-of-plane vibration as demonstrated in FIG. 19A (d-f) with acceleration of 3 and 5 g. The acceleration is measured by a commercial accelerometer (ADXL325, Analog Devices) assembled on the T-ball 1900 according to example embodiments. For the vertical vibration, electrodes Ex+ and Ey+ are connected as single electrode to measure the output voltage and current. When the acceleration level increases, the output voltage and current also increases.

The above results show that the T-ball according to example embodiments has the capability to harvest both in-plane and out-of-plane vibration energy from multiple and irregular directions. Similar to vibration motion, spinning or rotation motion is also common in the ambient environment, for example, rotating wheels, moving fans, operating washing machine, swerving, etc. FIG. 19B (g-i) presents the results when the T-ball according to example embodiments is moved in a circle with diameter of 1, 3, and 5 cm (plotted consecutively along the time axis for comparison) while its orientation remains the same. When the circle diameter increases from 1 to 5 cm, output voltage and current increases from 8 to 32 V and from 0.15 to 0.35 μA, respectively. When the steel balls undergo circular movement, the centripetal force is

f_{c}=mrω² (B1)

where f_{c} is the centripetal force required to maintain the circular movement, m is the object mass, r is the radius of curvature, and ω is angular velocity. When the circle diameter increases, higher centripetal force is required to sustain the circular movement. In order to achieve higher centripetal force, the steel balls need to move to higher position on the inner surface of the T-ball 1900, resulting in larger contact area and higher output.

The testing results of rotating are depicted in FIG. 19B (j−1) when the T-ball 1900 according to example embodiments, specifically when the 3 T-Ball 1900 is rotating along its z-axis 1) vertically and 2) horizontally (plotted consecutively along the time axis for comparison).

Output from horizontal rotation is higher than that from vertical rotation due to the larger contact area of steel balls on the boat-shaped electrodes when the T-ball 1900 is rotating with its z-axis placed horizontally. Rolling can be treated as a special case of rotation without fixed rotation axis. The testing results of the T-ball 1900 according to example embodiments when it is rolling 1) slowly and 2) fast (plotted consecutively along the time axis for comparison) on a table are illustrated in FIG. 19C (m-o). Higher output is generated with fast rolling.

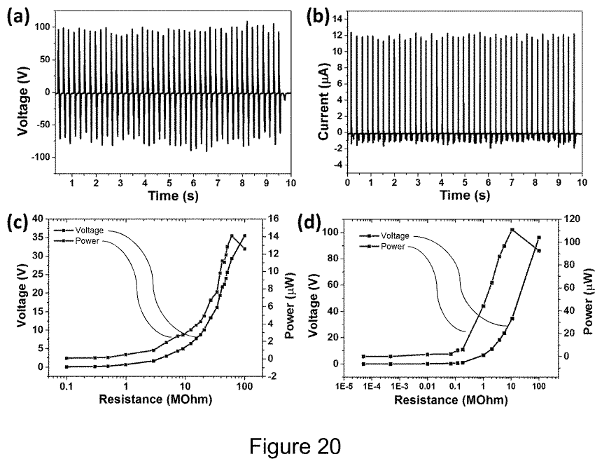

FIG. 20 shows energy harvesting by a T-Ball according to an example embodiment from the outer electrodes and output power performance, specifically: a,b) Output voltage and current from the outer electrode E1 when the T-Ball according to an example embodiment is tapped by human finger at ˜4 Hz. c) Output voltage and power from Ex with different external load resistance when the T-Ball according to an example embodiment is moved at 4 Hz around a circle of 5 cm diameter. d) Output voltage and power from E1 with different external load resistance when the T-Ball according to an example embodiment is tapped by human finger at ˜4 Hz.

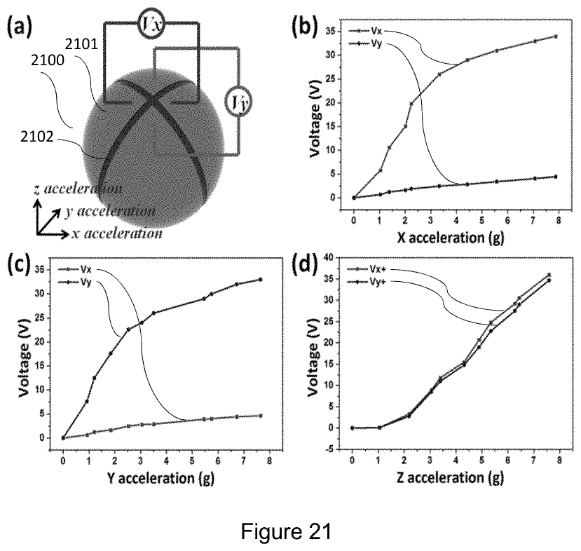

FIG. 21 shows the T-Ball 2100 as a Self-powered 3D accelerometer according to example embodiments, specifically: a) Schematic illustration of the T-Ball 2100 with wire connection and applied acceleration in x, y, z direction. Only the inner electrodes e.g. Ex− 2101 and PTFE film 2102 are shown in the schematic illustration. b) The output voltage from Ex and Ey with different x acceleration. c) The output voltage from Ex and Ey with different y acceleration. d) The output voltage from Ex and Ey with different z acceleration.

Self-Powered Advanced Motion Sensor According to Example Embodiments

Apart from the multimode energy harvesting capability, the 3D symmetric T-ball according to example embodiments is ideally suitable for self-powered advanced motion sensing. When operating as self-powered sensor, the outer electrodes of the T-ball according to example embodiments are grounded to minimize the electrostatic interference. Conventional TENGs normally can only achieve one-axis acceleration sensing, but the T-ball according to example embodiment is able to function as a self-powered 3D accelerometer.

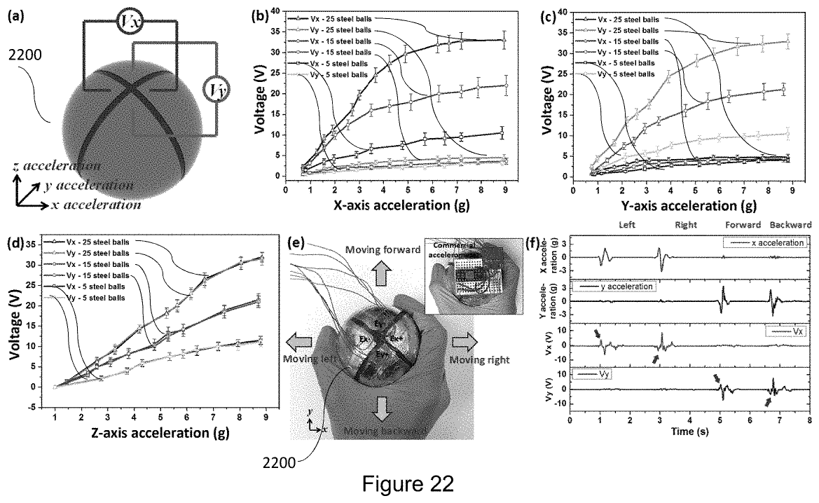

As shown in FIG. 22a, acceleration with different magnitude is applied on the T-ball 2200 according to example embodiments in x, y, and z-axis direction. The output voltage from Ex and Ey is measured when x and y-axis acceleration is applied, while the output voltage from single electrode Ex+ and Ey+ is measured with z-axis acceleration is applied. FIGS. 22b-d present the relationship of output voltage and x, y, and z acceleration when different number of 6.3 mm steel balls are encapsulated inside the T-Ball 2200 according to non-limiting example embodiments. When the T-ball 2200 is vibrating in x direction, voltage from Ex first increases significantly with x-axis acceleration but then gradually saturates as shown in FIG. 22b. This can be attributed to the large increment of contact area with small acceleration, but only small increment of contact area is achieved with large acceleration. Larger number of steel balls show higher output. The linear range and sensitivity for x-axis acceleration sensing with 25 steel balls is 4.87 g and 6.08 V g⁻¹, according to a non-limiting example embodiment. It can be observed that voltage from Ey is almost 0 since no electric potential difference is generated on electrode Ey+ and Ey− when the T-ball 2200 is vibrating along the x direction. The small voltage from Ey with increasing x acceleration is caused by the fabrication error and alignment error, that is, the four electrodes are not perfectly symmetric and the alignment of the vibration is not exactly in x direction. Measurement results are similar for y-axis acceleration, where the linear sensing range and sensitivity with 25 steel balls is 5.06 g and 5.87 V g⁻¹.

For z-axis acceleration, voltage is generated from both Ex+ and Ey+ when the steel balls start to vibrate. When z acceleration is less than 1 g, almost no output voltage is observed from Ex+ and Ey+, because the acceleration is not able to separate the steel balls from the bottom surface of the T-ball. When z acceleration further increases, output voltage increases with sensitivity (25 steel balls) of 3.62 V g⁻¹.

The T-ball 2200 as a 3D accelerometer according to example embodiments exhibits better or comparable sensitivity than the previously reported TENG-based accelerometers [E23,E24,E26], showing great capability for various applications in motion sensing. The T-ball according to example embodiments can be used for self-powered human gesture or hand motion recognition.

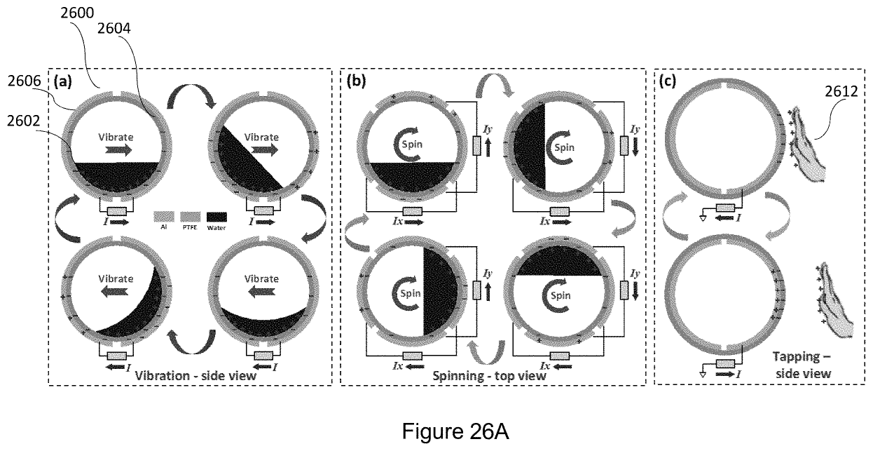

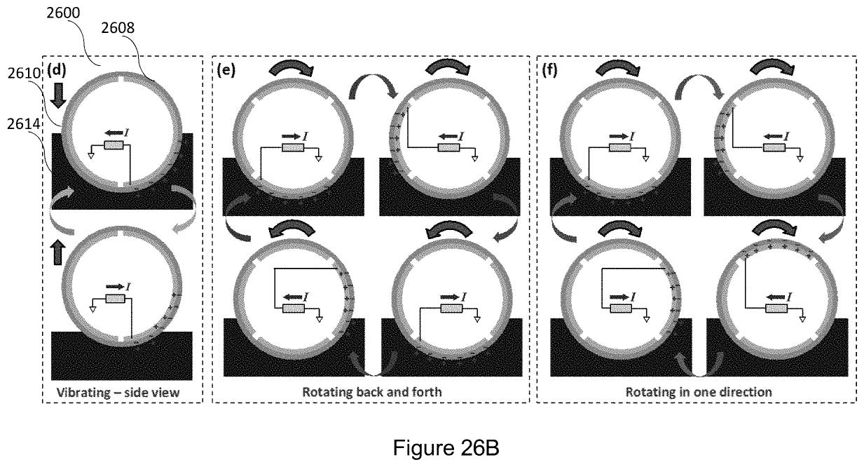

FIG. 22e shows the T-ball 2200 according to an example embodiment held by a human hand for moving direction monitoring. A commercial accelerometer (ADXL325, Analog Devices) is assembled on a small breadboard and attached on top of the T-ball 2200 to measure the actual acceleration. Output voltage from Ex and Ey is connected to an oscilloscope for waveform recording when the T-ball 2200 is moving left, right, forward, and backward. After each movement, the T-ball always moves back to the original position, waiting for the next movement. FIG. 26f illustrates acceleration from the commercial accelerometer (top two graphs for x and y acceleration, respectively) as well as the output voltage waveform from Ex and Ey (bottom two graphs, respectively). When moving left, Vx first shows a positive peak and then several vibrating peaks while Vy shows no signal since acceleration is in x direction. When moving right, Vx first shows a negative peak and then several vibrating peaks while Vy also shows no signal. The first peaks are indicted by arrows. The output voltage waveforms can be explained because when the T-ball 2200 is moving to the left side, the steel balls are first swung to electrode Ex+ and then vibrate, thus a positive peak is generated at the beginning.

When the T-ball 2200 is moving to the right side, the steel balls are first swung to electrode Ex− and thus a negative peak is generated at the beginning and then vibrate. The same phenomenon happens when the T-ball 2200 is moving forward and backward except that the acceleration is in the y-direction.

While existing TENGs have been extensively developed for various motion sensing including pressure/force, strain, tactile, and acceleration, no rotation sensing has been reported to the inventors' knowledge. For the first time, triboelectric mechanism is demonstrated for self-powered rotation sensing by using the T-ball according to example embodiments.

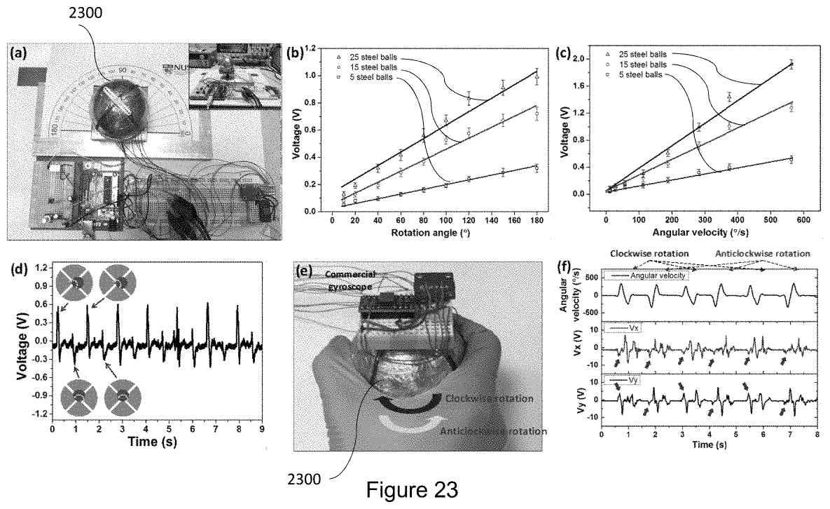

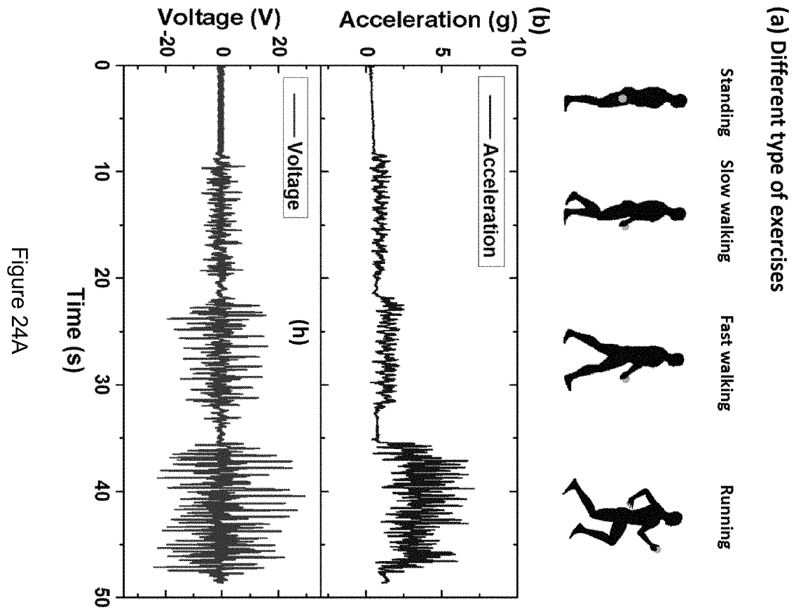

As illustrated in FIG. 23a, the T-ball 2300 according to an example embodiment is fixed on a servo motor which can be controlled by Arduino microcontroller with different rotation angles and angular velocities. In the following, rotation angle means the ball is rotating around its z axis with by certain degree, one circle is 360 degree. Angular velocity means rotation rate.

Output is generated due to the relative movement of steel balls mass and inner surface. The performance of the T-ball 2300 is characterized under different rotation angles and angular velocities. FIG. 23b shows the output voltage from Ex when the rotation angle is changed from 100 to 180° with the angular velocity fixed at 280° s⁻¹ and varying number of 6.3 mm steel balls from 5 to 25 according to non-limiting example embodiments. Output voltage with different angular velocities is also measured with the rotation angle fixed at 180°, as shown in FIG. 23c. The output voltage waveform from Ex is depicted in FIG. 23d when the angular velocity is 280° s⁻¹ and the rotation angle is 180°. The output signal from rotation is generated by the movement of the steel balls. Major peaks are generated by the movement of the majority of the steel balls across the sensing electrode and small peaks are generated by the movement of the minority steel balls across the same sensing electrode (with time lag). The major peaks are marked by arrows in FIG. 23d and the schematic illustration of the steel balls movement is also indicated to show their inherent relationship (majority and minority separated by the borderline in the overall steel ball group). Major positive peaks are produced when the steel balls move on Ex+, while major negative peaks are produced when the steel balls move away from Ex+. The voltage and rotation angle/angular velocity relationship is extrapolated by extracting the peak-to-peak voltage from the output voltage waveform data under different testing conditions.

It can be observed that output voltage linearly increases with the rotation angle, since larger rotation angle induces higher electric potential difference on inner electrodes and thus higher output. The output voltage also linearly increases with the angular velocity. More steel balls encapsulated in the T-ball provide larger effective contact area and thus induce higher output signal and sensitivity. The output voltage sensitivity of 25 steel balls for angular velocity sensing without further signal processing or amplification is 3.5 mV per degree per second according to a non-limiting example embodiment. Benefited from the rotation sensing ability, the T-ball 2300 according to example embodiments can be used for rotating human gesture recognition.

FIG. 23e shows the T-ball 2300 according to an example embodiment with a gyroscope (ADXRS622, Analog Devices) for rotation direction monitoring. FIG. 23f depicts the angular velocity and output voltage waveform when the T-ball is rotating clockwise and anticlockwise.

When the device is rotating, output voltage signal is generated from both Ex and Ey. For clockwise rotation, Vx (middle graph) first shows a negative peak and Vy (bottom graph) first shows a positive peak. While for anticlockwise rotation, Vx first shows a negative peak and Vy also first shows a negative peak. This is because when the T-ball 2300 is rotated clockwise by a human hand, the steel balls are first swung to Ey+ and Ex−, and then spin around the inner surface of the T-ball 2300 in the clockwise direction. Hence, a negative peak is first generated in Vx and a positive peak is first generated in Vy. Then when the T-ball is rotated anticlockwise, the steel balls are first swung to Ey− and Ex− (and then spin around the inner surface of the T-Ball 2300 in the anticlockwise direction), thus a negative peak is first generated in Vx and a negative peak is first generated in Vy. When the T-ball 2300 is operated under different moving and rotation direction, different waveforms of Vx and Vy can be identified by a signal processing circuit and can serve as controlling signal for motion recognition system. The T-ball 2300 shows great potential for the applications in smart controlling system, virtual reality, game control, etc.

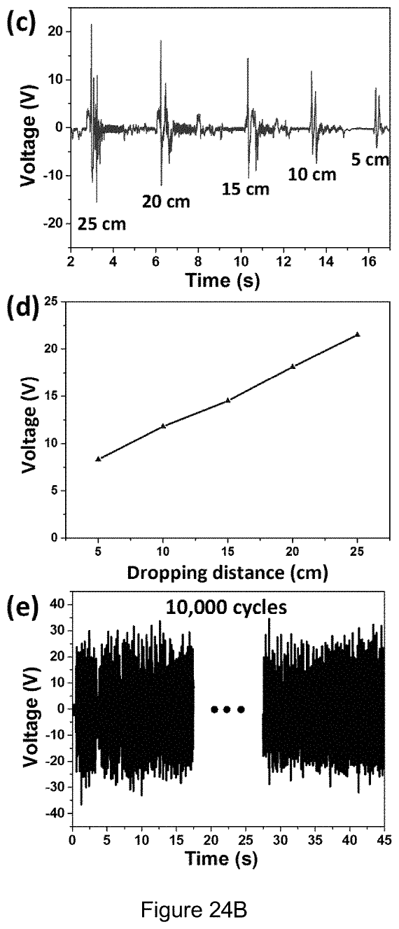

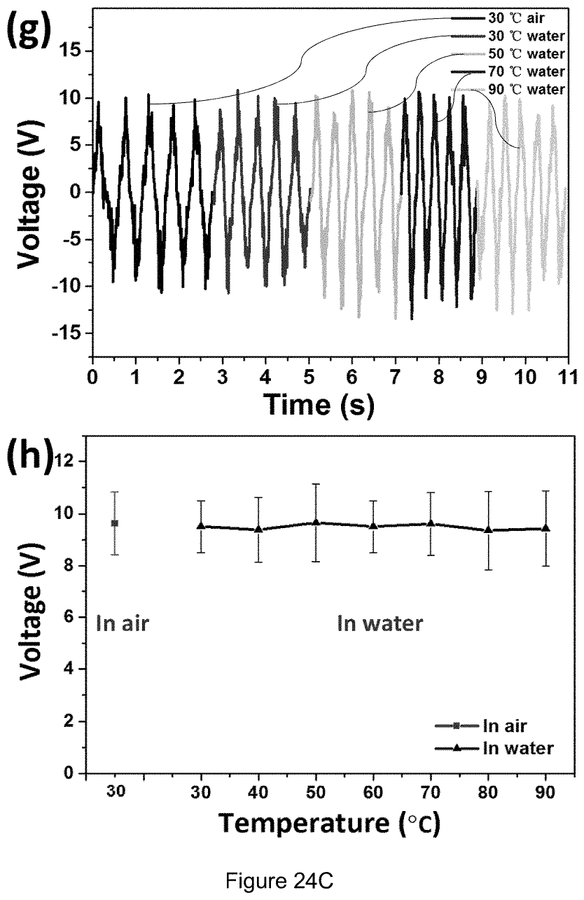

Monitoring daily activity state or exercise level is important in healthcare monitoring system for rehabilitation or diagnostics. The T-ball according to example embodiments as a self-powered exercise sensor can be mounted on the human hand for different exercise state sensing, as shown in FIG. 24A (a). The x-direction of the T-ball according to an example embodiment is aligned with the moving direction of the human. When standing, walking slowly, walking fast, or running, the output voltage from Ex is plotted in FIG. 24A (b) along with the corresponding acceleration level derived from a commercial accelerometer.

Corresponding to the increment of acceleration, the output voltage of the T-ball also increases. Other than just judging from the output voltage waveform, frequency domain analysis can also be performed to determine which exercise the tester is undergoing. No significant output peak in frequency domain can be observed when the tester is standing still, while a small peak with amplitude of 0.17 at 0.80 Hz appears when the tester is walking slowly. When the tester is walking fast, the peak amplitude increases to 0.62 and frequency increases to 1.00 Hz. For running, amplitude and frequency further increase to 1.00 and 1.35 Hz, respectively. The amplitude in the frequency domain is normalized to the amplitude when the tester is running. Based on the frequency domain analysis results, different types of exercise can be easily determined from the output signal of the T-ball according to example embodiments.

The T-ball according to example embodiments can also function as a dropping sensor to measure the free dropping distance. FIG. 24B (c,d) shows the output voltage of the T-ball according to an example embodiment when it is dropped from dropping distance of 5 to 25 cm. The output voltage increases with the dropping distance since higher dropping distance induces higher backward acceleration on the T-ball. FIG. 24B (e) depicts the output voltage of the T-ball according to example embodiments after 10 000 cycles of vibration, showing the robustness of the T-ball for long-term applications.

The device performance under extreme environmental conditions such as high temperature and high humidity is also very important for many sensing applications. The output voltage performance of the T-ball according to an example embodiment in air and in water with different temperatures is depicted in FIG. 24C (g,h), respectively. From the results, it can be seen that the performance of the T-ball according to an example embodiment is almost constant in underwater environment with temperature increases from 30 to 90° C., compared to the performance in air. The ability of the T-ball according to example embodiments to operate in high temperature, high humidity, and underwater environment promotes a wide range of extended applications such as underwater sensor and water wave energy harvester.

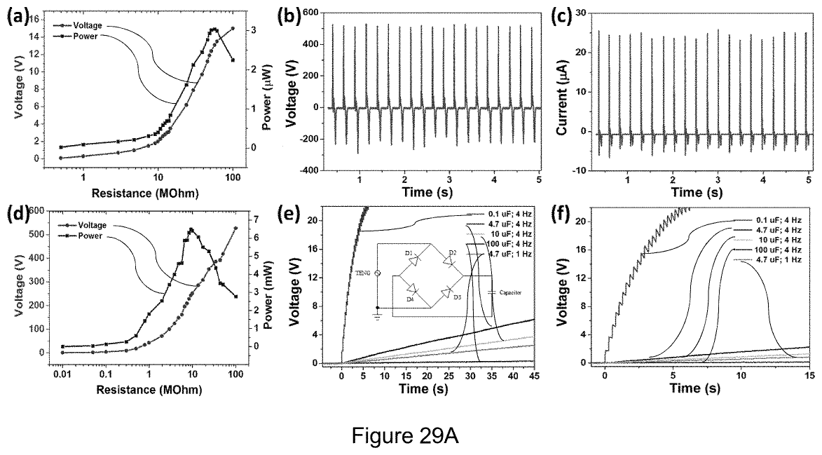

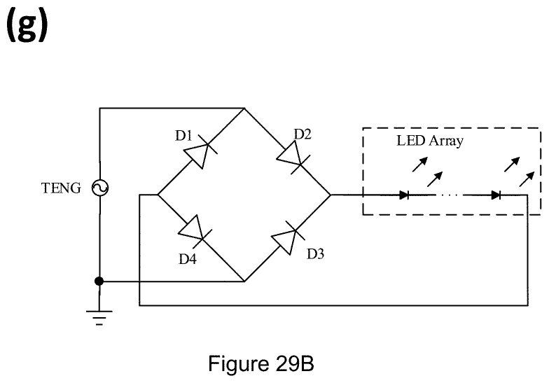

FIGS. 29A and B shows the energy harvesting capability of the T-BALL according to example embodiments from outer electrode, specifically: FIG. 29A (a) Output voltage and power from inner electrode Eᵢₙ₋ₓ under spinning movement at 4 Hz. FIG. 29A (b) Output voltage and FIG. 29A (c) output current from the outer electrode Eₒᵤₜ₋ₓ₊ under finger tapping at 4 Hz. FIG. 29A (d) Output voltage and power from outer electrode Eₒᵤₜ₋ₓ₊ under finger tapping. FIG. 29A (e) Capacitor charging by finger tapping on different capacitors. Insert shows the rectifier circuit for capacitor charging. FIG. 29A (f) Enlarged view of the capacitor charging curve. FIG. 29B (g) Rectifier circuit for direct LED array lighting by the T-BALL under finger tapping.

As described above, a 3D symmetric T-ball is provided according to example embodiments for multimode energy harvesting and self-powered advanced motion (multiaxis acceleration and rotation) sensing. A self-powered gyroscope for rotation sensing based on triboelectric mechanism is demonstrated using the T-ball according to example embodiments. The T-ball according to example embodiments can harvest energy under versatile circumstances, such as multiple and random directional vibration, spinning, rotation, rolling, finger tapping/touching, etc. It is highly adaptable and practicable to harvest energy from various types of ambient energy source. Besides, the symmetric structure enables the T-ball according to a non-limiting example embodiments for self-powered 3D acceleration sensing with x, y, and z direction sensitivity of 6.08, 5.87, and 3.62 V g⁻¹ without signal processing by IC circuit. Moreover, the T-ball according to a non-limiting example embodiment can work as a self-powered gyroscope for rotation sensing and hand motion recognition with the angular velocity sensitivity of 3.5 mV per degree per second, which shows great potential in smart control system, virtual reality, and game control applications. In addition, the T-ball according to example embodiments mounted on human hand exhibits good performance as a self-powered exercise sensor, which provides useful real-time information for the healthcare monitoring system. Looking forward, the T-ball according to example embodiments can be a key component paving the way to eventually realize a self-powered, more complete, and more accurate motion monitoring system.

In another aspect, to address and preferably overcome the drawbacks of previously developed water wave based TENGs, embodiments of the present invention can provide a highly symmetric 3D spherical shaped water based triboelectric nanogenerator (SWTENG). The SWTENG according to example embodiments comprises a double-layer water based TENG configuration, i.e., both its inner surface and outer surface are in contact with water, which is ideally suitable for water wave energy harvesting. Firstly, water inside as movable mass is an ideal approach for harvesting energy from the low frequency and random direction/amplitude water wave due to its fluidic nature. Even under very subtle perturbation, water mass is able to respond and move around with conformal contact on the inner surface for output generation. Secondly, the SWTENG using double-layer water based TENG configuration according to example embodiments can greatly enhance the energy conversion efficiency because both the inner and the outer surfaces are effectively utilized. Thirdly, the SWTENG according to example embodiments is more robust in harsh environment, e.g., in underwater and on water surface, and is still able to function well even when water leaks into the encapsulated structure since water is adopted as the triboelectric material.

Additionally, the SWTENG according to example embodiments can also be used for harvesting energy from 3D vibration, spinning, rotation and diverse human motions. Furthermore, the SWTENG as power source according to example embodiments can be integrated with other functional sensors to perform various sensing capabilities. Due to the high scalability, a SWTENG array according to example embodiments can be connected into a network structure on water surface, serving as power source for large-area environment monitoring (e.g. water temperature, water level, water pollution, etc.) and harvesting the huge water wave energy towards efficient water wave energy farm.

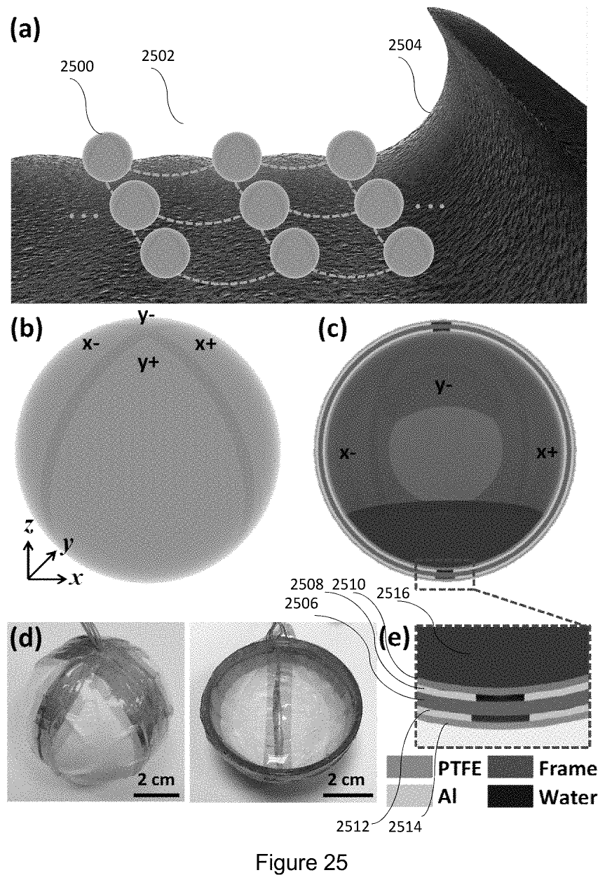

Symmetric Configuration Design According to Example Embodiments Symmetric structure provides a more advanced and effective way to harvest energy from versatile ambient sources including water wave motion, multiple directional vibration, rotating and rolling motion, etc. The device configuration of the symmetric 3D SWTENG 3100 according to an example embodiment is shown in FIG. 25. A conceptual drawing of multiple SWTENGs 2500 connected as network array 2502 according to example embodiments for large-scale water wave energy harvesting is shown in FIG. 25(a). When a random water wave 2504 comes along, the SWTENG array 2502 will either vibrate up and down or rotate with the water wave, resulting in power generation in large-area. The device configuration of the SWTENG 2500 with tilted view and cross-sectional view is illustrated in FIGS. 25(b) and (c), respectively. The SWTENG 2500 according to example embodiments is composed of a spherical shell frame 2506, inner-layer water based TENG with four A1 electrodes 2508 covered by Polytetrafluoroethylene (PTFE) thin film 2510, outer-layer water based TENG also with four A1 electrodes 2512 covered by PTFE thin film 2514, and de-ionized (DI) water 2516 encapsulated inside as movable mass. FIG. 25(e) is the enlarged view of the different layers.

FIG. 25(d) shows the photographs of the complete SWTENG 2500 and the half SWTENG 2500 with water mass, according to an example embodiments In order to differentiate different electrodes, a coordinate system as shown in FIG. 25(b) is considered as the intrinsic coordinate system of the SWTENG 2500. Hereinafter, the four inner electrodes are indicated as Eᵢₙ₋ₓ₊, E_{in-y+}, Eᵢₙ₋ₓ₊, E_{in-y-}. and the four outer electrodes are indicated as Eₒᵤₜ₋ₓ₊, E_{out-y+}, Eₒᵤₜ₋ₓ₋, E_{out-y-}, respectively. Eᵢₙ₋ₓ₊ and Eᵢₙ₋ₓ₋ are then connected as the positive input and negative input of Eᵢₙ₋ₓ while E_{in-y+} and E_{in-y-} are connected as the positive input and negative input of E_{in-y}.

For the four outer electrodes Eₒᵤₜ₋ₓ₊, E_{out-y+}, Eₒᵤₜ₋ₓ₋, E_{out-y-}, each of them works under single electrode mode to more effectively harvest the random water wave and other ambient mechanical energy. Fabrication of the SWTENG 2500 starts from two hemi-spherical frames with diameter of 6.5 cm in a non-limiting example embodiment which are fabricated by using 3D printing technique with the material of Vero Clear. Then separated and symmetric A1 foils are attached on both the inner surface and the outer surface of the two hemi-spherical frames as electrodes. PTFE thin film with thickness of 100 μm in a non-limiting example embodiment is then attached on top of the A1 electrodes as the friction layer with water. Kapton tape is adopted to improve the attachment robustness between PTFE thin film and the hemi-spherical frame, and also to prevent water leakage into the A1 electrodes. After that, DI water is poured inside one hemi-spherical structure for liquid-solid interface triboelectrification with the inner PTFE thin film. Lastly, the two hemi-spherical structures are attached and encapsulated together to form the complete SWTENG 2500.

Operation Principle According to Example Embodiments

The SWTENG according to example embodiments can be considered as the integration of double-layer water based TENG on the inner surface and outer surface. The operation principle of the inner-layer water based TENG for vibration and spinning/rotating is depicted in FIGS. 26A 26(a) and (b), in which only the water mass 2602, inner PTFE 2604 and inner electrodes e.g. 2606 of the SWTENG 2600 according to an example embodiment are shown for simplification. For vibration along x direction, side view of the operation principle is illustrated in FIG. 26A 26(a). Due to difference in electron affiliation ability between PTFE 2604 and water 2602, they become negatively charged and positively charged, respectively, after contacting with each other. After that, when the water mass 2602 is swung between the left electrode and the right electrode, the induced electrical potential difference drives electrons to flow between the two electrodes until a new balance is achieved. Thus cyclic output current is generated if the SWTENG 2600 according to the example embodiment is under cyclic vibration. When the SWTENG 2600 is vibrating exactly along x direction, only Eᵢₙ₋ₓ generates output current since there is no potential difference in y direction, and vice versa for y direction. If the SWTENG 2600 is vibrating at a certain angle with respect to x axis, output current is produced from both Eᵢₙ₋ₓ and E_{in-y}.

For spinning/rotating motion, top view of the operation principle is illustrated in FIG. 26 26(b). When the SWTENG 2600 according to example embodiments is under spinning/rotating motion, the water mass 2602 will move along the inner circumference of the SWTENG 2600, creating consecutive electrical potential difference on the four inner electrodes. Then electrons are driven to flow between the two ends of Eᵢₙ₋ₓ and E_{in-y} in response to the induced electrical potential difference by the water mass, resulting in current flow in the external circuit. For the spinning/rotating motion, both of Eᵢₙ₋ₓ and E_{in-y} produce output current.

The operation principle of the outer-layer water based TENG of the SWTENG 2600 according to an example embodiment under single electrode mode for harvesting human motion energy and water wave energy is depicted in FIG. 26A(c), 26B (d)-(f). Only the outer PTFE 2608 and outer electrodes e.g. 2610 of the SWTENG 2600 are shown in the schematic diagram for simplification. The operation principle for harvesting energy from human finger tapping is illustrated in FIG. 26A 26(c). The PTFE 2608 ends up with negative charges on surface and the human finger 2612 ends up with positive charges on surface after their first contact. Then when the human finger 2612 is moving closer to the outerlayer TENG, electrons are driven to flow from ground to the outer A1 electrode e.g. 2610 to balance the electrical potential difference.

When the human finger 2612 is moving away from the outer-layer TENG, electrons are driven to flow from the outer A1 electrode e.g. 2610 back to ground. Thus current flow between the outer A1 electrode e.g. 2610 and ground is generated in the external circuit in response to finger tapping.

In water wave energy harvesting, there are basically three types of motion that the SWTENG 2600 experiences on water surface—vibrating up and down, rotating back and forth, or rotating in one direction. The operation principle of outer-layer water based TENG of the SWTENG 2600 according to an example embodiments vibrating up and down on the (external) water 2614 surface is indicated in FIG. 26(d). After contacting, PTFE 2608 becomes negatively charged and the water 2614 surface becomes positively charged. Electrical potential difference is generated when the SWTENG 2600 vibrates up and down and the water 2614 surface level covers up to different percentages of the PTFE 2608 area. Electrons are driven to flow between the outer A1 electrode 2610 and ground, leading to current generation in the external circuit.

The operation principle of outer-layer water based TENG of the SWTENG 2600 according to an example embodiment rotating back and forth or rotating in one direction on the water surface is shown in FIGS. 26B 26(e) and (f), respectively. Although the water-cover surface level may maintain the same in these two scenarios, electrical potential difference is produced when the PTFE thin film 2608 is rotating across the water-air interface. Electrons driven by the electrical potential difference are forced to flow between the outer A1 electrode e.g. 2610 and ground, generating output current flow.

In practical situations on water surface for water wave energy harvesting, the actual motion of the SWTENG according to example embodiments is normally the combination of these three different motions described above. Due to the multiple operation principles under different circumstances, the SWTENG according to example embodiments has the ability to harvest diverse mechanical energy, human motion energy and random water wave energy from various aspects, enabling high efficiency and good performance under different usage scenarios.

Device Characterization and Optimization According to Example Embodiments

Prior to the selection of the dielectric layer for the double-layer water based SWTENG according to example embodiments, a comparison of output performance between Polydimethylsiloxane (PDMS), Kapton and PTFE against water was conducted. A simple device configuration with a metal electrode coated with dielectric layers on both sides is adopted for the comparison of different materials' performance [D37]. With this device configuration, large contact area can be achieved for different dielectric materials and thus the triboelectric performance can be clearly observed and compared. The A1 electrode with dimension of 2 cm×2 cm is sandwiched between the same dielectric layers (PDMS, Kapton or PTFE). The three fabricated devices are then periodically inserted into and pulled out of water for output generation. When the dielectric layer contacts with water, it attracts electrons from water and thus becomes negatively charged on surface while water becomes positively charged. Then when the device is periodically inserted into and pulled out of water, the alternating electrical potential difference drives electrons flow between the A1 electrode and ground.

The output voltage and current waveform for different dielectric layer were compared. The voltage measurement was achieved by connecting the output to a DSO-X3034A oscilloscope (Agilent) with a high impedance probe of 100 MΩ. The current measurement was achieved by connecting the output to a low noise SR570 current pre-amplifier (Stanford Research Systems).

From the output performance, it was seen that PTFE shows better energy harvesting capability than PDMS and Kapton against water. This can be attributed to its excellent triboelectric property and hydrophobic nature of PTFE thin film, which produces maximum electrical potential difference in water environment. A water droplet of 4 μL is dripped on the surface of Kapton, PDMS and PTFE. The corresponding contact angle is measured to be 97.9°, 111.8° and 111.5°, respectively. For water based SWTENGs according to example embodiments, triboelectric surface with good hydrophobicity is preferred since residual water on the triboelectric surface reduces the electrical potential difference and thus weakens the power generation capability. Therefore, PTFE thin film with excellent triboelectric property and hydrophobic nature is selected as the dielectric layer for the water based SWTENG according to example embodiments described herein, by way of example, not limitation.

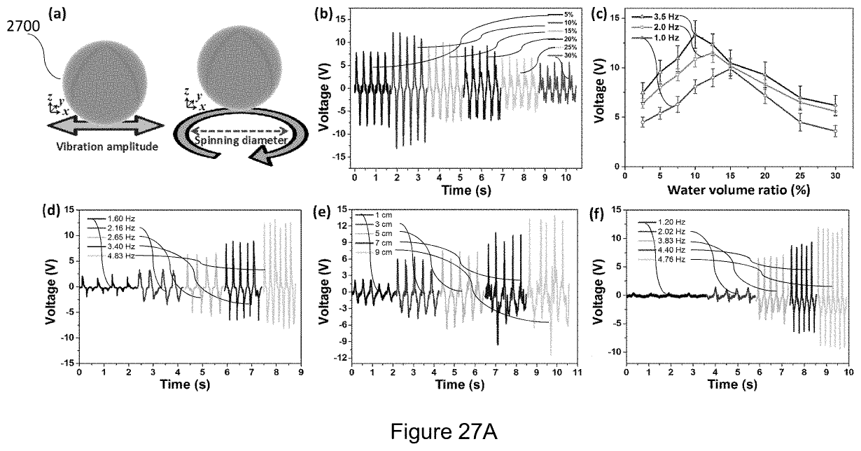

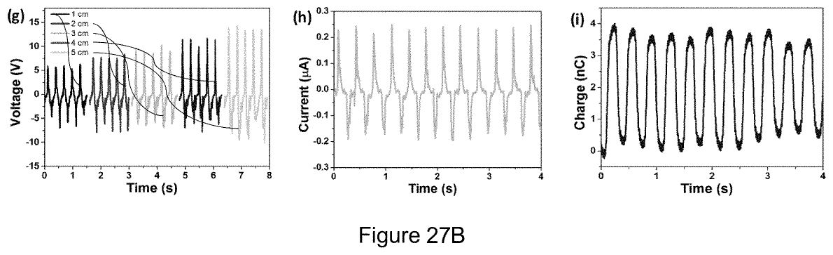

As discussed in the operation principle section for the inner-layer water based TENG of the SWTENG according to example embodiments, water mass can be activated by ambient mechanical excitation such as vibration and spinning motion. FIG. 27A(a) depicts the testing setup diagram for vibration along x axis (harmonic vibration) and spinning/rotating motion around a circle, where the output voltage from Eᵢₙ₋ₓ is measured. The amount of water inside the SWTENG 2700 is important for the output performance. Thus the SWTENG 2700 is first characterized and optimized in terms of the encapsulated water volume ratio. In order to determine the optimized water volume ratio according to an example embodiment, output voltage from Eᵢₙ₋ₓ is measured with varying water volume ratio, as shown in FIG. 27A (b). The applied vibration is along x direction with frequency of 3.5 Hz and amplitude of 5 cm. Other than 3.5 Hz vibration, 1 Hz and 2 Hz vibration measurements are also conducted to find out the corresponding optimized water volume ratio. As shown in FIG. 27A (c), it can be observed that when the vibration frequency decreases, the overall output performance also decreases due to the lower acceleration. Different frequency seems to have an optimized water volume ratio which decreases when the vibration frequency increases. This may be due to the fluidic nature of water. When higher frequency is applied, the water is spread out in a large-area and thus covers more surface area. When the frequency reduces, more amount of water is required to cover the same surface area. Here water volume ratio of 10% is adopted for the SWTENG 2700 according to an example embodiment.

Then output voltage performance with different vibration frequency is measured and plotted in FIG. 27A (d), from 1.6 to 4.8 Hz at 3 cm displacement. Output voltage performance with different vibration displacement amplitude is then measured and shown in FIG. 27A (e). The vibration amplitude increases from 1 cm to 9 cm while the vibration frequency is fixed at 2.5 Hz.

From these results, it can be observed that the output voltage increases with vibration frequency and amplitude due to the increment of contact area. Although output voltage from both Eᵢₙ₋ₓ and E_{in-y} is generated when the SWTENG 2700 according to an example embodiment is under spinning/rotating motion, only output from Eᵢₙ₋ₓ is measured and plotted to compare with the output from vibration motion. FIG. 27A (f) shows the output voltage performance with different spinning frequency when the spinning diameter is fixed at 3 cm according to a non-limiting example embodiment. FIG. 27B (g) shows the output voltage performance with different spinning diameter when the spinning frequency is maintained at 3.5 Hz. The results show that output voltage increases when the spinning frequency or diameter increases. This is due to the increment of contact area when higher spinning frequency or diameter is applied on the SWTENG 2700 according to an example embodiment. With higher spinning frequency or diameter, higher centripetal force is required for the water mass to maintain the circular motion, hence the water mass is swung higher and spread into large-area on the sidewall of the SWTENG 2700 due to its fluidic nature. The short-circuit current and the transferred charge under vibration motion of 3 Hz is shown in FIG. 27B (h) and (i), respectively. The transferred charge is measured by connecting the output of the SWTENG 2700 according to example embodiments to a model 6514 system electrometer (Keithley).

Versatile Mechanical Motion and Human Motion Energy Harvesting Capability According to Example Embodiments

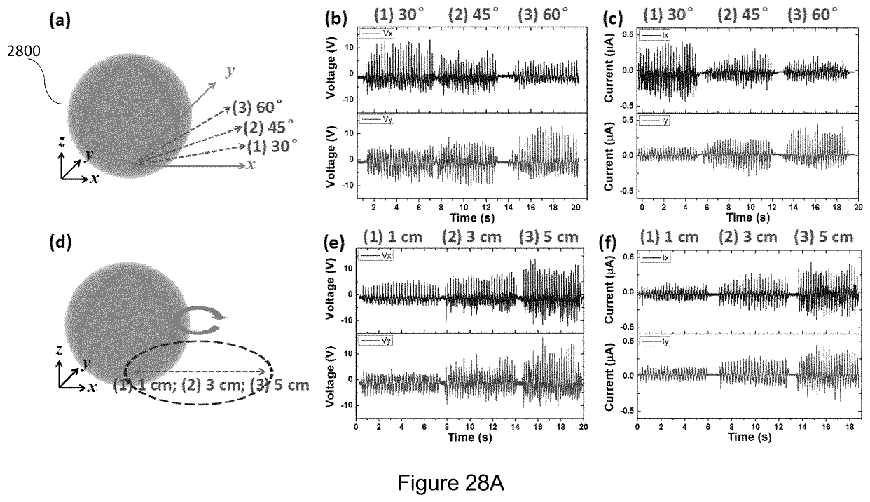

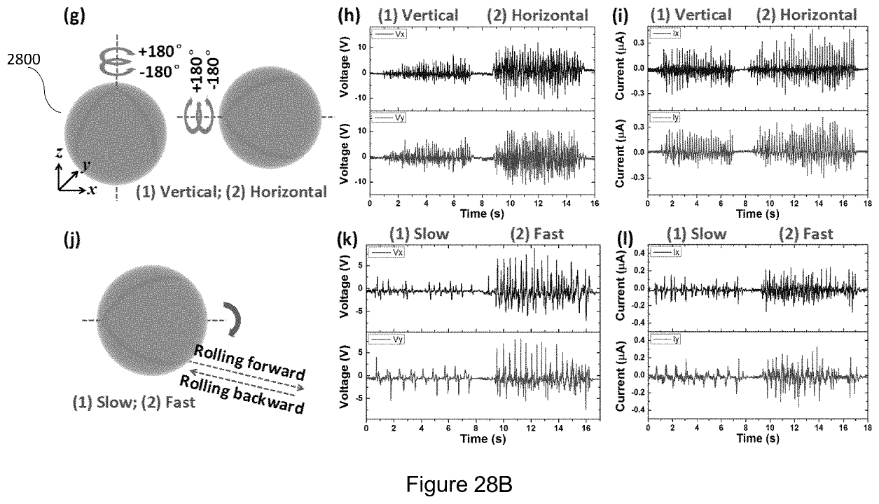

The symmetric structure enables the SWTENG according to example embodiments to harvest energy under versatile mechanical motion and human motion. FIGS. 28A and B demonstrate the energy harvesting capability of a SWTENG 2800 according to example embodiments under various mechanical motion excitations—vibration, spinning, rotation and rolling. The output voltage and current from both Eᵢₙ₋ₓ and E_{in-y} are measured and compared. As shown in FIG. 28A (a) to (c), the SWTENG 2800 according to example embodiments is under in-plane (x-y plane) vibration with vibration angle of 30°, 45° and 60° with respect to x axis. From the output voltage and current results, it can be seen that output from Eᵢₙ₋ₓ is higher when vibration angle is smaller than 45° and output from E_{in-y} is higher when it is vibration angle is larger than 45°. Similar output performance is generated in Eᵢₙ₋ₓ and E_{in-y} if the vibration angle is 45°. This can be attributed to different contact area in x and y direction when the vibration angle is different.

FIG. 28A (d) to (f) shows the SWTENG 2800 according to a non-limiting example embodiment under spinning/rotating motion with diameter of 1 cm, 3 cm and 5 cm. The output from both Eᵢₙ₋ₓ and E_{in-y} increases with larger spinning diameter since larger contact area is achieved.

Similar to spinning around a circle, the SWTENG 2800 according to the example embodiment is also able to harvest energy when it rotates along its z axis vertically and horizontally as shown in FIG. 28B (g) to (i). It can be seen that higher output is achieved when the SWTENG 2800 is rotating with its z axis placed horizontally, as the contact area of water mass with the inner electrode is large in the horizontal placement. Rolling is similar to rotating and the device performance with slow and fast rolling is shown in FIG. 28B (j) and (l). Higher output is generated in both Eᵢₙ₋ₓ and E_{in-y} when the SWTENG 2800 is rolling fast.

The above demonstration of the SWTENG according to example embodiments operating under different mechanical motion shows that it is highly adaptable to various usage scenarios and can harvest energy from diverse ambient energy sources due to its novel structure design. The maximum output voltage and output current attained from the inner-layer TENG of the SWTENG according to a non-limiting example embodiment is 13.5 V and 0.38 μA, respectively, under spinning motion with 5 cm diameter. Due to its diverse energy harvesting capability, the SWTENG according to example embodiments has the potential to function as a self-powered buoy ball on water surface for fishing or other sensing applications.

For example, when the SWTENG according to an example embodiment is connected to a hook and the hook is pulled by a fish, the water mass inside will vibrate along the pulling direction and output signals will be generated. With the x and y direction sensing capability discussed above, pulling force direction or fish position can be differentiated based on the output amplitude in x and y direction. When the SWTENG according to an example embodiment is spinning with frequency of 4 Hz and diameter of 5 cm, the maximum power of 3.04 μW can be achieved when the load resistance is 56.5 MD according to a non-limiting example embodiment.

Except for energy harvesting ability from various mechanical motions, the SWTENG according to example embodiments can also harvest energy from human motions such as finger tapping. When the SWTENG is cyclically tapped by human finger at frequency of 4 Hz, the output voltage and current achieved is 520 V and 25 μA, respectively, according to a non-limiting example embodiment. When different external load resistor is connected to the SWTENG according to example embodiments, the output voltage and power curve is measured and plotted. The maximum power achieved is 6.5 mW when the load resistance is 9.1 MΩ according to a non-limiting example embodiment. The produced output energy from finger tapping can be stored in capacitors after a rectification circuit as power source for other electronics. The output from the SWTENG according to example embodiments by finger tapping can directly light up LED array without using capacitor to store the energy.

Additionally, due to the encapsulated movable water mass, the SWTENG according to example embodiments can also be used as an inertial sensor for acceleration sensing and human activity monitoring. When the SWTENG is mounted on human hand, it can serve as a self-powered activity sensor for monitoring different human activities like slow walking, fast walking and running, similar to the embodiments described above using solid balls as internal mass.

Water Wave Energy Harvesting According to Example Embodiments

Water wave energy is a huge green energy source existing across the world in oceans, rivers, lakes, pools, etc. However, until now, majority of the water wave energy still remains unexplored and wasted. When trying to harvest the water wave energy, water pollution is one of the main concerns for the water wave energy harvesters. The SWTENG according to example embodiments is fabricated from pollution-free materials, i.e. water, A1, PTFE and Vero Clear, thereby providing a green approach to harvest the water wave energy. Furthermore, since water itself is adopted as one triboelectric material, the device according to example embodiments is more stable and robust when operating in the wet or water environment. The SWTENG according to example embodiments is still able to work even when water leakage happens.

Thus the SWTENG according to example embodiments is ideally suitable for harvesting the ambient water wave energy in a green, stable and efficient way. Multiple SWTENGs can be connected together into network structure to harvest the large-area water wave energy according to example embodiments, as depicted in FIG. 25 (a). The SWTENG array lying on water surface can also be integrated with other functional sensors to form large-area self-powered sensing system according to example embodiments. Each SWTENG node can serve as a power source for the integrated functional sensors to enable self-powered environment monitoring, such as water pollution, water temperature, water level, water flow, etc. according to example embodiments.

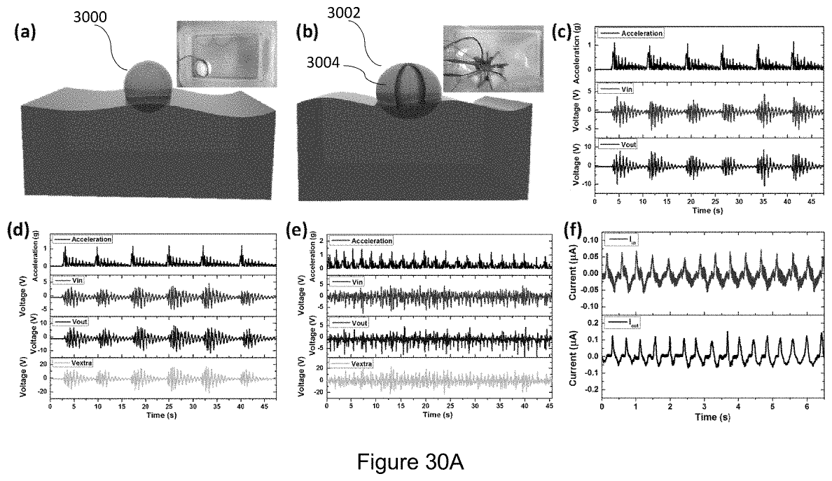

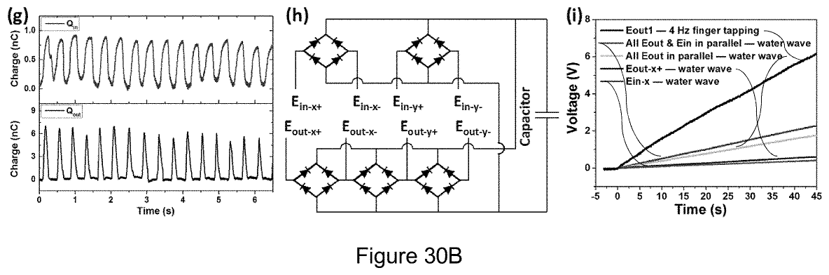

FIG. 30A (a) shows the schematic diagram of SWTENG 3000 according to an example embodiment floating on water surface as water wave energy harvester. FIG. 30A (b) shows an enhanced SWTENG 3002 by attaching four additional single electrode water based TENGs e.g. 3004 on the outer sidewall of the SWTENG 3000, according to example embodiments.

The four additional TENGs e.g. 3004 (Eₑₓₜᵣₐ₋ₓ₊) have the same boat shaped structure with A1 electrode covered by PTFE thin film on both sides to enhance the contact area and efficiency.

More additional TENGs can be further attached layer by layer on the SWTENG forming flower structure to further improve the output performance, according to different embodiments. As discussed in the operation principle section above, the SWTENG according to example embodiments will vibrate or rotate on water surface along with the water wave, resulting in power generation from the outer-layer water based TENG of the SWTENG according to example embodiments.

When the SWTENG 3000, 3002 vibrates or rotates with the water wave, the water mass inside the device will also vibrate or rotate on the inner surface, resulting in power generation from the inner-layer water based TENG of the SWTENG 3000, 3002, as described in details above.

The output voltage from the SWTENG 3000 and the enhanced SWTENG 3002 according to example embodiments activated by water wave in a water tank is shown in FIG. 20A (c)-(e). A commercial accelerometer ADXL325 (Analog Devices) is attached on the SWTENG 3000 and the enhanced SWTENG 3002 to measure the actual acceleration magnitude corresponding to the water wave. The output voltage from the electrode Eᵢₙ₋ₓ, Eₒᵤₜ₋ₓ₊ and Eₑₓₜᵣₐ₋ₓ₊ is measured and compared. The water wave resulting in the outputs in FIG. 30A (c) and (d) is produced by shaking the water tank at a low frequency of ˜0.15 Hz to mimic a normal ocean wave. The acceleration level and the vertical amplitude of the produced water wave are 1.1 g and 9 cm, respectively. The output voltage of the SWTENG 3000 is 3.1 V and 7.5 V from Eᵢₙ₋ₓ and Eₒᵤₜ₋ₓ₊, respectively. Under similar incoming water wave level, the enhanced SWTENG 3002 exhibits similar output voltage from Eᵢₙ₋ₓ and Eₒᵤₜ₋ₓ₊, but additional output voltage of 15.2 V is generated from Eₑₓₜᵣₐ₋ₓ₊. Higher voltage is generated from Eₑₓₜᵣₐ₋ₓ₊ is due to its larger contact area with water from both sides.

For the measurement in FIG. 30A (e), the water tank is shaken with a higher frequency of ˜0.47 Hz to generate the continuous water wave. When the enhanced SWTENG 3002 is activated by the continuous water wave, the corresponding voltage output is also generated in a continuous way. When a water wave excitation comes along, the SWTENG 3000, 3002 according to example embodiments will also vibrate with amplitude gradually decreasing. Thus corresponding signals are generated along with the incoming water waves.

The short-circuit current and the transferred charge from inner electrode and outer electrode under continuous water wave is also measured and shown in FIGS. 30A (f) and 30B (g) for the enhanced SWTENG 3002. Current of 0.07 μA and 0.12 μA and charge of 0.8 nC and 6 nC is observed for inner and outer electrode, respectively, in a non-limiting example embodiment.

The output energy from water wave activation can also be used for capacitor charging. A rectification circuit design for multiple single electrode mode TENGs is adopted [D45] in example embodiments, and the circuit connection 3004 of all the outputs for capacitor charging is shown in FIG. 30B (h). The charging curves on a 4.7 μF capacitor from different connection configurations are shown and compared with finger tapping result in FIG. 30B (i). The capacitor can be charged up to 2.2 V from parallel connection of the enhanced SWTENG 3002 according to a non-limiting example embodiment after 45 s.

Self-Powered Buoy Ball Towards Water Surface Sensor According to Example Embodiments

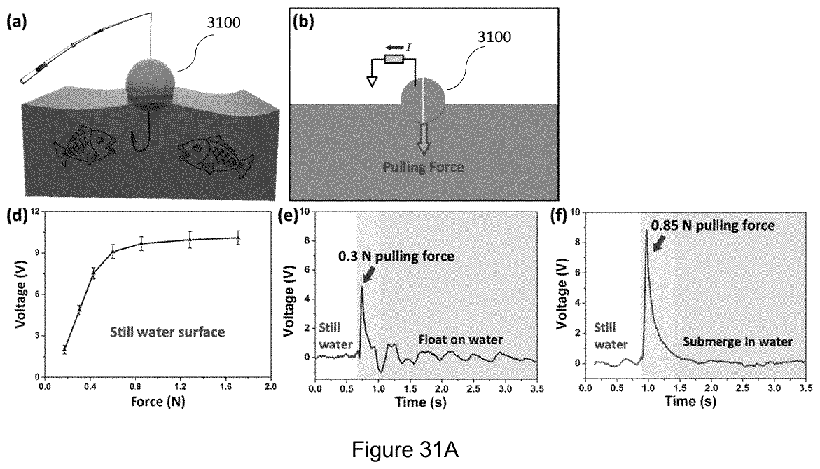

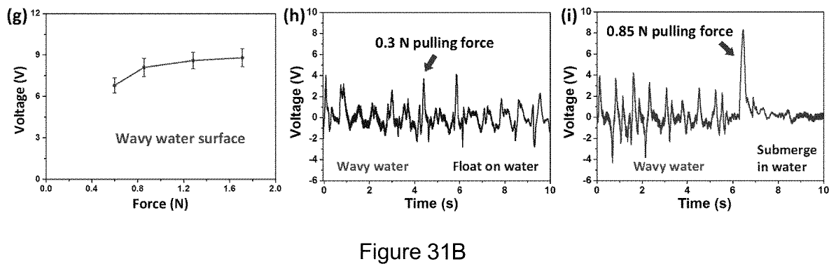

Various sensors are required to operate on water surface in order to collect information of the water pollution, water flow, water level, water temperature, etc. But the harsh and perishable environment makes it quite difficult for regular battery replacement and has high risk to cause battery deterioration and thereby water pollution. On the other hand, the SWTENG buoy ball according to example embodiments with diverse energy harvesting capability according to example embodiments provides a promising solution, which can function as self-powered sensor on water surface and is robust in the water environment. Moving forward, it can be further optimized and embedded with other sensing function for various sensing applications on the water surface. A self-powered fishing sensor using the SWTENG 3100 according to an example embodiment as a substitute of fishing buoy is illustrated in FIG. 31A (a). The purpose of conventional fishing buoy is to remind the fisherman that there is a fish baiting the hook when it starts to sink. However, sometimes it is not so obvious and one may miss the good chance to pull the fishing rod. The SWTENG 3100 as a self-powered fishing buoy according to example embodiments can generate an output signal when a fish is pulling the hook, since the water-air interface for the SWTENG 3100 is changed. If the SWTENG 3100 is connected with a processing circuit, an alarm signal (e.g. LED flashing) can be triggered. The measurement setup of the SWTENG 3100 according to an example embodiment floating on the water surface for pulling test is shown in FIG. 31A (b).

When there is a pulling force applied on the SWTENG 3100 such as fish baiting, it will start to sink into the water. Then an electrical signal is generated on the outer electrode due to the electrical potential difference induced by the water-air interface change. FIG. 31A (c) depicts the relationship of the output voltage from Eₒᵤₜ₋ₓ₊ and the applied pulling force under still water surface condition. It can be observed that when the SWTENG 3100 is placed on still water surface, the output voltage increases with the applied force. Even when the applied force is as small as 0.2 N, an output voltage peak can be observed.

After the applied pulling force exceeds 0.85 N, the output voltage gradually saturates with further increasing the pulling force. The increment of the output voltage is mainly because of the increment of the contact area, i.e. the immersion area of the PTFE thin film due to the applied pulling force. When the pulling force is smaller than 0.85 N, larger immersion area is achieved. But when the pulling force is larger than 0.85 N, the SWTENG 3100 according to an example embodiment is almost fully immersed under the water surface and thus the immersion area remains constant after that. The generated output voltage waveform with 0.3 N and 0.85 N applied force is shown in FIG. 31A (d) and (e), respectively. The left parts of both waveforms show that no signal is generated when the SWTENG 3100 is placed on still water surface. Then when force is applied, output peaks with different magnitude are observed. After that, for 0.3 N applied force, since the force is not high enough to pull the device under the water surface, thus the device still floats on the water surface and the agitated water induces small vibrating signals on the device, as seen after the peak indicated by the arrow in FIG. 31A (d).

On the other hand, when for 0.85 N applied force, a higher output voltage peak is generated, as indicated by the arrow in FIG. 31A (e). Then the device submerges under the water surface completely and no signal is observed after that. Although fishing on still water surface is common, sometimes fishing on wavy water surface (river or ocean) is also common. To characterize the influence of the wavy water surface, pulling force measurement on wavy water surface with continuous water wave is also conducted. FIG. 31A (f) depicts the relationship of the output voltage from Eₒᵤₜ₋ₓ₊ and the applied pulling force under wavy water surface. It can be seen that when the SWTENG 3100 is placed on wavy water surface, output voltage (˜4 V) is already generated even when no pulling force is applied due to the agitated water. Thus if the applied force is too small, the generated voltage peak will be too small to be differentiated from the background signal. When the applied force is larger than 0.6 N, the generated peak can be observed. Typical waveform of 0.3 N and 0.85 N applied force is shown in FIG. 31B (g) and (h), respectively. The left parts of both waveforms show a background signal without any applied forces. Then when force is applied, output peaks (indicated by the arrows in FIG. 31B (g) and (h)) with different magnitude are generated. For 0.3 N applied force in FIG. 31B (g), the generated signal is difficult to be differentiated from the background signal. After that, background signal is observed again since the device still floats on water surface. For 0.85 N applied force in FIG. 31B (h), the generated signal is higher than the background signal and can be clearly observed. And after that, no more background signal is observed since the device submerges under the water surface completely. Based on the magnitude of the output signal and the waveform pattern, the SWTENG 3100 according to an example embodiment is able to function as a fishing sensor to monitor the pulling force even under wavy water surface.

In the practical fishing sensor application, the output voltage can be connected to a signal processing circuit for output pattern differentiation according to example embodiments. Thereby the information of the fishing environment (still water or wavy water) and the pulling force (larger than a threshold) can be obtained. Then an alarm signal such as LED flashing can be triggered to remind the fisherman that there is a fish pulling the bait. Based on the magnitude of the pulling force, different level of signals can be activated such as one LED flashing, two LED flashing, etc.

As described above, a highly symmetric 3D spherical-shaped water based triboelectric nanogenerator (SWTENG) is provided according to example embodiments for harvesting energy from ambient water wave motions and various mechanical motions. The SWTENG with double-layer water based TENG configuration on both surfaces according to example embodiments is ideally suitable for harvesting the random directional and irregular water wave energy, due to the novel 3D symmetric structure design and robust water based operation principle. In addition, the SWTENG according to example embodiments shows excellent performance for harvesting energy from diverse ambient motions, e.g. 3D vibration, spinning, rotation, rolling and various human motion, etc. Furthermore, the SWTENG according to example embodiments can serve as a self-powered fishing sensor on still water surface or wavy water surface to generate a reminding signal when fish pulling the bait. Due to the high adaptability and scalability, the SWTENG according to example embodiments not only can function as single power source, but also can form SWTENG network on water surface for large-area water wave energy harvesting towards applications of environment monitoring and efficient water wave energy farm.

The possible industrial applications of various embodiments of the present invention described above also include multi-mode energy harvester, water wave energy harvester, self-powered water surface sensor (e.g. fishing sensor), self-powered multi-axis accelerometer, gyroscope, human motion monitor, gesture monitor, activity state sensor, exercise sensor in amusement, healthcare, virtual reality, smart control, game control applications.

In one embodiment, a self-powered triboelectric based device is provided comprising

a base member comprising a first material,
an actuator member comprising a second material having a work function that differs from the first material disposed on a first surface of the base member, and
a plurality of electrodes electrically coupled to the base member;
wherein the plurality of electrodes are disposed in a manner such that a direction of a shear force component applied to the actuator member can be analysed based on electrical outputs measured via respective ones of the electrodes.

The actuator member may be elastically deformable such that a normal force component applied to the actuator member can be analysed based on the electrical outputs measured via the respective ones of the electrodes.

The self-powered triboelectric based device may be configured for 2-dimensional or 3-dimensional sensing of control signals for providing a user control interface.

The self-powered triboelectric based device may further comprise a supporting structure for supporting the base member, the actuator member and the plurality of electrodes.

The actuator member may be sphere-shaped and the second material is comprised in a semi-spherical portion of the actuator member.

The first surface of the base member may have a semi-spherical contour for receiving the semi-spherical portion of the actuator member. The second surface of the base member may have a semi-spherical contour, and the plurality of electrodes are arranged in a semi-spherical contour for receiving the second surface of the base member.

The self-powered triboelectric based device may comprise four electrodes.

Two of the self-powered triboelectric based devices may be coupled together to form an integral device.

The actuator member may be sphere-shaped and the second material is comprised in contact points on a surface of the sphere-shaped actuator member. The base member may be integrally formed with the electrodes such that the electrodes comprise the first material. The electrodes may comprise two sets of four electrodes each, each set being disposed circumferentially around four of the contact points at different and wherein the two sets and their respective associated contact points are disposed at different latitudes of the sphere-shaped actuator member.

In one embodiment, a self-powered triboelectric based device is provided comprising

a hollow base member comprising a first material,
one or more actuator members comprising a second material having a work function that differs from the first material disposed inside the hollow base member in a cavity defined by an internal surface of the base member, and
a plurality of electrodes disposed below the internal surface of the base member;
wherein the plurality of inner electrodes are disposed in a manner such that movement of the one or more actuator members can be analysed based on electrical outputs measured via respective ones of the inner electrodes.

The one or more actuator members may comprise one or more balls.

The actuator member may comprise the second material in liquid form.

The self-powered triboelectric based device may be configured for 3-dimensional sensing of control signals for providing a user control interface and/or a gyroscope.

The self-powered triboelectric based device may be configured for harvesting signals for conversion into energy.

The base member may further comprise a plurality of outer electrodes covered by a layer made from a third material, such that further triboelectric signals can be measured via the outer electrodes responsive to an external material having a work function that differs from the third material co-operating with the third material.

The base member may further comprise a plurality of additional electrodes covered by a layer made from a fourth material, such that additional triboelectric signals can be measured via the additional electrodes responsive to an external material having a work function that differs from the fourth material co-operating with the fourth material. The additional electrodes may be covered by the fourth material on two opposing surfaces for cooperating with the external material.

In one embodiment a user interface comprising the device of the above embodiments is provided.

In one embodiment a method of providing user input using the device of the above embodiments is provided.

In one embodiment an energy harvesting device comprising the device of the above embodiments is provided.

In one embodiment, a method of harvesting energy using the device of the above embodiments is provided.

In one embodiment a submersion-detecting device comprising the device of the above embodiments is provided.

In one embodiment a method of submersion-detecting using the device of the above embodiments is provided.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types.

Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize.

The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims.

Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

### REFERENCES

[1] F.-R. Fan, L. Lin, G. Zhu, W. Wu, R. Zhang, Z. L. Wang, Nano letters 2012, 12, 3109.
[2] L. Lin, Y. Xie, S. Wang, W. Wu, S. Niu, X. Wen, Z. L. Wang, ACS nano 2013, 7, 8266.
[3] Y. S. Zhou, G. Zhu, S. Niu, Y. Liu, P. Bai, Q. Jing, Z. L. Wang, Advanced Materials 2014, 26, 1719.
[4] Q. Jing, G. Zhu, W. Wu, P. Bai, Y. Xie, R. P. Han, Z. L. Wang, Nano Energy 2014, 10, 305.
[5] Y. Su, G. Zhu, W. Yang, J. Yang, J. Chen, Q. Jing, Z. Wu, Y. Jiang, Z. L. Wang, ACS nano 2014, 8, 3843.
[6] G. Zhu, W. Q. Yang, T. Zhang, Q. Jing, J. Chen, Y. S. Zhou, P. Bai, Z. L. Wang, Nano letters 2014, 14, 3208.
[7] F. Yi, L. Lin, S. Niu, J. Yang, W. Wu, S. Wang, Q. Liao, Y. Zhang, Z. L. Wang, Advanced Functional Materials 2014, 24, 7488.
[8] L. Lin, S. Wang, S. Niu, C. Liu, Y. Xie, Z. L. Wang, ACS applied materials & interfaces 2014, 6, 3031.
[9] Y. Yang, Y. S. Zhou, H. Zhang, Y. Liu, S. Lee, Z. L. Wang, Advanced Materials 2013, 25, 6594.
[10] K. Parida, V. Bhavanasi, V. Kumar, R. Bendi, P. S. Lee, Nano Research 2017, 10, 3557.
[11] Q. Shi, H. Wang, T. Wang, C. Lee, Nano Energy 2016, 30, 450.
[12] B. Meng, W. Tang, Z.-h. Too, X. Zhang, M. Han, W. Liu, H. Zhang, Energy & Environmental Science 2013, 6, 3235.
[13] A. Chandrasekhar, N. R. Alluri, V. Vivekananthan, J. H. Park, S.-J. Kim, ACS Sustainable Chemistry & Engineering 2017, 5, 7310.
[14] X. He, Y. Zi, H. Yu, S. L. Zhang, J. Wang, W. Ding, H. Zou, W. Zhang, C. Lu, Z. L.

Wang, Nano Energy 2017, 39, 328.
[15] K. Parida, V. Bhavanasi, V. Kumar, R. Bendi, P. S. Lee, Nano Research 2017, 10, 3557.
[16] Z. Wang, R. Jiang, G. Li, Y. Chen, Z. Tang, Y. Wang, Z. Liu, H. Jiang, C. Zhi, ACS Applied Materials & Interfaces 2017, 9, 22685.
[17] X. Zhang, Y. Zheng, D. Wang, F. Zhou, Nano Energy 2017, 40, 95.
[18] R. D. I. G. Dharmasena, K. Jayawardena, C. Mills, J. Deane, J. Anguita, R. Dorey, S.

Silva, Energy & Environmental Science 2017, 10, 1801.
[19] Z. L. Wang, Materials Today 2017.
[20] Z. L. Wang, J. Chen, L. Lin, Energy & Environmental Science 2015, 8, 2250.
[A1] N. Zhang, C. Tao, X. Fan, J. Chen, J. Mater. Res. 2017, 32, 1628.
[A2] Z. L. Wang, J. Chen, L. Lin, Energy Environ. Sci. 2015, 8, 2250.
[A3] D. Evans, CISCO white paper, 2011, 1, 1.
[A4] F.-R. Fan, L. Lin, G. Zhu, W. Wu, R. Zhang, Z. L. Wang, Nano Lett. 2012, 12, 3109.
[A5] L. Lin, Y. Xie, S. Wang, W. Wu, S. Niu, X. Wen, Z. L. Wang, ACS Nano 2013, 7, 8266.
[A6] Y. S. Zhou, G. Zhu, S. Niu, Y. Liu, P. Bai, Q. Jing, Z. L. Wang, Adv. Mater. 2014, 26, 1719.
[A7] Q. Jing, G. Zhu, W. Wu, P. Bai, Y. Xie, R. P. Han, Z. L. Wang, Nano Energy 2014, 10, 305.
[A8] Y. Su, G. Zhu, W. Yang, J. Yang, J. Chen, Q. Jing, Z. Wu, Y. Jiang, Z. L. Wang, ACS Nano 2014, 8, 3843.
[A9] G. Zhu, W. Q. Yang, T. Zhang, Q. Jing, J. Chen, Y. S. Zhou, P. Bai, Z. L. Wang, Nano Lett. 2014, 14, 3208.
[A10] Q. Shi, H. Wu, H. Wang, H. Wu, C. Lee, Adv. Energy Mater. 2017, 7, 1701300.
[A11] Q. Shi, H. Wang, H. Wu, C. Lee, Nano Energy 2017, 40, 203.
[A12] Y. Yang, Y. S. Zhou, H. Zhang, Y. Liu, S. Lee, Z. L. Wang, Adv. Mater. 2013, 25, 6594.
[A13] K. Parida, V. Bhavanasi, V. Kumar, R. Bendi, P. S. Lee, Nano Res. 2017, 10, 3557.
[A14] Q. Shi, H. Wang, T. Wang, C. Lee, Nano Energy 2016, 30, 450.
[A15] B. Meng, W. Tang, Z.-h. Too, X. Zhang, M. Han, W. Liu, H. Zhang, Energy Environ.

Sci. 2013, 6, 3235.
[A16] A. Chandrasekhar, N. R. Alluri, V. Vivekananthan, J. H. Park, S.-J. Kim, ACS Sustainable Chem. Eng. 2017, 5, 7310.
[A17] X. He, Y. Zi, H. Yu, S. L. Zhang, J. Wang, W. Ding, H. Zou, W. Zhang, C. Lu, Z. L.

Wang, Nano Energy 2017, 39, 328.
[A18] Z. Wang, R. Jiang, G. Li, Y. Chen, Z. Tang, Y. Wang, Z. Liu, H. Jiang, C. Zhi, ACS Appl. Mater. Interfaces 2017, 9, 22685.
[A19] X. Zhang, Y. Zheng, D. Wang, F. Zhou, Nano Energy 2017, 40, 95.
[A20] Z. L. Wang, Faraday Discuss. 2015, 176, 447.
[A21] G. Zhu, C. Pan, W. Guo, C.-Y. Chen, Y. Zhou, R. Yu, Z. L. Wang, Nano Lett. 2012, 12, 4960.
[A22] S. Wang, L. Lin, Z. L. Wang, Nano Lett. 2012, 12, 6339.
[A23] R. D. I. G. Dharmasena, K. Jayawardena, C. Mills, J. Deane, J. Anguita, R. Dorey, S.

Silva, Energy Environ. Sci. 2017, 10, 1801.
[A24] Z. L. Wang, Mater. Today 2017, 20, 74.
[A25] A. Fassler, C. Majidi, Adv. Mater. 2015, 27, 1928.
[A26] A. Wählin, G. Backström, J. Appl. Phys. 1974, 45, 2058.
[A27] D. Davies, J. Phys. D: Appl. Phys. 1969, 2, 1533.
[A28] J. Wang, C. Wu, Y. Dai, Z. Zhao, A. Wang, T. Zhang, Z. L. Wang, Nat. Commun. 2017, 8, 88.
[A29] L. B. Schein, Electrophotography and Development Physics, Vol. 14, Springer Science & Business Media, Berlin 2013.
[A30] M. A. Eddings, M. A. Johnson, B. K. Gale, J. Micromech. Microeng. 2008, 18, 067001.
[B1] K. Lee, Insight A Journal of Scholarly Teaching 7 (2017) 31-42.
[B2] T. Guan, L. Duan, Y. Chen, J. Yu, Sensors 10 (2010) 6017-6043.
[B3] L. Yu, S. K. Ong, A. Y. C. Nee, Multimedia Tools & Application 75 (2016) 1-22.
[B4] W. Fang, L. Zheng, H. Deng, H. Zhang, Sensors 17 (2017) 1-22.
[B5] W. Fang, L. Zheng, X. Wu, Computers in Industry (2017) 91-103.
[B6] D. P. Kaur, A. Mantri, IEEE Intern. Conf. on Moocs. (2016) 176-181.
[B7] P. Fuchs, G. Moreau, P. Guitton. CRC Press. 2011.
[B8] X. Y. Dong, Advanced Materials Research 791-793 (2013) 1208-1213.
[B9] S. Yoshida, T. Mizota, H. Noma, IEEE Virtual Conference (2007) 281-282.
[B10] H. J. Kwon, J. H. Kim, W. C. Choi, Microsyst. Technol. 17 (2011) 1721-1726.
[B11] H. Chen, L. Miao, Z. Su. Y. Song, M. Han, X. Chen, X. Cheng, D. Chen, H. X. Zhang, Nano Energy 40 (2017) 65-72.
[B12]X. Chen, Y. Song, H. Chen, J. Zhang, H. X. Zhang, Journal of Materials Chemistry A.5 (2017) 12361-12368.
[B13]J. Zou, M. Zhang, J. Huang, J. Bian, Y, Jie, M. Willander, X. Cao, N. Wang, Z. L. Wang, Advanced Energy Materials (2018).
[B14] Y. Huang, H. Yuan, W. Q. Kan, X. H. Guo, C. X. Liu, P. Liu, Microsyst. Technol. 23 (2017) 1847-1852.
[B15] F. R. Fan, Z. Q. Tian, Z. L. Wang, Nano Energy 1 (2012) 328-334.
[B16]Z. Su, M. Han, X. Cheng, H. Chen, X. Chen, H. X. Zhang, Advanced Functional Materials 26 (2016) 5524-5533.
[B17]Y. Ma, Q. Zhang, Y. Liu, B. Shi, X. Xue, W. Ji, Z. Liu, Y. Jin, Y. Zou, Z. An, W. Zhang, X. Wang, W. Jiang, Z. Xu, Z. L. Wang, H. Zhang, Nano Letter 16 (2016) 6042-6051.
[B18]G. Gu, C. Han, J. Tian, C. Lu, C. He, T. Jiang, Z. Li, Z. L. Wang, ACS Applied Materials & Interfaces 9 (2017) 11882-11888.
[B19] X. Liu, K. Zhao, Z. L. Wang, Y. Yang, Advanced Energy Materials 7 (2017) 1701629.
[B20] X. Pu, H. Guo, J. Chen, X. Wang, Y. Xi, C. Hu, Z. L. Wang, Science Advances 3 (2017) e1700694.
[B21] G. Liu, J. Chen, Q. Tang, L. Feng, H. Yang, J. Li, Y. Xi, X. Wang, C. Hu, Advanced Energy Materials (2018) 1703086.
[B22] J. Chen, X. J. Pu, H. Y. Guo, Q. Tang, L. Feng, X. Wang, C. G. Hu, Nano Energy 43 (2018) 253-258.
[B23] L. B. Schein, Science 316 (2006) 1572-1573.
[B24] T. A. L. Burgo, T. R. D. Ducati, K. R. Francisco, K. J. Clinckspoor, F. Galembeck and S. E. Galembeck, Langmuir 28 (2012) 7407-7416.
[B25]Q. Zheng, H. Zhang, B. Shi, X. Xue, Z. Liu, Y. Jin, Y. Ma, Y. Zou, X. Wang, Z. An, W. Tang, W. Zhang, F. Yang, Y. Liu, X. Lang, Z. Xu, Z. Li, Z. L. Wang, ACS Nano 10 (2016) 6510-6518.
[B26]T. Li, H. Luo, L. Qin, X. Wang, Z. Xiong, H. Ding, Y. Gu, Z. Liu, T. Zhang, Small 12 (2016) 5042-5048.
[B27]H. Guo, T. Li, X. Cao, J, Xiong, Y. Jie, M. Willander, X. Cao, N. Wang, Z. L. Wang, ACS Nano 11 (2017) 856-864.
[B28] S. Qi, H. Guo, J. Chen, J. Fu, C. G. Hu, M. Yu, Z. L Wang, Nanoscale 10 (2018) 4745-4752.
[B29] N. Zhang, C. Tao, X. Fan, J. Chen, Journal of Materials Research 32 (2017) 1628.
[B30] R. K. Gupta, Q. Shi, L. Dhakar, T. Wang, C. H. Heng, C. Lee, Scientific Reports 7 (2017) 41396.
[B31] L. Dhakar, S. Gudla, X. Shan, Z. Wang, F. E. H. Tay, C. H. Heng, C. Lee, Scientific Reports 6 (2016) 22253.
[B32]H. Li, L. Su, S. Kuang, Y. Fan, Y. Wu, Z. L. Wang, G. Zhu, Nano Research 10 (2017) 785-793.
[B33]T. Li, J. Zou, F. Xing, M. Zhang, X. Cao, N. Wang, Z. L. Wang, ACS Nano 11 (2017) 3950-3956.
[B34] Z. L. Wang, J. Chen, L. Lin, Energy & Environmental Science 8 (2015) 2250.
[B35] S. Cheon, H. Kang, H. Kim, Y. Son, J. Y. Lee, H. J. Shin, S. W. Kim, J. H. Cho, Advanced Functional Materials 28 (2017) 1703778.
[B36] H. J. Choi, J. H. Lee, J. Jun, T. Y. Kim, S. W. Kim, H. Lee, Nano Energy 27 (2016) 595-601.
[B37] R. Hinchet, A. Ghaffarinejad, Y. Lu, J. Y. Hasani, S. W. Kim, P. Basset, Nano Energy 47 (2018) 401-409.
[B38] H. Wang, H. Wu, D. Hasan, T. He, Q. Shi, C. Lee, Acs Nano 11 (2017) 10337-10346.
[B39] Q. Shi, H. Wu, H. Wang, H. Wu, C. Lee, Adv. Energy Mater. 7 (2017) 1701300.
[B40] T. Chen, Y. Xia, W. Liu, H. Liu, L. Sun, C. Lee, J. of MEMS 12 (2016) 845-847.
[B41] H. Liu, T. Chen, L. Sun, C. Lee, Micromachines 6 (2015) 984-992.
[B42]F. Wang, Z. Liu, P. Zhang, H. Li, W. Sheng, T. Zhang, R. Jordan, Y. Wu, X. Zhang, X.

Feng, Small 13 (2017) 1702449.
[B43] J. W. Zhong, Q. Zhang, F. R. Fan, Y. Zhang, S. H. Wang, B. Hu, Z. L. Wang and J. Zhou, Nano Energy 2 (2012) 491-497.
[B44] Y. Yang, H. Zhang, X. Zhong, F. Yi, R. Yu, Y. Zhang, Z. L. Wang, ACS Applied Materials & Interfaces 6 (2014) 3680-3688.
[B45] U. Khan, T. H. Kim, H. Ryu, W. Seung, S. W. Kim, Advanced Materials 29 (2017) 1603544.
[B46] Q. Jing, G. Zhu, W. Wu, P. Bai, Y. Xie, R. P. Han, Z. L. Wang, Nano Energy 10 (2014) 305.
[B47] Y. Yang, H. Zhang, Z. H. Lin, Y. S. Zhou, Q. Jing, Y. Su, J. Yang, J. Chen, C. Hu, Z. L. Wang, ACS Nano 7 (2013) 9213-9222.
[B48] G. H. Lim, S. S. Kwak, N. Kwon, T. Kim, H. Kim, S. M. Kim, S. W. Kim, B. Lim, Nano energy 42 (2017) 300-306.
[B49]Y. Cao, T. Li, Y. Gu, H. Luo, S. Wang, T. Zhang, Small (2018).
[B50]L. Su, H. Y. Li, Y. Wang, S. Kuang, Z. L. Wang, G. Zhu, Nano Energy 31 (2017) 264-269.
[B51] Y. Yang, Y. S. Zhou, H. Zhang, Y. Liu, S. Lee, Z. L. Wang, Advanced Materials 25 (2013) 6594.
[B52] G. Zhu, W. Q. Yang, T. Zhang, Q. Jing, J. Chen, Y. S. Zhou, P. Bai, Z. L. Wang, Nano Letters 14 (2014) 3208.
[B53] F. Yi, L. Lin, S. Niu, J. Yang, W. Wu, S. Wang, Q. Liao, Y. Zhang, Z. L. Wang, Advanced Functional Materials 24 (2014) 7488.
[B54] Q. Shi, H. Wang, T. Wang, C. Lee, Nano Energy 30 (2016) 450.
[B55] B. Meng, W. Tang, Z.-h. Too, X. Zhang, M. Han, W. Liu, H. Zhang, Energy & Environmental Science 6 (2013) 3235.
[B56] X. He, Y. Zi, H. Yu, S. L. Zhang, J. Wang, W. Ding, H. Zou, W. Zhang, C. Lu, Z. L.

Wang, Nano Energy 39 (2017) 328.
[B57] Z. Wang, R. Jiang, G. Li, Y. Chen, Z. Tang, Y. Wang, Z. Liu, H. Jiang, C. Zhi, ACS Applied Materials & Interfaces 9 (2017) 22685.
[B58] X. Zhang, Y. Zheng, D. Wang, F. Zhou, Nano Energy 40 (2017) 95.
[B59] Z. L. Wang, Faraday Discuss. 176 (2014) 447.
[B60] D. Davies, Journal of Physics D: Applied Physics 2 (1969) 1533.
[B61] A. Wählin, G. Backström, Journal of Applied Physics 45 (1974) 2058.
[B62] D. Armani, C. Liu, N. Aluru, presented at Micro Electro Mechanical Systems, 1999. MEMS '99. Twelfth IEEE International Conference on 1999.
[B63] P. Rae, E. Brown, Polymer 46 (2005) 8128.
[B64] W. M. Haynes, CRC handbook of chemistry and physics, CRC press, 2014.
[B65] S. Trigwell, J. Captain, J. Captain, E. Arens, J. Quinn, C. Calle, Trigwell Steve 2006.
[B66] J. G. Speight, Lange's handbook of chemistry, McGraw-Hill New York 2005.
[B67] P. A. Tipler, R. Llewellyn, Modern physics, Macmillan 2003.
[B68] S. Wang, D. B. Lian, Y. Chen, Computer Systems & Application 25 (2016) 72-76.
[B69] K. Jiang, F. Y. Zheng, H. K. Tang, Applied Mechanics & Materials 602-605 (2014) 1838-1841.
[C1] M.-H. Tsai, Y.-C. Liu, W. Fang, J. Microelectromech. Syst. 2012, 21, 1329.
[C2] R. Xu, S. Zhou, W. J. Li, IEEE Sens. J. 2012, 12, 1166.
[C3] F. Ayazi, K. Najafi, J. Microelectromech. Syst. 2001, 10, 169.
[C4] K. Liu, W. Zhang, W. Chen, K. Li, F. Dai, F. Cui, X. Wu, G. Ma, Q. Xiao, J. Micromech. Microeng. 2009, 19, 113001.
[C5] H. Xie, G. K. Fedder, J. Aerospace Eng. 2003, 16, 65.
[C6] STMicroelectronics, MEMS and Sensors: iNEMO-Inertial Modules, http://www.st.com/content/st_com/en/products/mems-and-sensors/inemo-inertial-modules.html?querycriteria=productId=SC1448, accessed: May, 2017.
[C7] R. Schulze, T. Gessner, M. Heinrich, M. Schueller, R. Forke, D. Billep, M. Sborikas, M. Wegener, presented at 2012 Int. Symp. Appl. Ferroelectr. held jointly with 2012 Eur. Conf. Appl. Polar Dielectrics and 2012 Int. Symp. Piezoresponse Force Microsc. Nanoscale Phenom. Polar Mater., Aveiro, Portugal, 9-13 July (July, 2012).
[C8] R. K. Gupta, Q. Shi, L. Dhakar, T. Wang, C. H. Heng, C. Lee, Sci. Rep. 2017, 7.
[C9] H. Zhang, Y. Yang, Y. Su, J. Chen, K. Adams, S. Lee, C. Hu, Z. L. Wang, Adv. Funct. Mater. 2014, 24, 1401.
[C10] X. Wang, S. Niu, Y. Yin, F. Yi, Z. You, Z. L. Wang, Adv. Energy Mater. 2015, S.
[C11] Y. K. Pang, X. H. Li, M. X. Chen, C. B. Han, C. Zhang, Z. L. Wang, ACS Appl. Mater. Inter. 2015, 7, 19076.
[D1] J. Glaser, Clean Technol. Environ. 9 (2007) 249-252.
[D2] K. S. Brown, Science 285 (1999) 678-680.
[D3] D. Clery, Science 320 (2008) (1574-1574).
[D4] J. Cruz, Ocean Wave Energy: Current Status and Future Perspectives, Springer Science & Business Media, 2007.
[D5] L. Drouen, J. Charpentier, E. Semail, S. Clenet, in: Proceedings of the 2007 IEEE OCEANS, 2007, pp. 1-6.
[D6] A. Von Jouanne, Mech. Eng.-CIME 128 (2006) 24-28.
[D7] A. Wolfbrandt, IEEE Trans. Magn. 42 (2006) 1812-1819.
[D8] F.-R. Fan, Z.-Q. Tian, Z. L. Wang, Nano Energy 1 (2012) 328-334.
[D9] Z. L. Wang, J. Chen, L. Lin, Energy Environ. Sci. 8 (2015) 2250-2282.
[D10] S. Wang, L. Lin, Z. L. Wang, Nano Energy 11 (2015) 436-462.
[D11] M. Shi, H. Wu, J. Zhang, M. Han, B. Meng, H. Zhang, Nano Energy 32 (2017) 479-487.
[D12] Q. Zheng, B. Shi, F. Fan, X. Wang, L. Yan, W. Yuan, S. Wang, H. Liu, Z. Li, Z. L. Wang, Adv. Mater. 26 (2014) 5851-5856.
[D13] R. K. Gupta, Q. Shi, L. Dhakar, T. Wang, C. H. Heng, C. Lee, Sci. Rep. 7 (2017) 41396.
[D14] H.-J. Choi, J. H. Lee, J. Jun, T. Y. Kim, S.-W. Kim, H. Lee, Nano Energy 27 (2016) 595-601.
[D15] J. Tian, H. Feng, L. Yan, M. Yu, H. Ouyang, H. Li, W. Jiang, Y. Jin, G. Zhu, Z. Li, Z. L. Wang, Nano Energy 36 (2017) 241-249.
[D16] X. Wang, Y. Yang, Nano Energy 32 (2017) 36-41.
[D17] T. Li, J. Zou, F. Xing, M. Zhang, X. Cao, N. Wang, Z. L. Wang, ACS Nano 11 (2017) 3950-3956.
[D18] D. Bhatia, W. Kim, S. Lee, S. W. Kim, D. Choi, Nano Energy 33 (2017) 515-521.
[D19] Q. Zheng, B. Shi, Z. Li, Z. L. Wang, Adv. Sci. 4 (2017) 1700029.
[D20] S. Lee, H. Wang, Q. Shi, L. Dhakar, J. Wang, N. V. Thakor, S.-C. Yen, C. Lee, Nano Energy 33 (2017) 1-11.
[D21] Z. L. Wang, Faraday Discuss. 176 (2015) 447-458.
[D22] Z. L. Wang, Nature 542 (2017) 159-160.
[D23] Z. L. Wang, Mater. Today 20 (2017) 74-82.
[D24] Z. L. Wang, T. Jiang, L. Xu, Nano Energy 39 (2017) 9-23.
[D25] J. Chen, J. Yang, Z. Li, X. Fan, Y. Zi, Q. Jing, H. Guo, Z. Wen, K. C. Pradel, S. Niu, ACS Nano 9 (2015) 3324-3331.
[D26] T. Jiang, L. M. Zhang, X. Chen, C. B. Han, W. Tang, C. Zhang, L. Xu, Z. L. Wang, ACS Nano 9 (2015) 12562-12572.
[D27] L. M. Zhang, C. B. Han, T. Jiang, T. Zhou, X. H. Li, C. Zhang, Z. L. Wang, Nano Energy 22 (2016) 87-94.
[D28] X. Wang, S. Niu, Y. Yin, F. Yi, Z. You, Z. L. Wang, Adv. Energy Mater. 5 (2015) 1501467.
[D29] A. Ahmed, Z. Saadatnia, I. Hassan, Y. Zi, Y. Xi, X. He, J. Zu, Z. L. Wang, Adv. Energy Mater. 7 (2017) 1601705.
[D30] Y. Zi, H. Guo, Z. Wen, M.-H. Yeh, C. Hu, Z. L. Wang, ACS Nano 10 (2016) 4797-4805.
[D31] X. Wang, Z. Wen, H. Guo, C. Wu, X. He, L. Lin, X. Cao, Z. L. Wang, ACS Nano 10 (2016) 11369-11376.
[D32] Z. H. Lin, G. Cheng, L. Lin, S. Lee, Z. L. Wang, Angew. Chem. Int. Ed. 52 (2013) 12545-12549.
[D33] S.-B. Jeon, D. Kim, M.-L. Seol, S.-J. Park, Y.-K. Choi, Nano Energy 17 (2015) 82-90.
[D34] S.-B. Jeon, M.-L. Seol, D. Kim, S.-J. Park, Y.-K. Choi, Adv. Electron. Mater. 2 (2016) 1600006.
[D35] Z. H. Lin, G. Cheng, S. Lee, K. C. Pradel, Z. L. Wang, Adv. Mater. 26 (2014) 4690-4696.
[D36] L. Zheng, Z.-H. Lin, G. Cheng, W. Wu, X. Wen, S. Lee, Z. L. Wang, Nano Energy 9 (2014) 291-300.
[D37] W. Tang, T. Jiang, F. R. Fan, A. F. Yu, C. Zhang, X. Cao, Z. L. Wang, Adv. Funct. Mater. 25 (2015) 3718-3725.
[D38] D. Choi, S. Lee, S. M. Park, H. Cho, W. Hwang, D. S. Kim, Nano Res. 8 (2015) 2481-2491.
[D39] M. Han, B. Yu, G. Qiu, H. Chen, Z. Su, M. Shi, B. Meng, X. Cheng, H. Zhang, J. Mater.

Chem. A 3 (2015) 7382-7388.
[D40] Q. Shi, H. Wang, T. Wang, C. Lee, Nano Energy 30 (2016) 450-459.
[D41] T. Kim, J. Chung, D. Y. Kim, J. H. Moon, S. Lee, M. Cho, S. H. Lee, S. Lee, Nano Energy 27 (2016) 340-351.
[D42] X. Zhang, Y. Zheng, D. Wang, Z. U. Rahman, F. Zhou, Nano Energy 30 (2016) 321-329.
[D43] S. Lee, J. Chung, D. Y. Kim, J.-Y. Jung, S. H. Lee, S. Lee, ACS Appl. Mater. Interfaces 8 (2016) 25014-25018.
[D44] G. Zhu, Y. Su, P. Bai, J. Chen, Q. Jing, W. Yang, Z. L. Wang, ACS Nano 8 (2014) 6031-6037.
[D45] X. J. Zhao, G. Zhu, Y. J. Fan, H. Y. Li, Z. L. Wang, ACS Nano 9 (2015) 7671-7677.
[D46] Y. Su, X. Wen, G. Zhu, J. Yang, J. Chen, P. Bai, Z. Wu, Y. Jiang, Z. L. Wang, Nano Energy 9 (2014) 186-195. Q. Shi et al. Nano Energy 40 (2017) 203-213
[E1] A. Darwish, A. E. Hassanien, Sensors 2011, 11, 5561.
[E2] Y. Zang, F. Zhang, C.-A. Di, D. Zhu, Mater. Horiz. 2015, 2, 140.
[E3] H. Alemdar, C. Ersoy, Comput. Networks 2010, 54, 2688.
[E4] B. C.-K. Tee, A. Chortos, A. Berndt, A. K. Nguyen, A. Tom, A. McGuire, Z. C. Lin, K. Tien, W.-G. Bae, H. Wang, Science 2015, 350, 313.
[E5] Y.-Y. Chiu, W.-Y. Lin, H.-Y. Wang, S.-B. Huang, M.-H. Wu, Sens. Actuators A 2013, 189, 328.
[E6] Z. Li, Z. L. Wang, Adv. Mater. 2011, 23, 84.
[E7] X. Wang, Y. Gu, Z. Xiong, Z. Cui, T. Zhang, Adv. Mater. 2014, 26, 1336.
[E8] S. Lee, R. Hinchet, Y. Lee, Y. Yang, Z. H. Lin, G. Ardila, L. Montès, M. Mouis, Z. L. Wang, Adv. Funct. Mater. 2014, 24, 1163.
[E9] J. Viventi, D.-H. Kim, L. Vigeland, E. S. Frechette, J. A. Blanco, Y.-S. Kim, A. E. Avrin, V. R. Tiruvadi, S.-W. Hwang, A. C. Vanleer, Nat. Neurosci. 2011, 14, 1599.
[E10] E. Meng, R. Sheybani, Lab Chip 2014, 14, 3233.
[E11] H. Sveistrup, J. NeuroEng. Rehabil. 2004, 1, 10.
[E12] R. Baker, J. NeuroEng. Rehabil. 2006, 3, 4.
[E13] D. M. Karantonis, M. R. Narayanan, M. Mathie, N. H. Lovell, B. G. Celler, IEEE Trans.

Inf. Technol. Biomed. 2006, 10, 156.
[E14] T. Shany, S. J. Redmond, M. R. Narayanan, N. H. Lovell, IEEE Sens. J. 2012, 12, 658.
[E15] P. Maciejasz, J. Eschweiler, K. Gerlach-Hahn, A. Jansen-Troy, S. Leonhardt, J.

NeuroEng. Rehabil. 2014, 11, 3.
[E16] M.-H. Tsai, Y.-C. Liu, W. Fang, J. Microelectromech. Syst. 2012, 21, 1329.
[E17] R. Xu, S. Zhou, W. J. Li, IEEE Sens. J. 2012, 12, 1166.
[E18] F. Ayazi, K. Najafi, J. Microelectromech. Syst. 2001, 10, 169.
[E19] K. Liu, W. Zhang, W. Chen, K. Li, F. Dai, F. Cui, X. Wu, G. Ma, Q. Xiao, J. Micromech. Microeng. 2009, 19, 113001.
[E20] H. Xie, G. K. Fedder, J. Aerospace Eng. 2003, 16, 65.
[E21] STMicroelectronics, MEMS and Sensors: iNEMO-Inertial Modules, http://www.st.com/content/st_com/en/products/mems-and-sensors/inemo-inertial-modules.html?querycriteria=productId=SC1448 (accessed: May 2017).
[E22] R. Schulze, T. Gessner, M. Heinrich, M. Schueller, R. Forke, D. Billep, M. Sborikas, M. Wegener, presented at 2012 Int. Symp. Applications of Ferroelectrics, held jointly with 2012 European Conf. Applications of Polar Dielectrics and 2012 Int. Symp. Piezoresponse Force Microscopy and Nanoscale Phenomena in Polar Materials, Aveiro, Portugal, 9-13 July, 2012.
[E23] R. K. Gupta, Q. Shi, L. Dhakar, T. Wang, C. H. Heng, C. Lee, Sci. Rep. 2017, 7, 41396.
[E24] H. Zhang, Y. Yang, Y. Su, J. Chen, K. Adams, S. Lee, C. Hu, Z. L. Wang, Adv. Funct. Mater. 2014, 24, 1401.
[E25] X. Wang, S. Niu, Y. Yin, F. Yi, Z. You, Z. L. Wang, Adv. Energy Mater. 2015, 5, 1501467.
[E26] Y. K. Pang, X. H. Li, M. X. Chen, C. B. Han, C. Zhang, Z. L. Wang, ACS Appl. Mater. Interfaces 2015, 7, 19076.
[E27] L. Persano, C. Dagdeviren, Y. Su, Y. Zhang, S. Girardo, D. Pisignano, Y. Huang, J. A.

Rogers, Nat. Commun. 2013, 4, 1633.
[E28] Q. Shi, T. Wang, T. Kobayashi, C. Lee, Appl. Phys. Lett. 2016, 108, 193902.
[E29] Q. Shi, T. Wang, C. Lee, Sci. Rep. 2016, 6, 24946.
[E30] K. I. Park, J. H. Son, G. T. Hwang, C. K. Jeong, J. Ryu, M. Koo, I. Choi, S. H. Lee, M. Byun, Z. L. Wang, Adv. Mater. 2014, 26, 2514.
[E31] F.-R. Fan, L. Lin, G. Zhu, W. Wu, R. Zhang, Z. L. Wang, Nano Lett. 2012, 12, 3109.
[E32] K. Y. Lee, M. K. Gupta, S.-W. Kim, Nano Energy 2015, 14, 139.
[E33] F.-R. Fan, Z.-Q. Tian, Z. L. Wang, Nano Energy 2012, 1, 328.
[E34] H. Wang, Z. Xiang, P. Giorgia, X. Mu, Y. Yang, Z. L. Wang, C. Lee, Nano Energy 2016, 23, 80.
[E35] K. Zhao, Z. L. Wang, Y. Yang, ACS Nano 2016, 10, 9044.
[E36] X. Wang, Y. Yang, Nano Energy 2017, 32, 36.
[E37] Q. Shi, H. Wang, T. Wang, C. Lee, Nano Energy 2016, 30, 450.
[E38] X. Cao, Y. Jie, N. Wang, Z. L. Wang, Adv. Energy Mater. 2016, 6, 1600665.
[E39] H. Zhu, N. Wang, Y. Xu, S. Chen, M. Willander, X. Cao, Z. L. Wang, Adv. Funct. Mater. 2016, 26, 3029.
[E40] L. Dhakar, P. Pitchappa, F. E. H. Tay, C. Lee, Nano Energy 2016, 19, 532.
[E41] Q. Zheng, B. Shi, F. Fan, X. Wang, L. Yan, W. Yuan, S. Wang, H. Liu, Z. Li, Z. L. Wang, Adv. Mater. 2014, 26, 5851.

1. A self-powered triboelectric based device comprising
a base member comprising a first material,
an actuator member comprising a second material having a work function that differs from the first material disposed on a first surface of the base member, and
a plurality of electrodes electrically coupled to the base member;
wherein the plurality of electrodes are disposed in a manner such that a direction of a shear force component applied to the actuator member can be analysed based on electrical outputs measured via respective ones of the electrodes.

2. The self-powered triboelectric based device of claim 1, wherein the actuator member is elastically deformable such that a normal force component applied to the actuator member can be analysed based on the electrical outputs measured via the respective ones of the electrodes.

3. The self-powered triboelectric based device of claim 1, wherein the self-powered triboelectric based device is configured for 2-dimensional or 3-dimensional sensing of control signals for providing a user control interface.

4. The self-powered triboelectric based device of claim 1, further comprising a supporting structure for supporting the base member, the actuator member and the plurality of electrodes.

5. The self-powered triboelectric based device of claim 1, wherein the actuator member is sphere-shaped and the second material is comprised in a semi-spherical portion of the actuator member, and optionally wherein the first surface of the base member has a semi-spherical contour for receiving the semi-spherical portion of the actuator member, and optionally wherein the first surface of the base member has a semi-spherical contour for receiving the semi-spherical portion of the actuator member.

6. (canceled)

7. (canceled)

8. The self-powered triboelectric based device of claim 1, comprising four electrodes.

9. The self-powered triboelectric based device of claim 1, wherein two of the self-powered triboelectric based devices are coupled together to form an integral device.

10. The self-powered triboelectric based device of claim 1, wherein the actuator member is sphere-shaped and the second material is comprised in contact points on a surface of the sphere-shaped actuator member, and optionally wherein the base member is integrally formed with the electrodes such that the electrodes comprise the first material.

11. (canceled)

12. The self-powered triboelectric based device of claim 10, wherein the electrodes comprise two sets of four electrodes each, each set being disposed circumferentially around four of the contact points at different and wherein the two sets and their respective associated contact points are disposed at different latitudes of the sphere-shaped actuator member.

13. A self-powered triboelectric based device comprising
a hollow base member comprising a first material,
one or more actuator members comprising a second material having a work function that differs from the first material disposed inside the hollow base member in a cavity defined by an internal surface of the base member, and
a plurality of electrodes disposed below the internal surface of the base member;
wherein the plurality of inner electrodes are disposed in a manner such that movement of the one or more actuator members can be analysed based on electrical outputs measured via respective ones of the inner electrodes.

14. The self-powered triboelectric based device of claim 13, wherein the one or more actuator members comprise one or more balls.

15. The self-powered triboelectric based device of claim 13, wherein the actuator member comprises the second material in liquid form.

16. The self-powered triboelectric based device of claim 13, configured for 3-dimensional sensing of control signals for providing a user control interface and/or a gyroscope.

17. The self-powered triboelectric based device of claim 13, configured for harvesting signals for conversion into energy.

18. The self-powered triboelectric based device of claim 13, wherein the base member further comprises a plurality of outer electrodes covered by a layer made from a third material, such that further triboelectric signals can be measured via the outer electrodes responsive to an external material having a work function that differs from the third material co-operating with the third material.

19. The self-powered triboelectric based device of claim 13, wherein the base member further comprises a plurality of additional electrodes covered by a layer made from a fourth material, such that additional triboelectric signals can be measured via the additional electrodes responsive to an external material having a work function that differs from the fourth material co-operating with the fourth material, and optionally wherein the additional electrodes are covered by the fourth material on two opposing surfaces for cooperating with the external material.

20. (canceled)

21. (canceled)

22. A method of providing user input using the device as claimed in claim 1.

23. (canceled)

24. A method of harvesting energy using the device as claimed in claim 13.

25. (canceled)

26. A method of submersion-detecting using the device as claimed in claim 13.

27. A method of providing user input using the device as claimed in claim 13.
